(19) United States
(12) Patent Application Publication
(10) Pub. No.: US 2011/0105182 A1
(43) Pub. Date: May 5, 2011

(54) MOBILE WIRELESS DEVICE WITH AN EMBEDDED MEDIA PLAYER

(75) Inventors: Philip Sant, London (GB); Michael Lamb, London (GB); Mark Sullivan, Birmingham (GB); Stephen Pocock, Egham (GB); Lucien Rawden, London (GB)

(73) Assignee: Omnifone Limited, London (GB)

(21) Appl. No.: 12/988,338

(22) PCT Filed: Apr. 20, 2009
(86) PCT No.: PCT/GB2009/050394

§ 371 Date: Jan. 19, 2011

(30) Foreign Application Priority Data
Apr. 18, 2008 (GB) 0807116.9
Nov. 11, 2008 (GB) 0820592.4

(51) Int. Cl. H04W 88/02

(52) U.S. Cl. 455/556.1

(57) ABSTRACT

A mobile wireless device includes an embedded media player; the functionality of the media player has been extended by integrating a third party application with the media player, the third party application supporting an unlimited music subscription service. Hence, the invention is based on the insight that a third party application that can provide access to an unlimited music subscription service, such as the MusicStation media player, can be integrated with an embedded media player in a mobile wireless device. The device then behaves as though the functionality of the media player has been extended, but without the extensive engineering effort needed to re-write the embedded media payer so that it can itself provide access to the unlimited music subscription service.

### BACKGROUND OF THE INVENTION

1. Field of the Invention

This invention relates to a mobile wireless device with an embedded media player. The term ‘mobile wireless device’ means any kind of personal, portable mobile device with one or two-way wireless capabilities and includes without limitation mobile telephones, smart phones, communicators, and similar application specific devices. It includes devices able to communicate in any manner over any kind of wireless network, such as GSM or UMTS, CDMA and WCDMA mobile radio, Bluetooth, IrDA etc. A ‘media player’ is an application that enables a device to store, organise and play digital music, images, video and other media. A media player is ‘embedded’ in a mobile wireless device if it is native to that device—i.e. is designed or implemented into the device by the device manufacturer itself.

2. Description of the Prior Art

Digital audio players, for example MP3 format portable consumer electronics devices and the Apple iPod□, are hugely popular. But the current generation of these devices have no wireless connectivity and this means that there is no mechanism for browsing or discovering new music and then wirelessly downloading those tracks directly to the player. Instead, music tracks are typically ripped from a CD onto a desktop computer or purchased from an on-line music store, such as the Apple iTunes® store. The digital audio player is connected via a cable to the desktop computer and the music tracks are then downloaded from the computer to the digital audio player.

For many years, the deficiencies of this model have been commented on; from the user's perspective, it would be far easier if the digital audio player could directly download music tracks over the wide area wireless network (e.g. 3G etc.). Hence, the mobile telephone has been seen by many as the natural device for consumers to use as their digital audio players. And for many years, most mobile telephones have been equipped with some form of media player that enables the user to store, organise and play digital music. But the process of getting digital music tracks onto these devices has remained cumbersome and slow; it typically involves downloading special software onto a desktop computer that enables the computer to recognise and communicate with the mobile telephone; you then need to install special software that enables the user to transfer music files from the computer to the mobile telephone over a USB cable. Once the software is installed, the user can ‘side-load’ tracks from the PC to the mobile telephone.

Different mobile telephones generally have different requirements; different network operators may also impose variations. So overall, it is a complex and confusing situation and there is no easy and popular mechanism to enable music tracks to be loaded onto a mobile telephone.

One recent initiative to address this problem is the MusicStation□ media player from Omnifone Limited. The MusicStation media player can be installed and run on a very broad range of popular mobile telephones; it then gives the ability to browse a library of several million music tracks stored on remote servers and to download music tracks over the air directly to the mobile telephone. Sophisticated DRM allows the MusicStation media player to offer unlimited music subscriptions services, often called ‘All You Can Eat’ services. The user can download as many tracks as desired for a flat monthly fee, or for a price that is in effect part of the initial purchase price. Downloaded music tracks can be organised and managed on the telephone. Further details are at WO 2007/129081, the contents of which are incorporated by reference.

Reference may also be made to WO 2006/061595, the contents of which are also incorporated by reference. This discloses a mechanism that enables a version of the MusicStation media player to be automatically adapted to run optimally on a given mobile telephone, taking into account the performance capabilities and functionality of that specific mobile telephone.

Most mobile telephones already have an embedded media player pre-installed and hence the appropriate version of the MusicStation media player will typically be installed together with this embedded media player; there will then be two separate media players on the mobile telephone; the original embedded player, that is restricted solely to storing, playing and organising tracks that have been uploaded to the device from a connected PC, and the MusicStation media player that allows much richer functionality, including the ability to download unlimited tracks over the air. This can however be confusing for consumers because there are then two different media players, each accessed using a different user interaction sequence and each offering different functions. It can also be an inefficient use of device memory.

### SUMMARY OF THE INVENTION

In this invention, a mobile wireless device includes an embedded media player; the functionality of the media player has been extended by integrating a third party application with the media player, the third party application extending the capabilities of the embedded media player by providing support for an unlimited music subscription service.

Hence, the invention is based on the insight that a third party application that can provide access to an unlimited music subscription service, such as the MusicStation media player, can be integrated with an embedded media player in a mobile wireless device. The device then behaves as though the functionality of the media player has been extended, but without the extensive engineering effort needed to re-write the embedded media payer so that it can itself provide access to the unlimited music subscription service.

The above may be extended for community, for a-la-carte music, for subscription based music, for other media type a-la-carte and subscription based access.

Features of the preferred implementation include the following:

The third party application and the embedded media player can be seamlessly integrated with each other so that they appear to the user to be a single application. For example, the third party application can mimic the user interface of the embedded media player third party application; it presents no visible UI that is different from the UI of the embedded media player. The third party application can provide one or more of: unlimited media browsing; unlimited media downloading; sharing of playlists with other users; sharing of tracks with other users; registering a profile representing the user to enable the user to develop a network of friends. The device can hence be rapidly enhanced to provide these advanced features, but without the need to re-design the embedded media player to provide these capabilities.

The third party application is a J2ME plug-in, or other mobile phone supported software language, and the embedded media player includes hooks that enable seamless integration with the third party application such that substantially no changes to the code for the embedded media player are required to integrate with the third party application.

The third party application can also be ‘manufacturer signed’; it is then enabled with more security access than a non-signed third party application, and is recognised more quickly by the device, and its operating system has faster and more stable operation than a non-signed third party application, enabling it to perform operations which do not need user approval.

The third party application may have been customized substantially automatically for a specific mobile wireless device. This can be done using the technology described in WO 2006/061595, the contents of which have been incorporated by reference.

The music related main menu of the embedded media player can include an item that, if selected, opens the third party application. Selecting the item can then cause a menu list to be displayed, the menu list including items that correspond to one or more of the following functions: Search; News; Discover/Browse; Friends/Community; Downloads.

The third party application can deliver content using a control mechanism such as DRM that supports media/content access control and metering and enables the use of unlimited subscription services. The third party application can provide a control mechanism such as DRM that supports media/content access control and metering and enables the use of unlimited subscription services. The download of music tracks does not have to be metered by or sent to a billing system. So for example, the costs of the unlimited music service can in effect be captured in the sale price of the device or the monthly fixed tariff, removing the need to meter actual usage or provide integration between the music/media download infrastructure and the billing infrastructure.

The third party application can communicate with the user's phone or address book data stored on the device to enable invitations to be sent to listen to and/or download music tracks. The third party application can also provide a download queuing mechanism for downloading a queue of media assets and digital content for efficient network utilization.

The device can send one or more playlists to one or more remote servers for subsequent retrieval by one or more other users. A playlist or playlists can be generated automatically using one or more of: statistical information, playing metrics, a media recommendations engine, information describing media charts or using any other information. When a playlist is received at a mobile wireless device it can be used to trigger the automatic downloading of media files specified in the playlist to that mobile wireless device. The media files specified in the playlist can be transferred from one or more remote servers to the mobile wireless device that has received the playlist.

The third party application can support one or more of: music, sound, images and video.

The device may be one in which the third party application communicates with the user's phone or address book data stored on the device, or the friends and contacts stored on the server (a cache of which will be in the application), to enable invitations to be sent to listen to and/or download music tracks.

The device may be one in which the third party application is manufacturer signed and is therefore recognised more quickly than a non-signed third party application and has faster and more stable operation that a non-signed third party application.

The device may be one in which the third party application is manufacturer signed and is provided with more security access and can run and access functions and features which may otherwise not be possible or require user approval.

### BRIEF DESCRIPTION OF THE DRAWINGS

FIG. 1 shows a mobile phone, which is being used by a user, running an implementation of the invention.

FIG. 2 shows mobile phone screens from the Get new: Access Unlimited Catalogue feature.

FIG. 3 shows mobile phone screens from the Get new: Access Unlimited Catalogue feature.

FIG. 4 shows mobile phone screens from the Community: Make Friends, Share Music feature.

FIGS. 5 to 18 are Figures which support a description of the Max App: “Community”.

FIGS. 19 to 29 are Figures which support a description of the Max App: “Get new”.

FIGS. 30 to 79 are Figures which support a description of the MusicStation Mobile Edition Screen Flows and Lifecycle.

### DETAILED DESCRIPTION

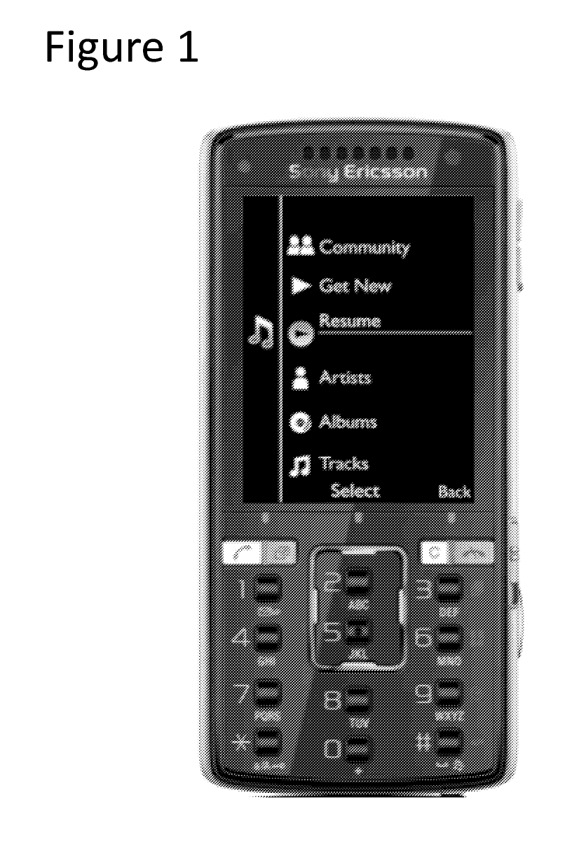

FIG. 1 shows a mobile phone, which is being used by a user, running a sample implementation of the invention which is the preferred embodiment. The present invention is described by reference to that preferred embodiment. A given embodiment of the present invention would not be required to incorporate all features precisely as illustrated herein, but would include the following features:
Implemented with little or no changes to the embedded media player code.
Delivered in an embedded player look & feel.
Extends or modifies the capabilities of the embedded media player.

And may also include one or more of the following features, or technically equivalent features, which are shown in the sample embodiment presented:
A fast phase one implementation extending the native or embedded media player environment in order to provide an integrated unlimited music subscriptions service (“all you can eat”—AYCE) and associated community features.
Utilises the method by which J2ME or other software applications can be neatly added to the embedded media player menu.
Leverages Omnifone's MusicStation Max back-end unlimited music subscriptions services infrastructure (See WO 2007/129081, the contents of which have been incorporated by reference).

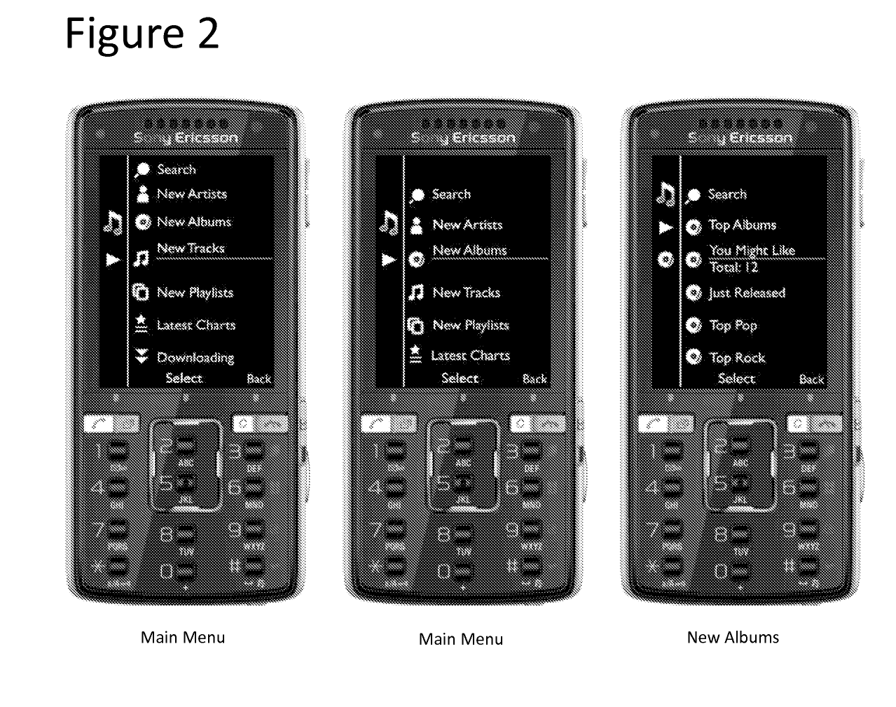

FIG. 2 introduces the Get new: Access Unlimited Catalogue feature. This includes:
Full access to a massive catalogue of tracks
Navigate catalogue by searching, new artists, new albums, new tracks, new playlists and the latest charts.
Select individual tracks, whole albums or playlists to be downloaded in the download manager.

In FIG. 2, the user navigates in the main menu to select the New Albums feature.

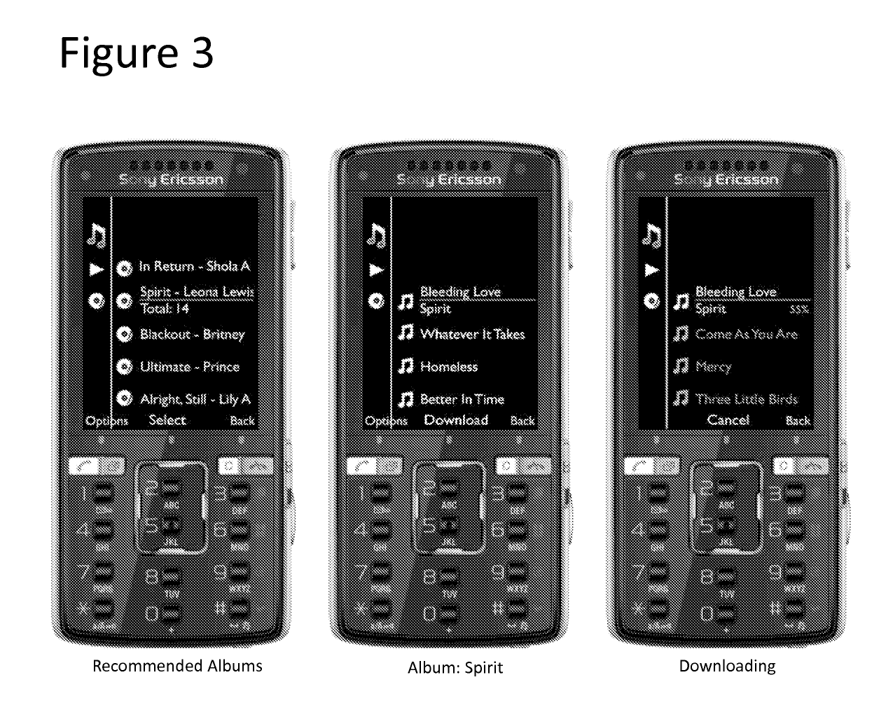

FIG. 3 continues from FIG. 2. In FIG. 3 the user selects Recommended Albums, then Album: Spirit, then the user sees the Album downloading.

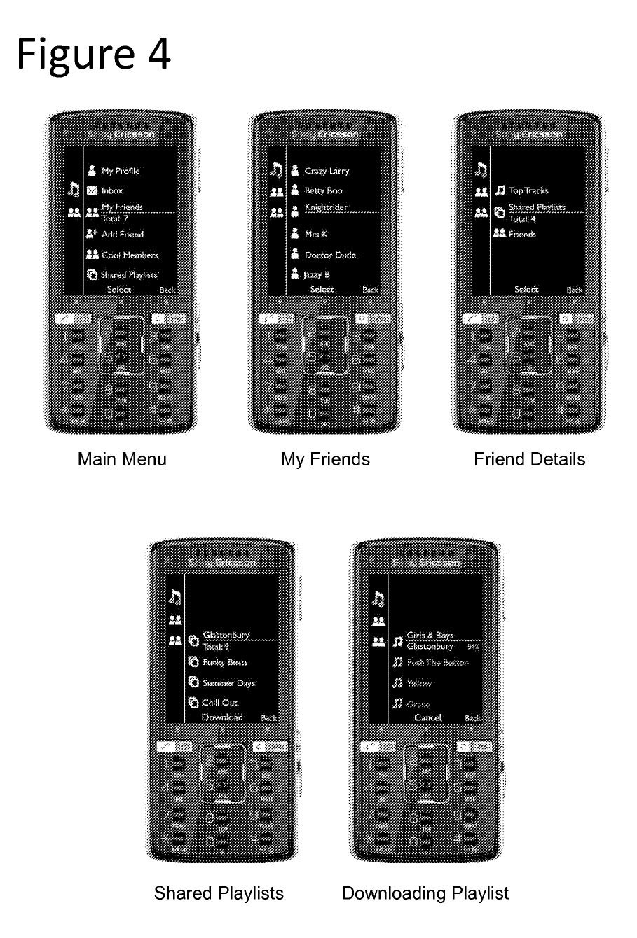

FIG. 4 introduces the Community: Make Friends, Share Music feature. This includes:
Turns the embedded media player into a community capable music application.
Find new friends; share tracks, albums, artists and playlists with existing friends.
Access shared or recommended playlists.

In FIG. 4, the user selects My Friends in the Main Menu, followed by Friend Details, then by Shared Playlists, then the user sees that a playlist is being downloaded.

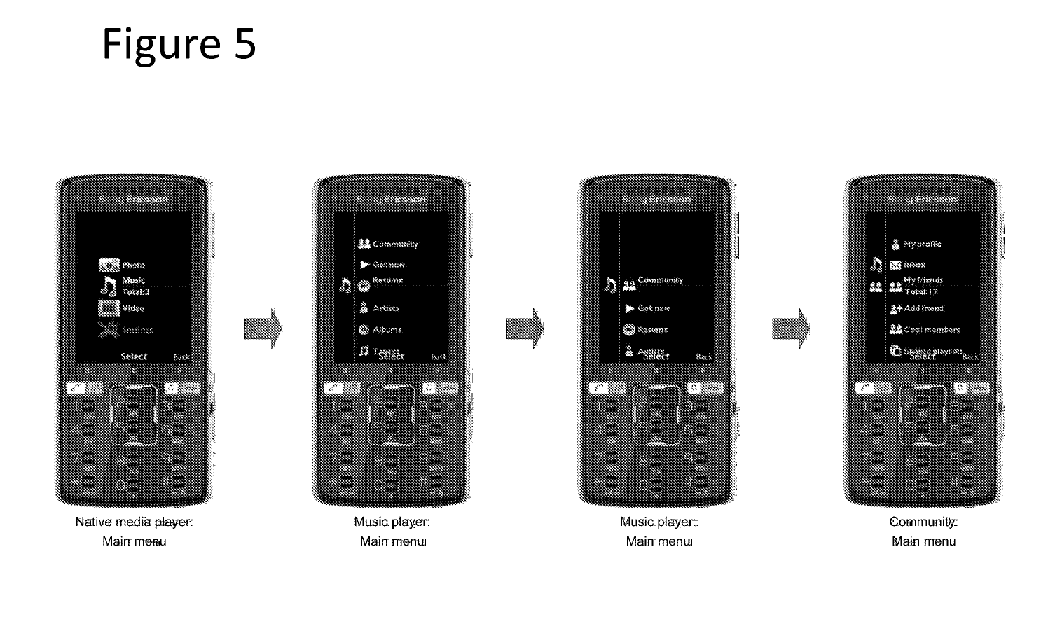

FIGS. 5 to 18 present the Max App: “Community”.

FIG. 5 shows Accessing the “Community” application (menu). The user navigates from the Native media player Main menu, to the Music player Main Menu, then within the Music player Main Menu and finally to the Community: Main menu.

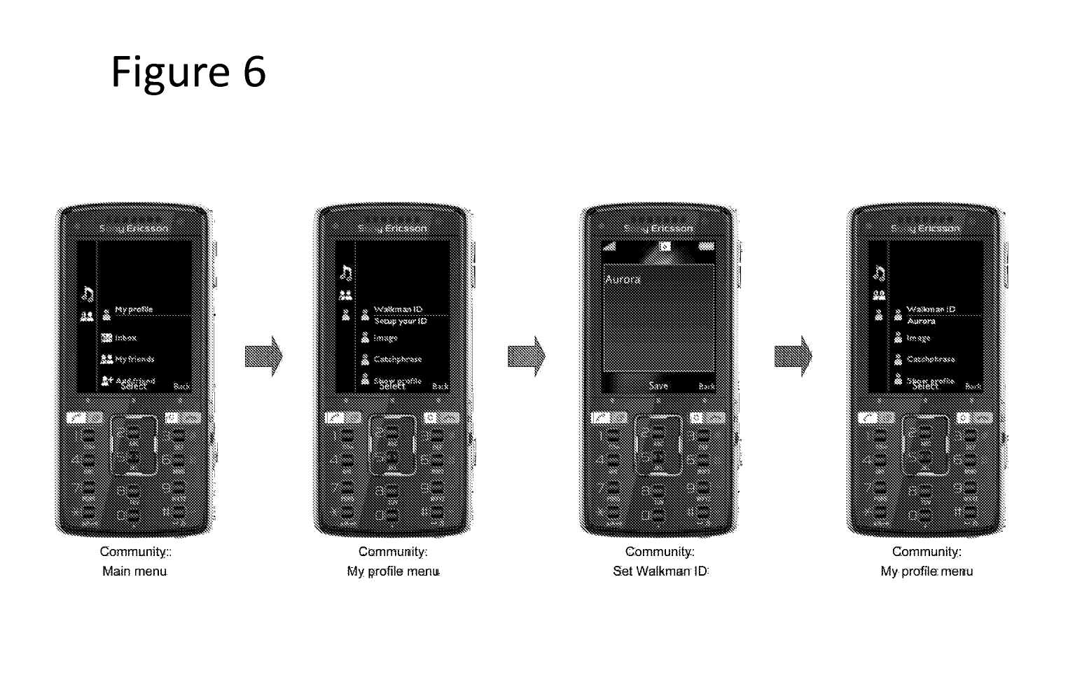

FIG. 6 shows My profile—Setting your ID. The user navigates from the Community Main menu, to the Community My Profile Menu, to Community Set ID Menu and finally to the Community: My profile menu.

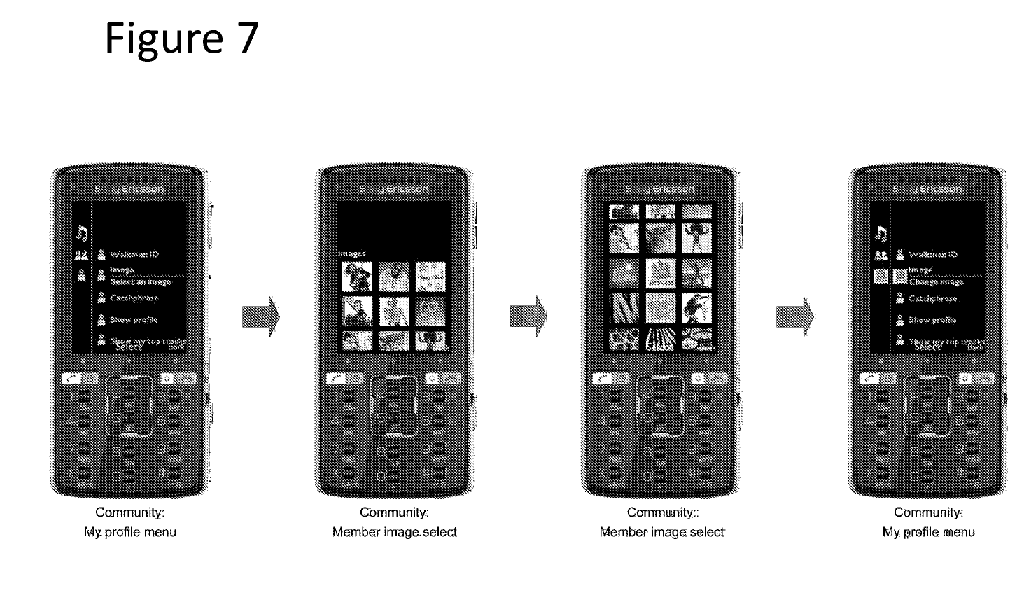

FIG. 7 shows My profile—Setting your member image. The user navigates from the Community My Profile Menu, to the Community Member image select Menu, then within the Community Member image select Menu and finally to the Community: My profile menu.

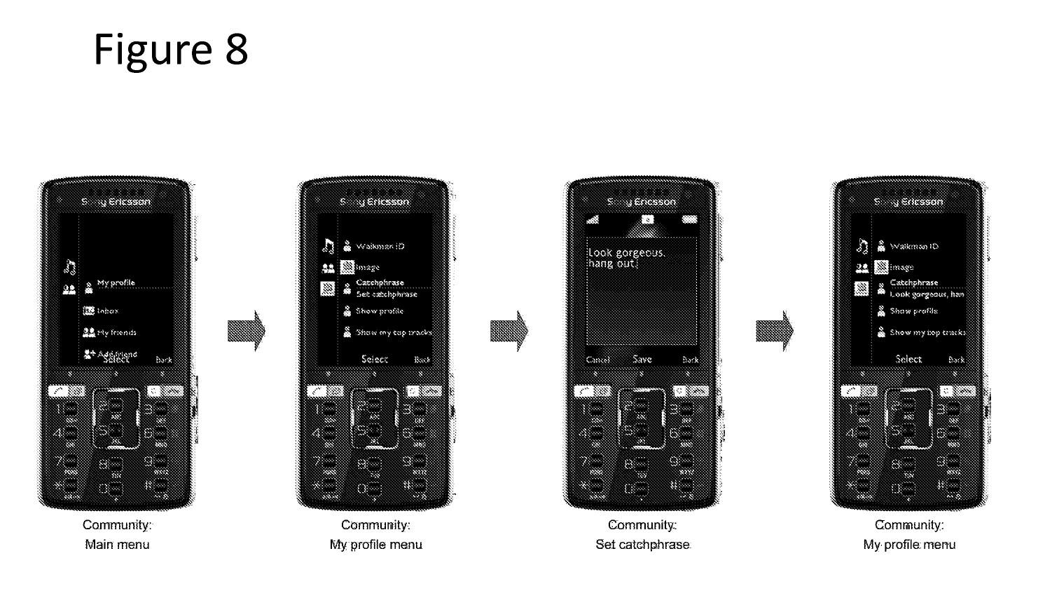

FIG. 8 shows My profile—Setting your catchphrase. The user navigates from the Community Main menu, to the Community My Profile Menu, to Community Set catchphrase Menu and finally to the Community: My profile menu.

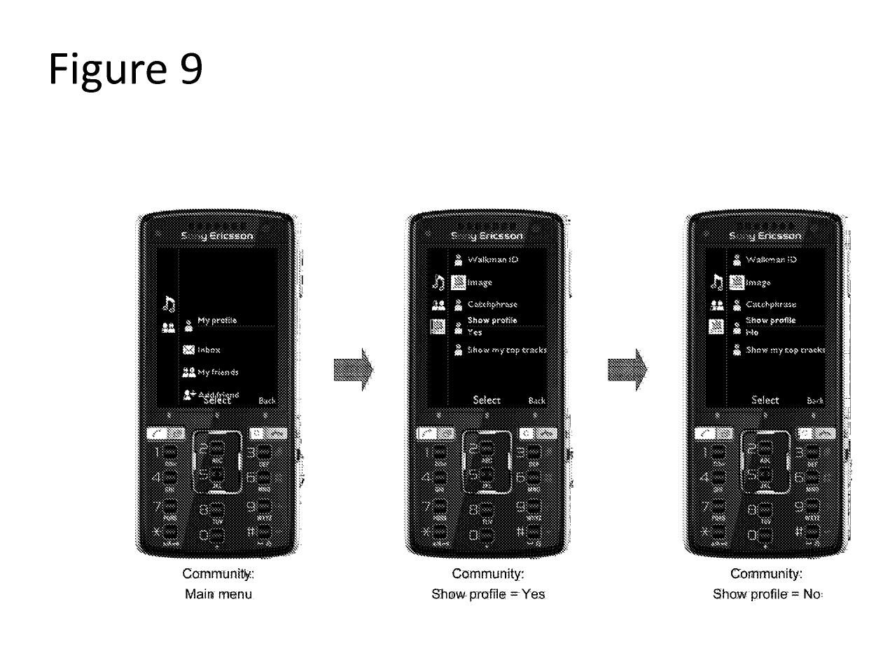

FIG. 9 shows My profile—Controlling whether your profile is shown to other users. The user navigates from the Community Main menu, to the Community show profile=yes page, and finally to the Community: show profile=no page.

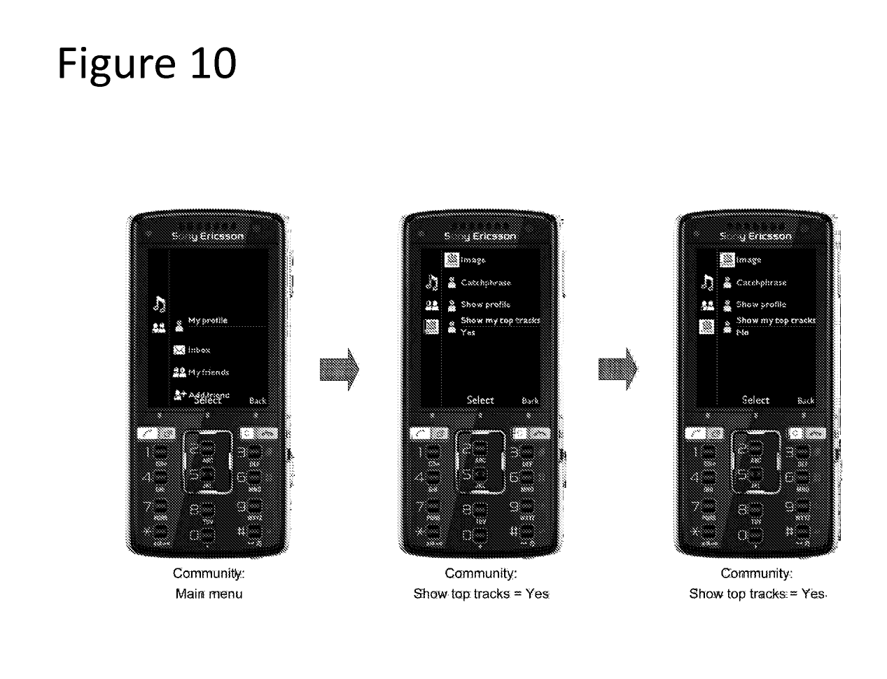

FIG. 10 shows My profile—Controlling whether your top tracks are shown to other users. The user navigates from the Community Main menu, to the Community show top tracks=yes page, and finally to the Community: show top tracks=no page.

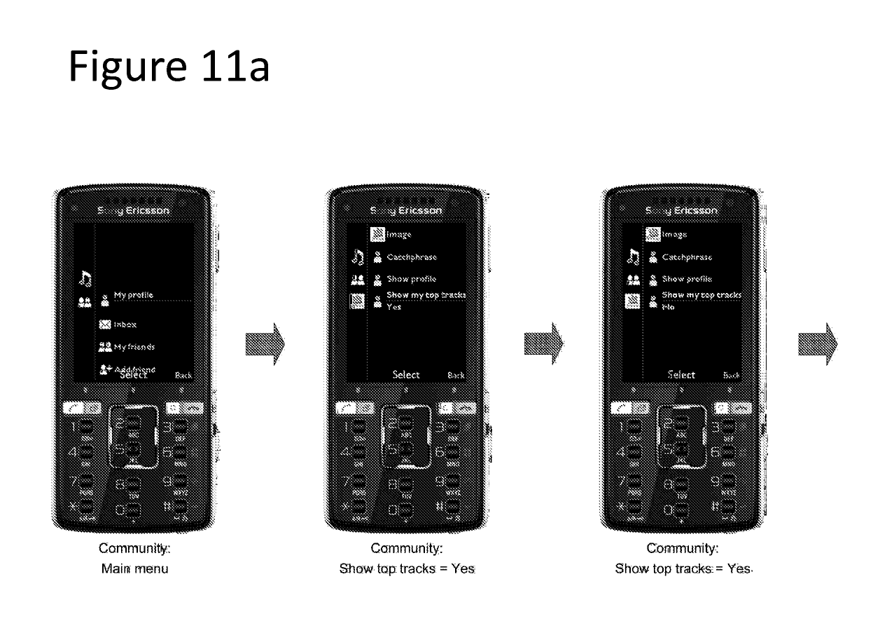

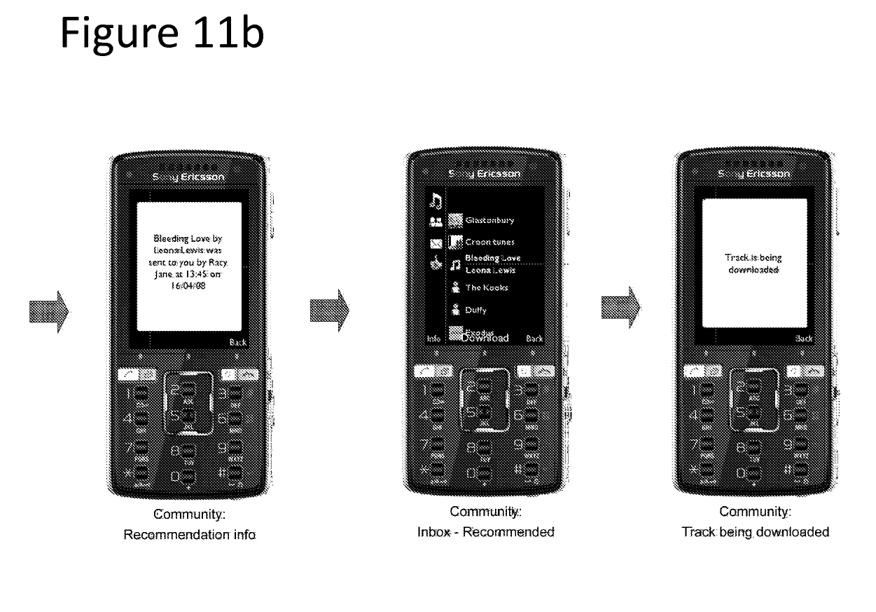

FIG. 11a shows Inbox—Accessing recommendations from friends (artists, albums, tracks and playlists). The user navigates from the Community Main menu, to the Community show top tracks=yes page, and the user continues on to the Community: show top tracks=yes page.

FIG. 11b (continues from FIG. 11a) shows Inbox—Accessing recommendations from friends (artists, albums, tracks and playlists). The user continues to Community: Recommendation Info, then to Community: Inbox—Recommended, and finally the user sees that in Community, the track is being downloaded.

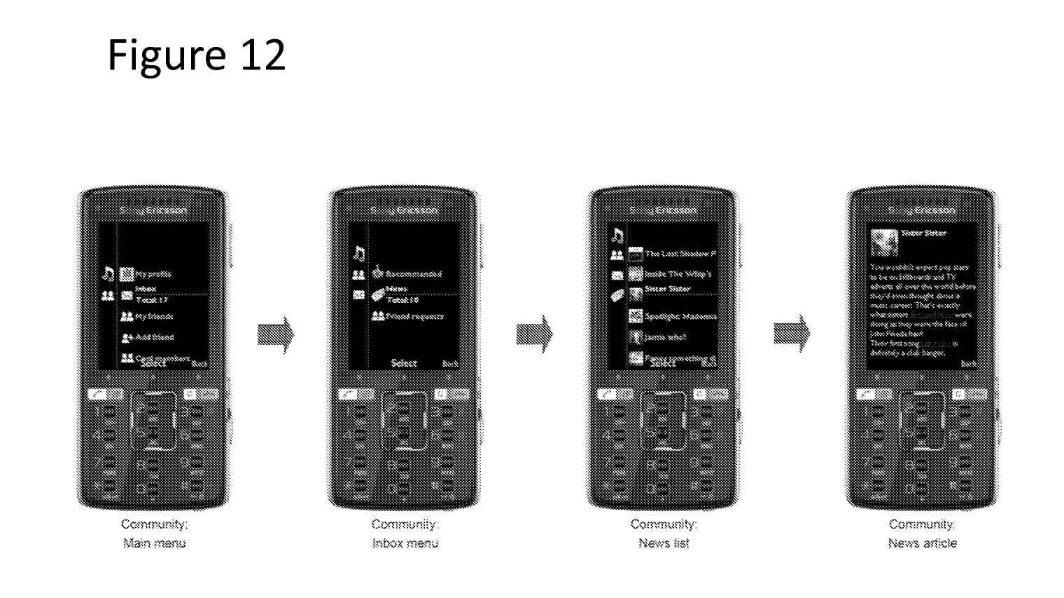

FIG. 12 shows Inbox—Reading news (articles targeted using user music preferences). The user navigates from the Community Main menu, to the Community Inbox Menu, to Community News list Menu and finally to the Community: News article screen.

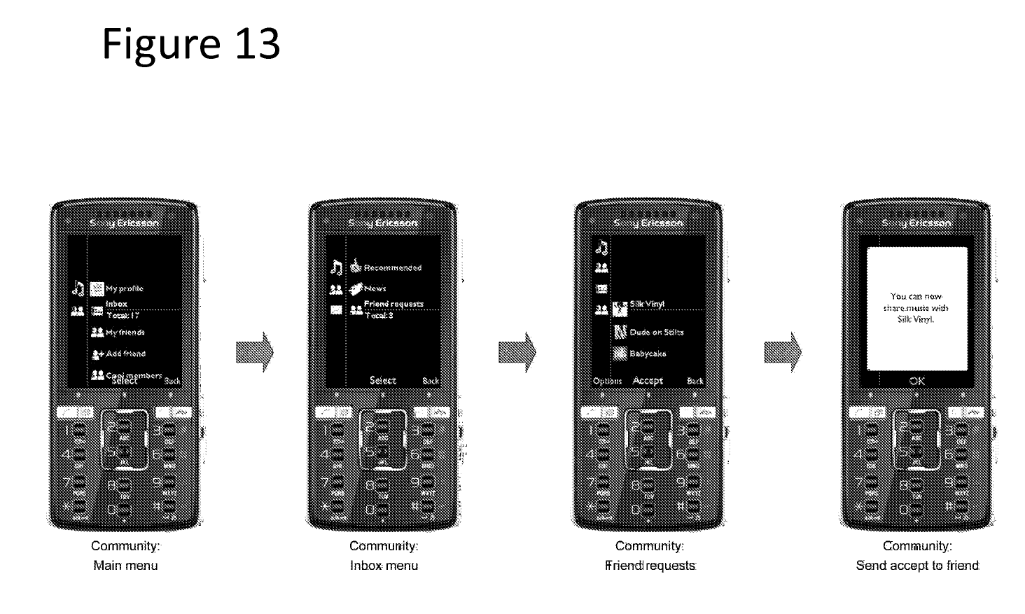

FIG. 13 shows Inbox—Approving requests from others to be your friend (includes accept, deny, block & report abuse). The user navigates from the Community Main menu, to the Community Inbox Menu, to Community Friend requests Menu and finally to the Community: send accept to friend screen.

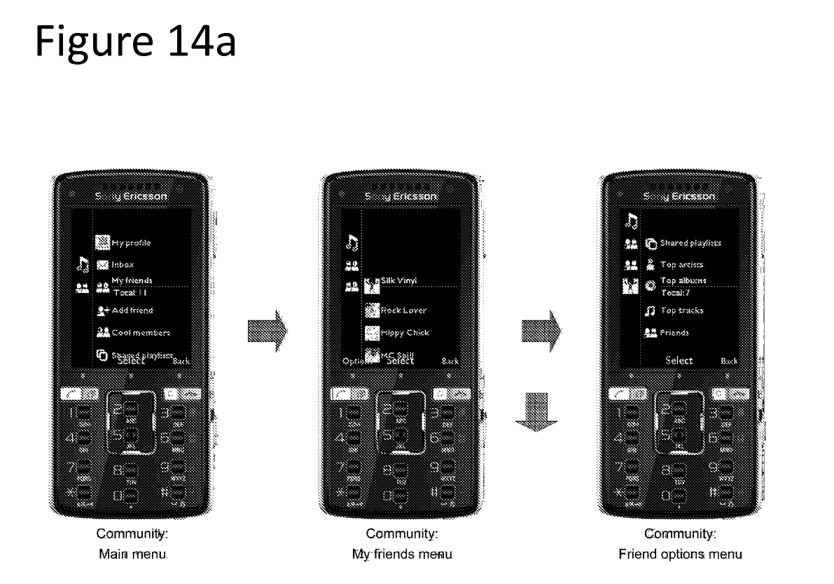

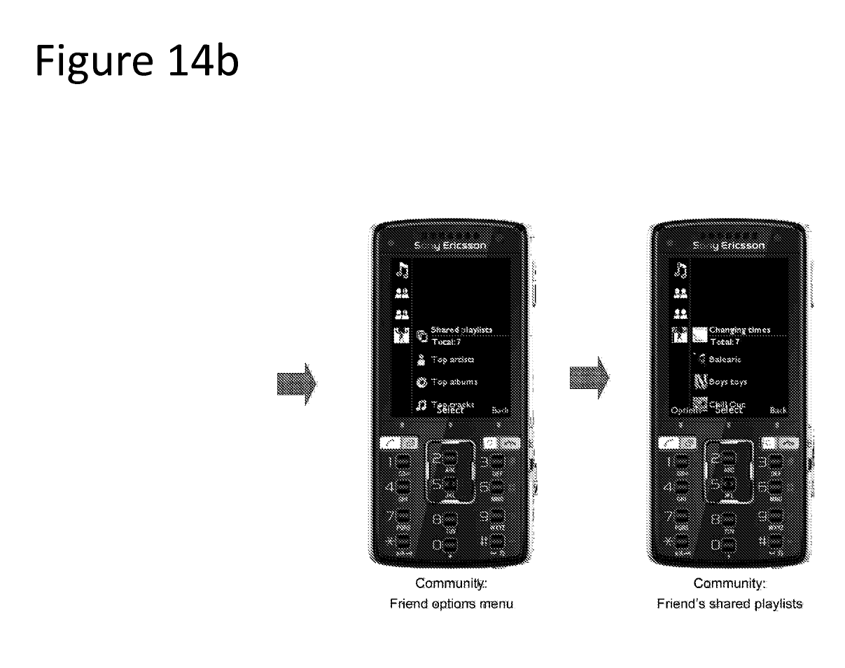

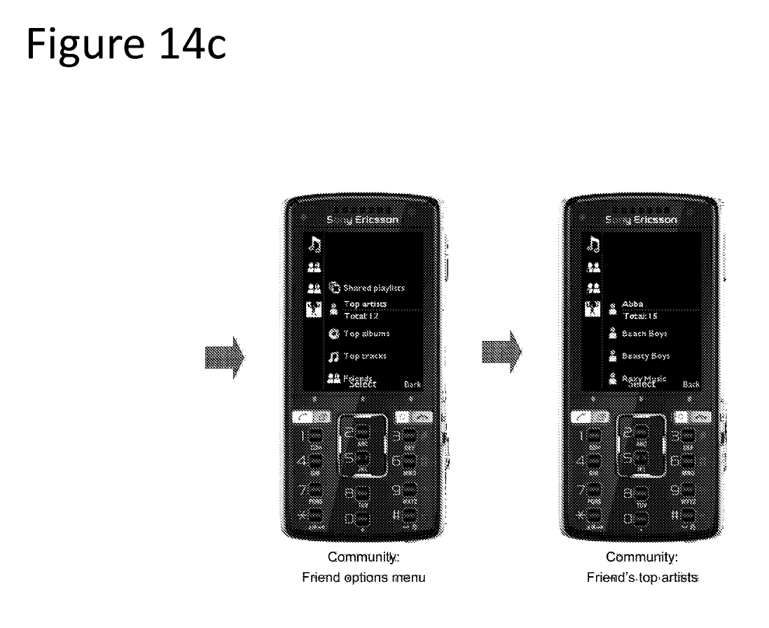

FIGS. 14a, 14b and 14c show My friends—Listening to your friends favourite music (shared playlists, top artists, top albums and top tracks). In FIG. 14a, the user can navigate from the Community Main menu, to the Community My Friends Menu, then optionally to the Community Friend Options Menu.

In FIG. 14b, which continues from FIG. 14a, the user can navigate from the Community My Friends Menu in FIG. 14a, optionally to the Community Friend Options Menu, then to the Community Friend's shared playlists screen.

In FIG. 14c, which continues from FIG. 14a, the user can navigate from the Community My Friends Menu in FIG. 14a, optionally to the Community Friend Options Menu, then to the Community Friend's top artists screen.

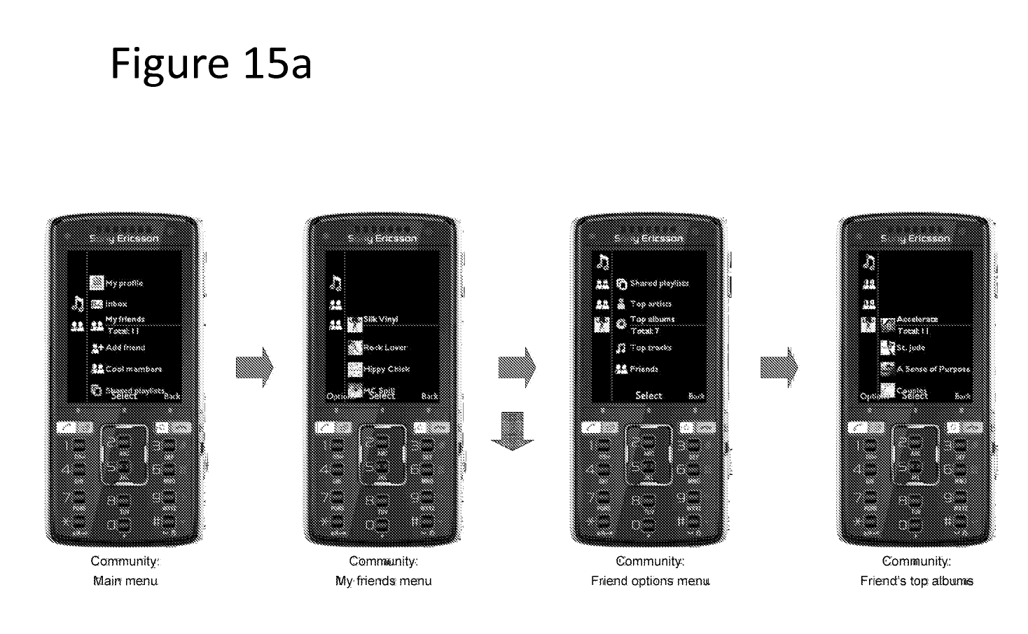

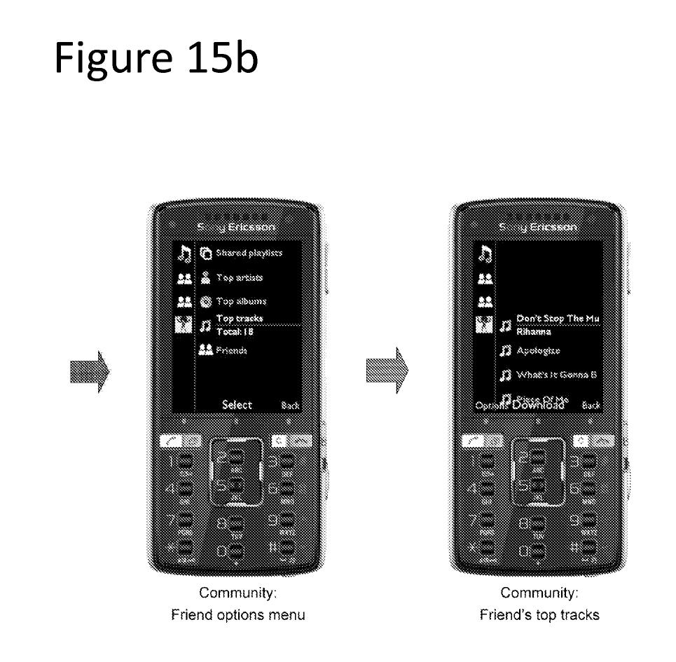

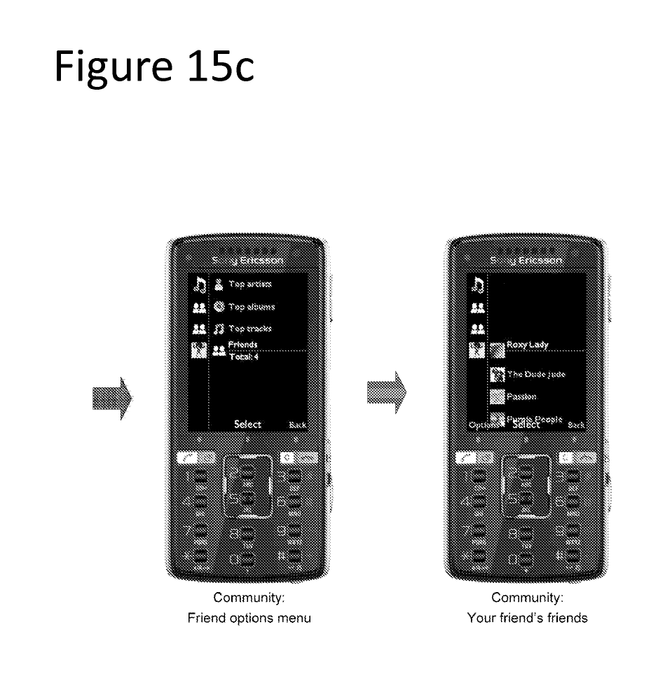

FIGS. 15a, 15b and 15c show My friends—Listening to your friends favourite music (shared playlists, top artists, top albums and top tracks) and meeting their friends. In FIG. 15a, the user can navigate from the Community Main menu, to the Community My Friends Menu, then optionally to the Community Friend Options Menu, then to the Community Friend's top albums screen.

In FIG. 15b, which continues from FIG. 15a, the user can navigate from the Community My Friends Menu in FIG. 15a, optionally to the Community Friend Options Menu, then to the Community Friend's top tracks screen.

In FIG. 15c, which continues from FIG. 15a, the user can navigate from the Community My Friends Menu in FIG. 15a, optionally to the Community Friend Options Menu, then to the Community Your Friend's friends screen.

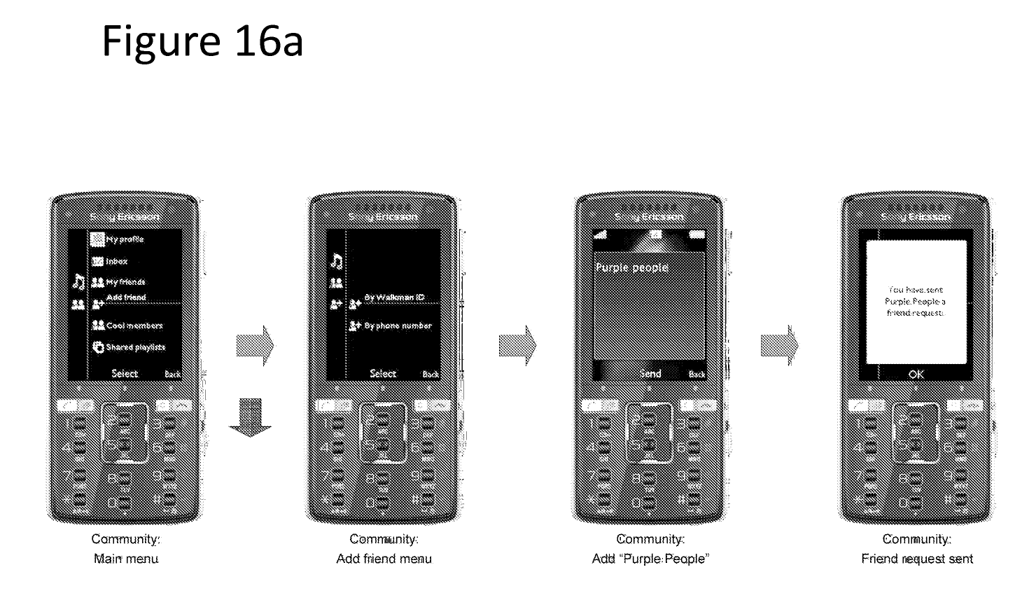

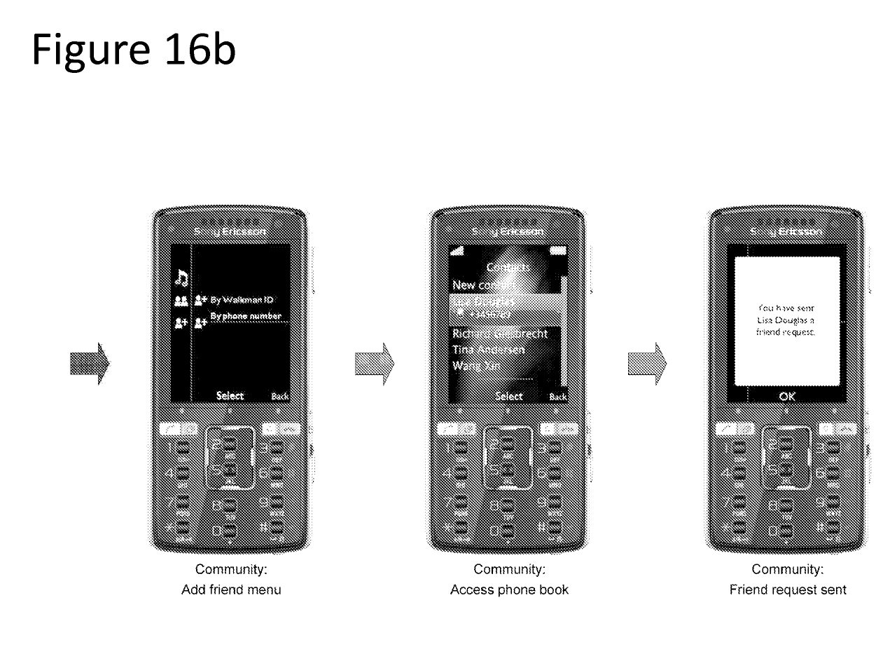

FIGS. 16a and 16b show My friends—Listening to your friends favourite music (shared playlists, top artists, top albums and top tracks) and meeting their friends. FIG. 16a shows the Community Main Menu, from which the user can optionally navigate to the Community Add Friend Menu, then to the Community “Add Purple People” screen, to the Community Friend request sent screen.

In FIG. 16b, which continues from FIG. 16a, the user can navigate from the Community Main Menu in FIG. 16a, optionally to the Community Add Friend Menu, then to the Community Access Phone Book, to the Community Friend request sent screen.

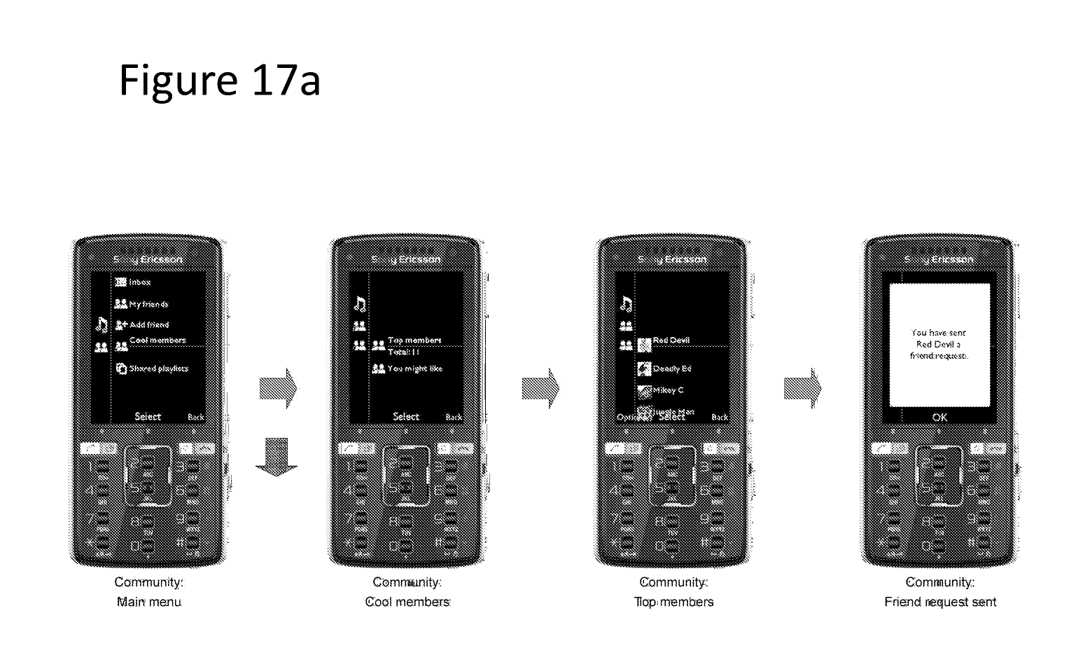

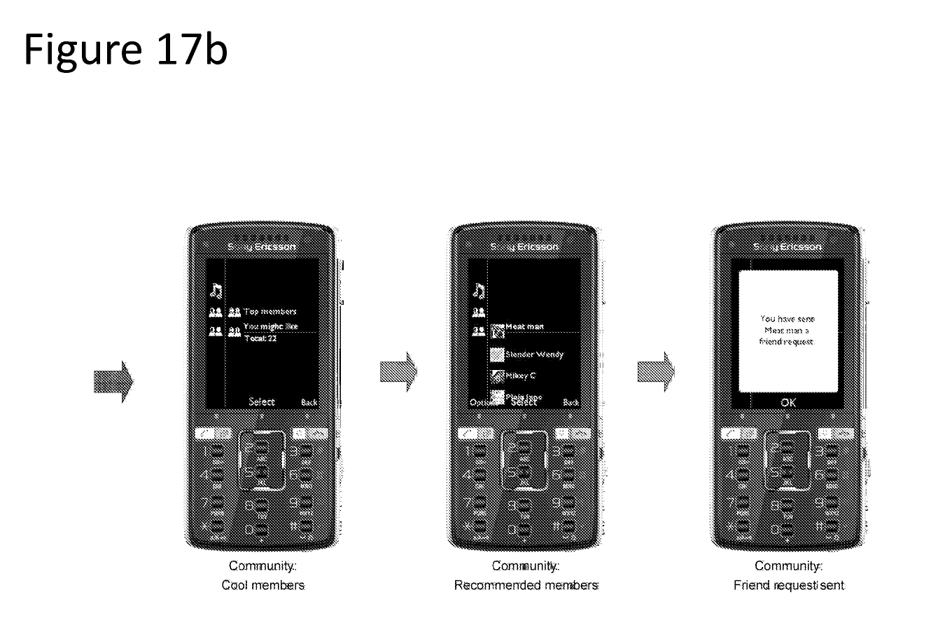

FIGS. 17a and 17b show Cool members—Find the top Community unlimited members and get member recommendations. FIG. 17a shows the Community Main Menu, from which the user can optionally navigate to the Community Cool Members Menu, then to the Community Top members screen, to the Community Friend request sent screen.

In FIG. 17b, which continues from FIG. 17a, the user can navigate from the Community Main Menu in FIG. 17a, optionally to the Community Cool Members Menu, then to the Community Recommended Members screen, to the Community Friend request sent screen.

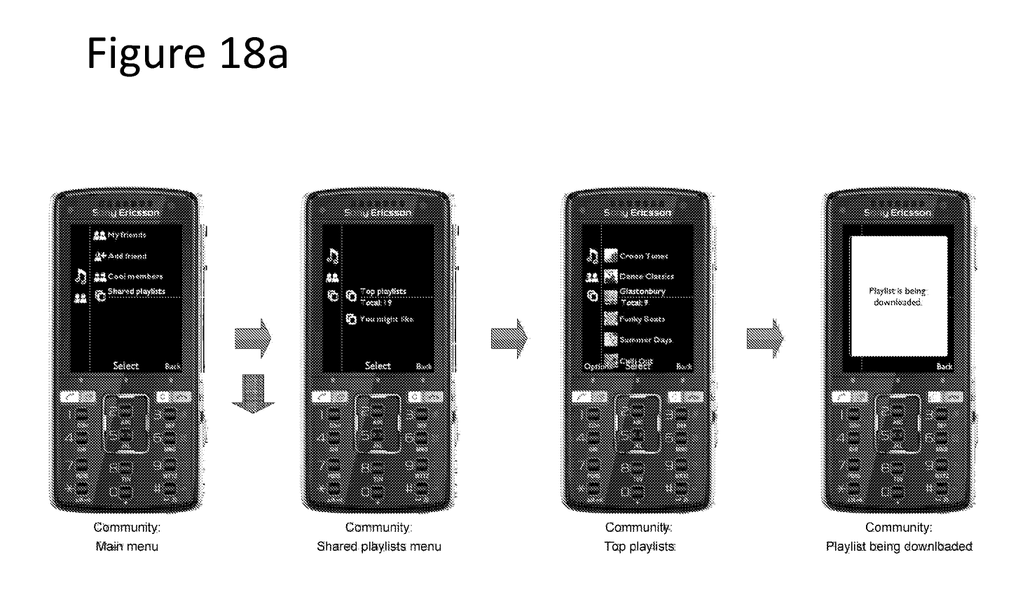

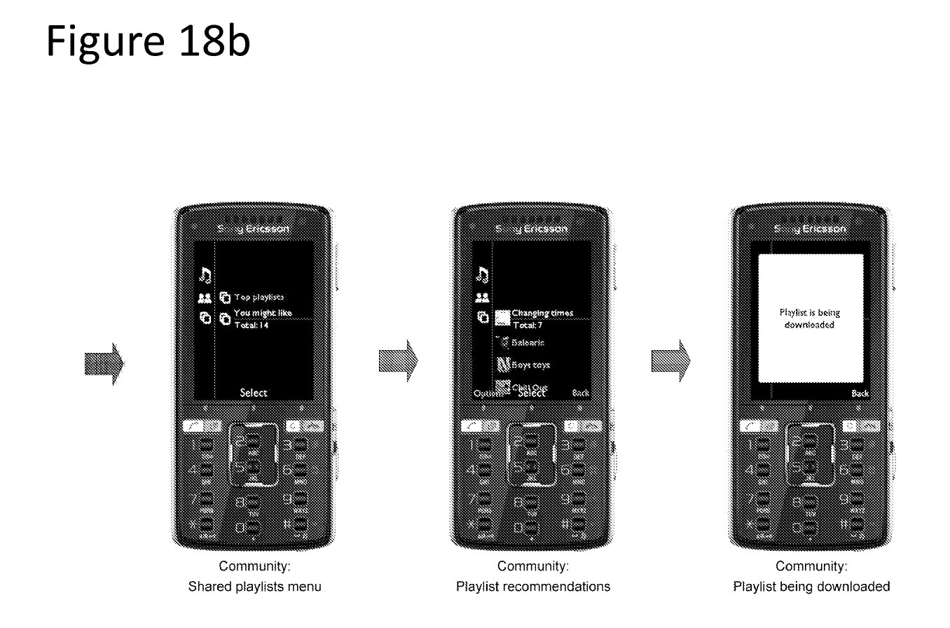

FIGS. 18a and 18b show Shared playlists—Find and download shared playlists from top and recommended members. FIG. 18a shows the Community Main Menu, from which the user can optionally navigate to the Community Shared Playlists Menu, then to the Community Top playlists screen, to the Community playlist being downloaded screen.

In FIG. 18b, which continues from FIG. 18a, the user can navigate from the Community Main Menu in FIG. 18a, optionally to the Community Shared Playlists Menu, then to the Community playlist recommended screen, to the Community playlist being downloaded screen.

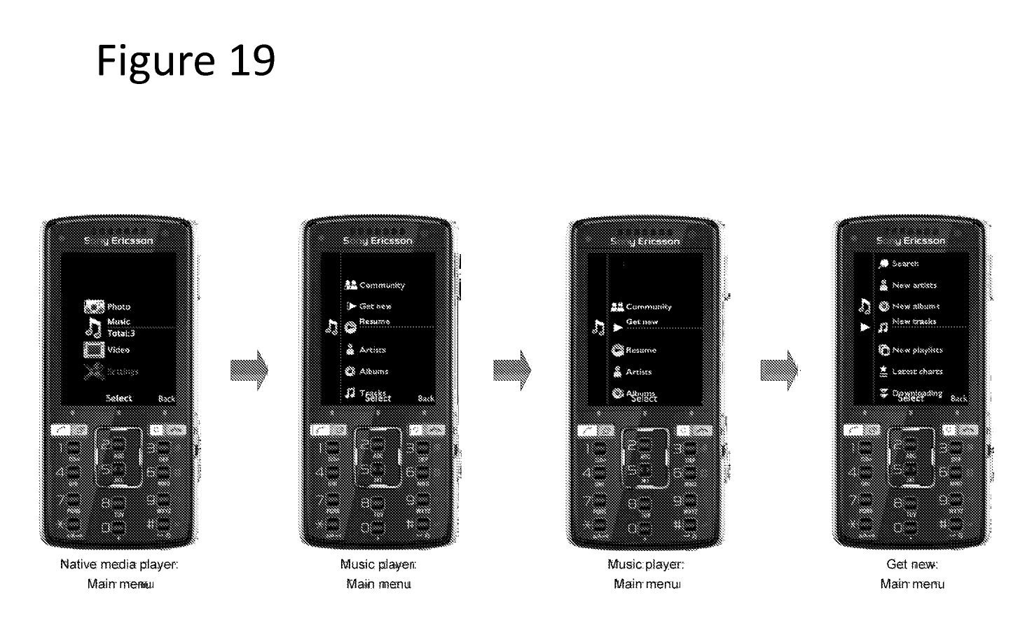

FIGS. 19 to 29 show Max App: “Get new”.

FIG. 19 shows accessing the “Get new” application (menu). The user can navigate from the Native media player Main Menu, to the Music player Main Menu, within the Music player Main Menu, and finally to the Get New: Main Menu screen.

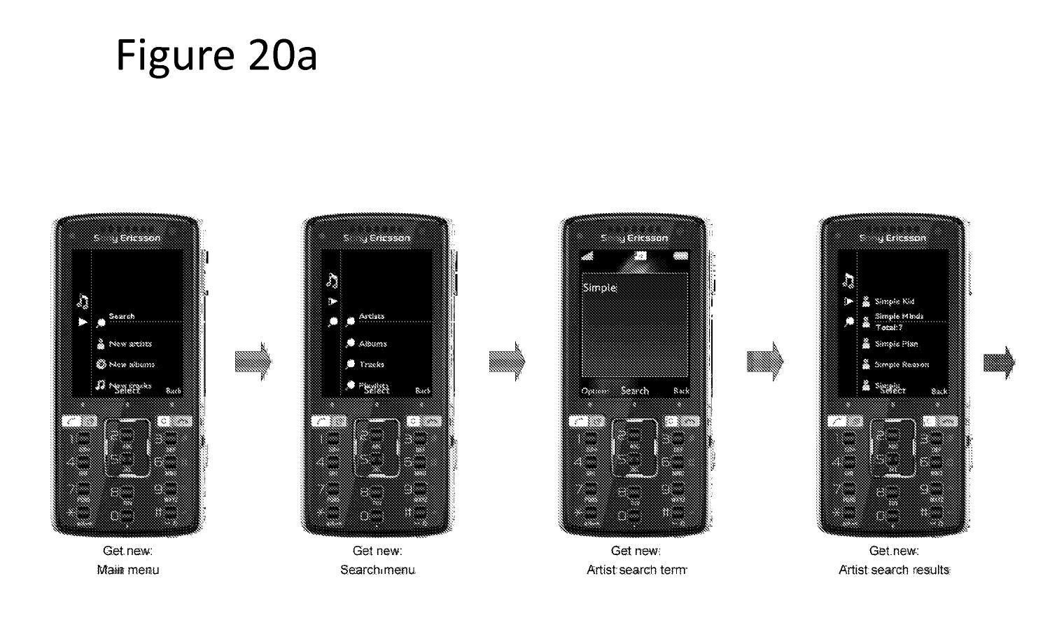

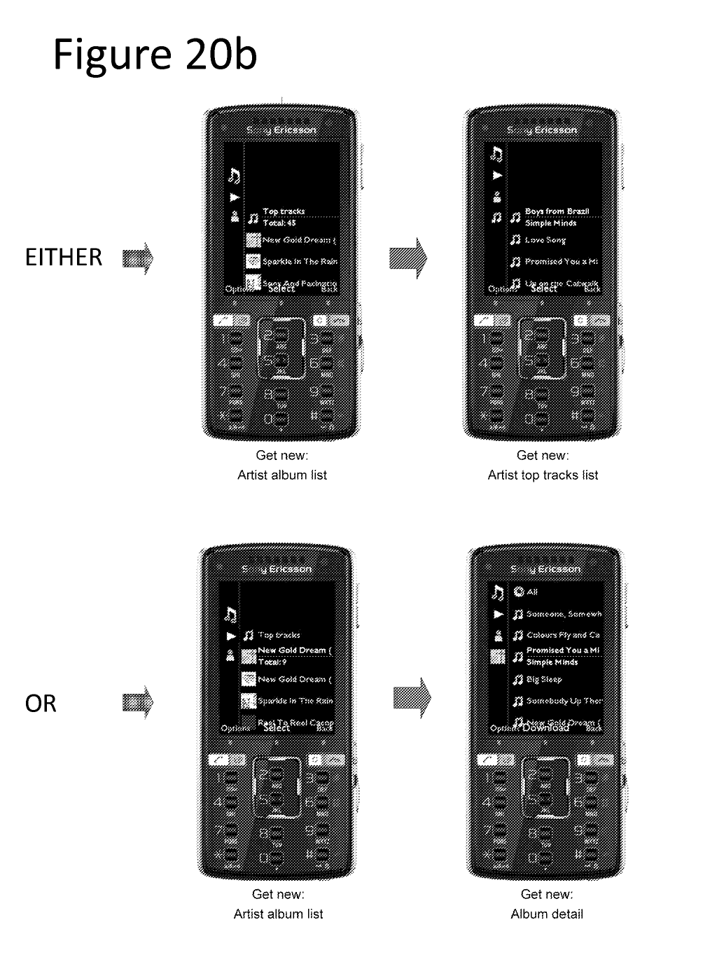

FIGS. 20a and 20b show Artist Search. In FIG. 20a, the user can navigate from the Get new: Main Menu, to the Get new: Search Menu, to the Get new: artist search term screen, to the Get New: artist search results screen, from which there are two options. In FIG. 20b, it is evident that from the Get New: artist search results screen of FIG. 20a, the user can EITHER go to the Get new: artist album list, followed by the Get new: artist top tracks list, OR the user can go to the Get new: artist album list, followed by the Get new: album detail screen.

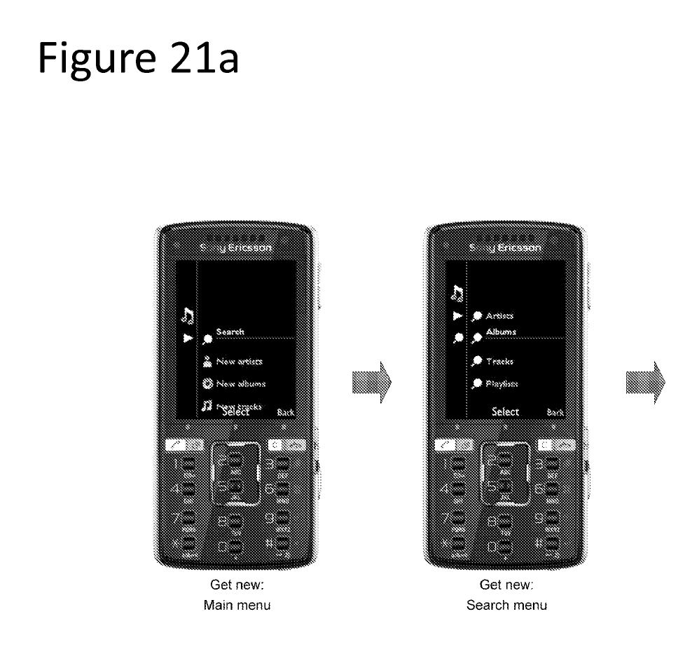

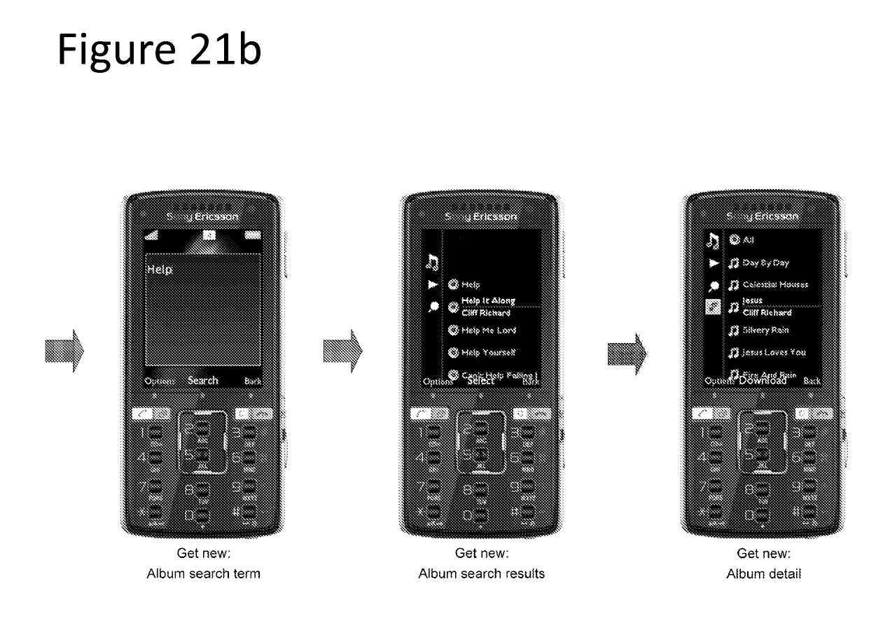

FIGS. 21a and 21b show Album search. In FIG. 21a, the user starts with the Get new: Main Menu, and goes to the Get new: Search Menu. FIG. 21b continues from FIG. 21a. From Get new: Search Menu in FIG. 21a, the user navigates to Get new: album search term, followed by the Get new: album search results, followed by the Get new: Album detail screen.

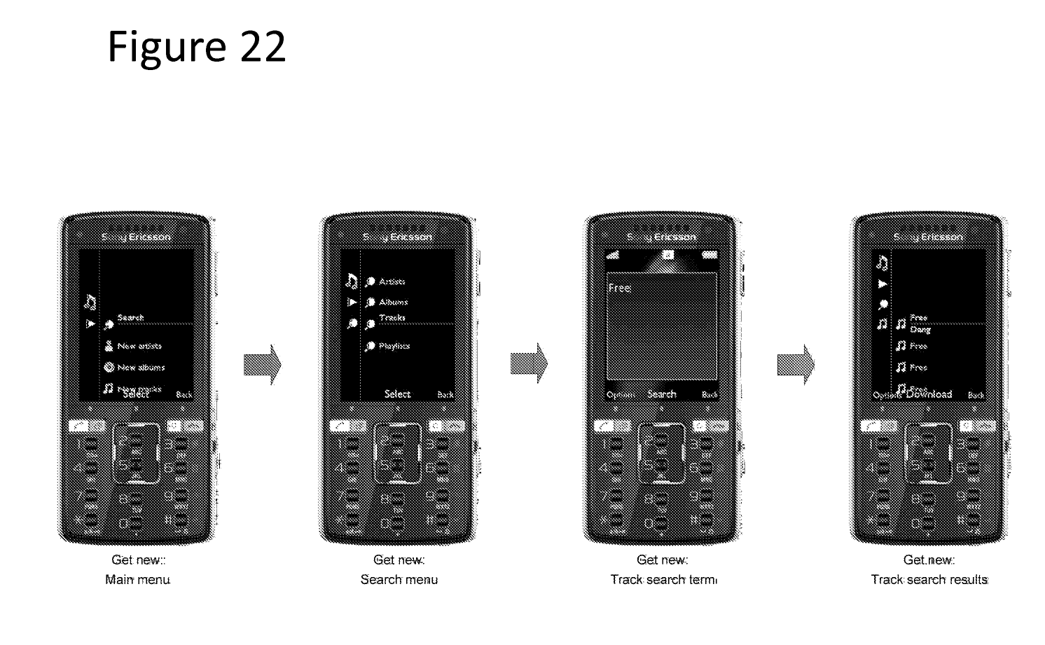

FIG. 22 shows Track search. The user can navigate from the Get New: Main Menu, to the Get New: Search Menu, to the Get New: Track Search term, and finally to the Get New: Track Search results screen.

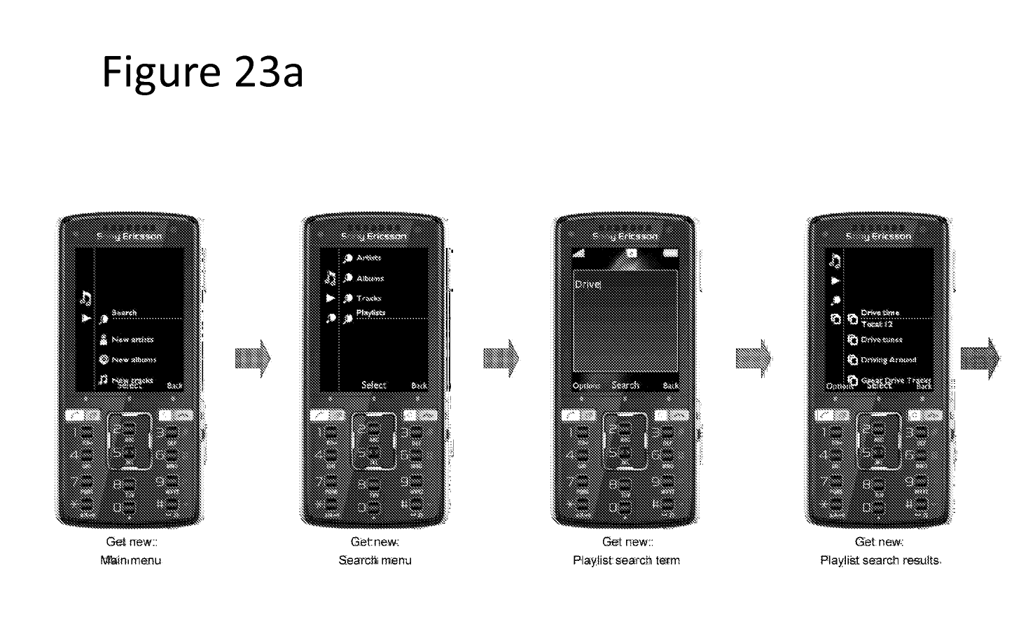

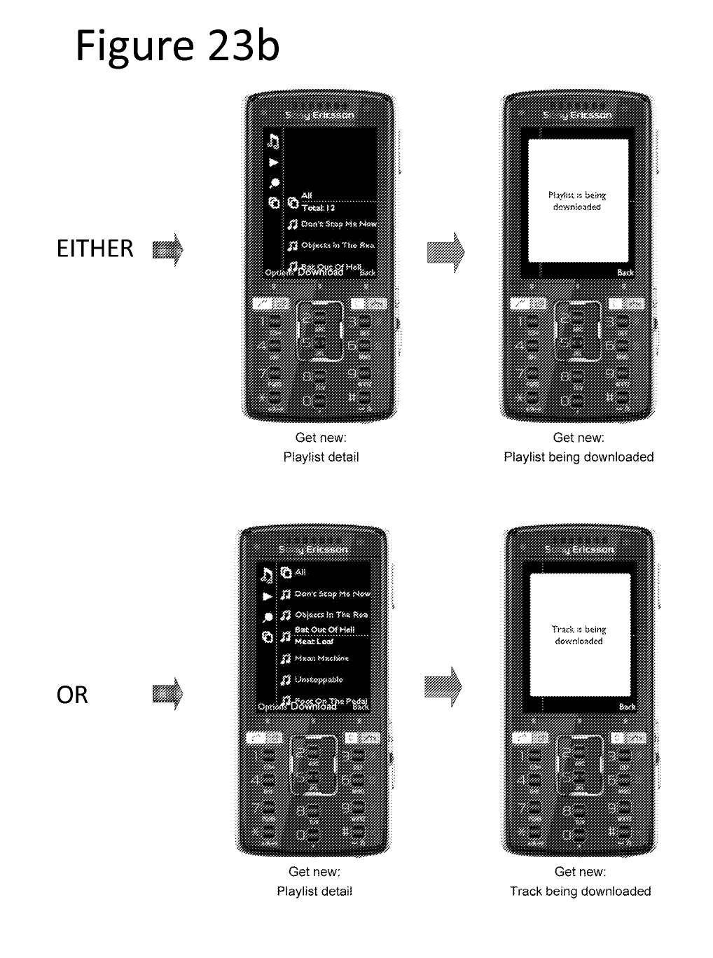

FIGS. 23a and 23b show Playlist search. In FIG. 23a, the user can navigate from the Get new: Main Menu, to the Get new: Search Menu, to the Get new: playlist search term screen, to the Get New: playlist search results screen, from which there are two options. In FIG. 23b, it is evident that from the Get New: playlist search results screen of FIG. 23a, the user can EITHER go to the Get new: playlist detail, followed by the Get new: playlist being downloaded screen, OR the user can go to the Get new: playlist detail, followed by the Get new: track being downloaded screen.

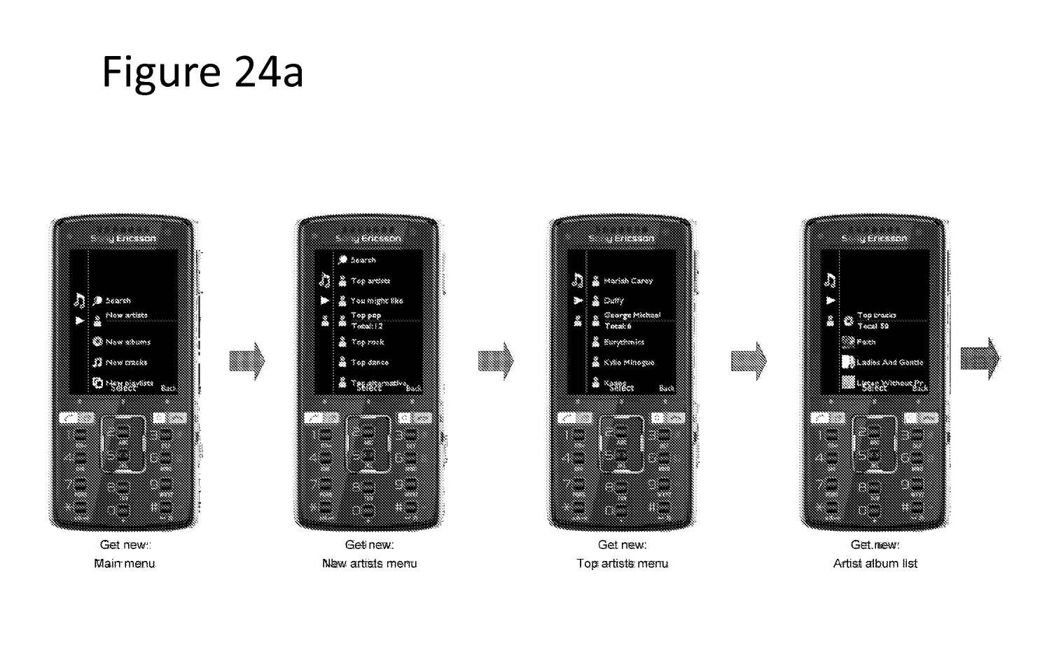

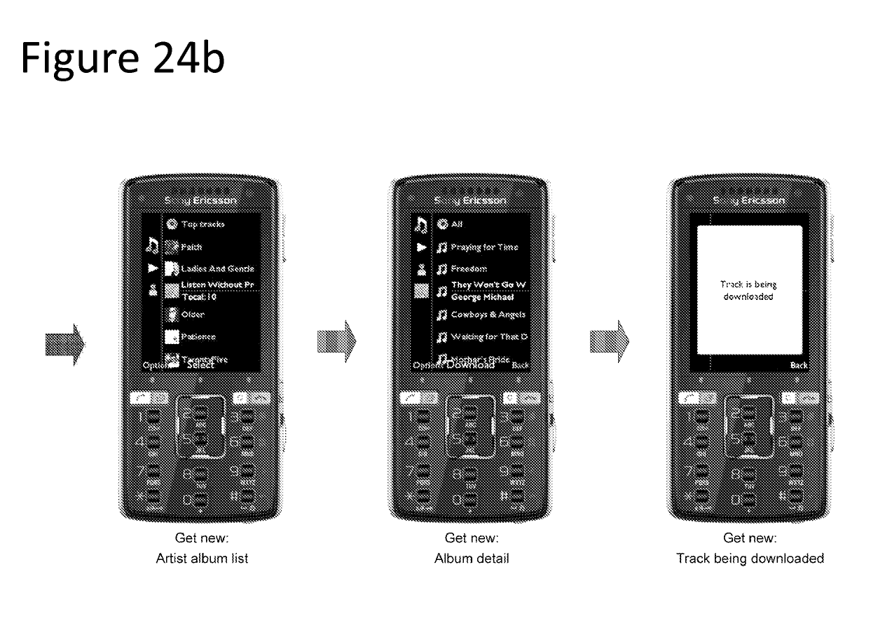

FIGS. 24a and 24b show New artists. In FIG. 24a, the user starts with the Get new: Main Menu, and goes to the Get new: New Artists Menu, then to Get New: Top artists menu, then to Get new: Artist album list. FIG. 24b continues from FIG. 24a. From Get new: Artist album list in FIG. 24a, the user navigates within Get new: Artist album list, then to Get new: album detail, followed by the Get new: track being downloaded screen.

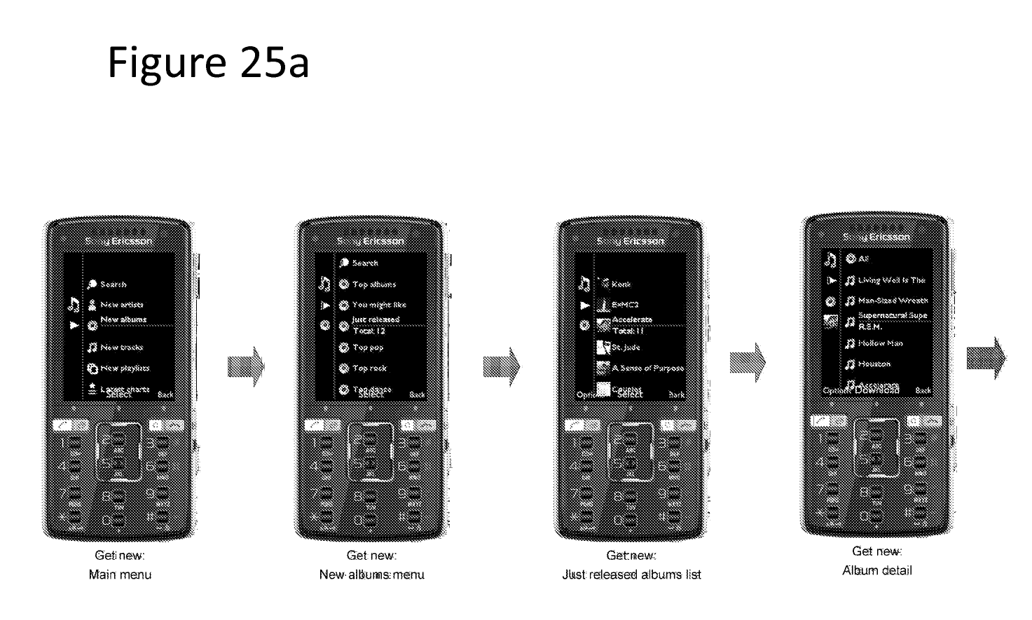

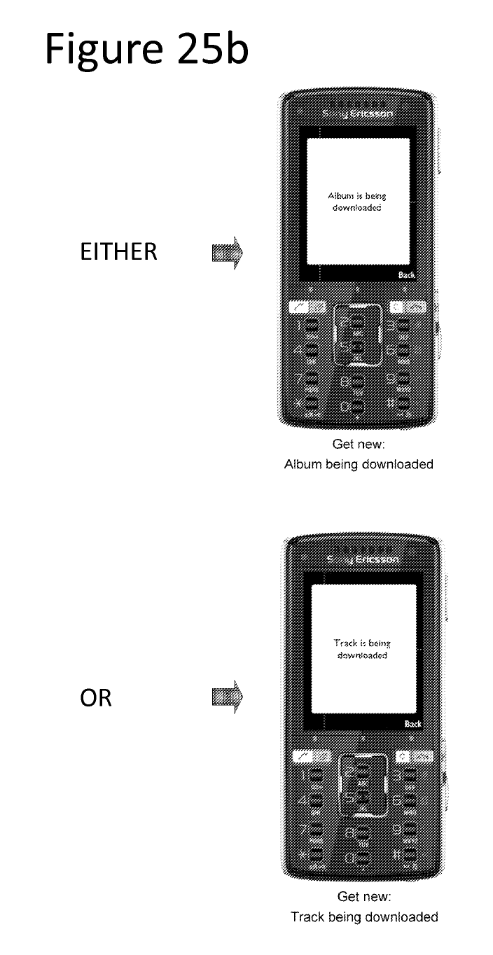

FIGS. 25a and 25b show New albums. In FIG. 25a, the user starts with the Get new: Main Menu, and goes to the Get new: New Albums Menu, then to Get New: just released albums list, then to Get new: album detail screen. FIG. 25b continues from FIG. 25a. From the Get new: album detail screen in FIG. 25a, the user either goes to the Get new: album being downloaded screen, or to the Get new: track being downloaded screen.

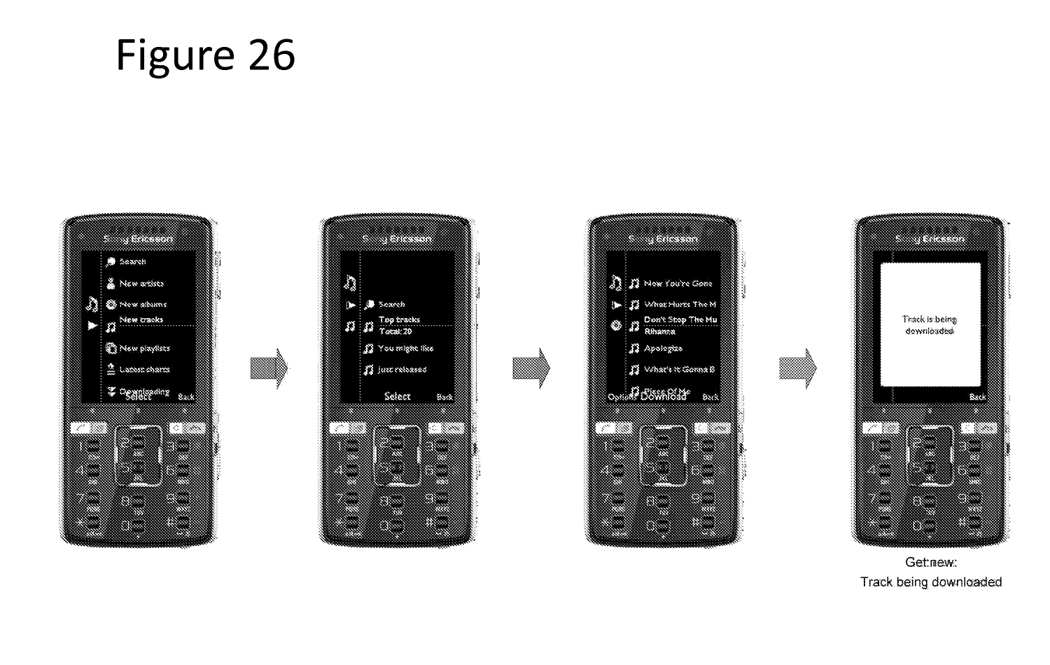

FIG. 26 shows New tracks. The user can navigate from the Get New: Main Menu, to the Top Tracks Menu, to the Track list screen, and finally to the Get new: track being downloaded screen.

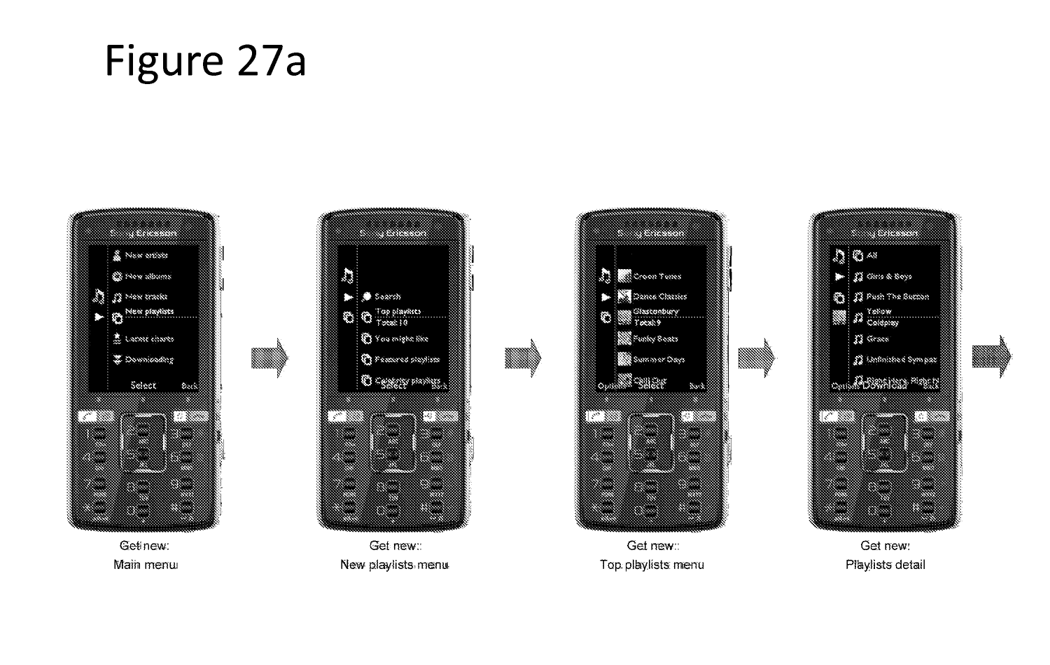

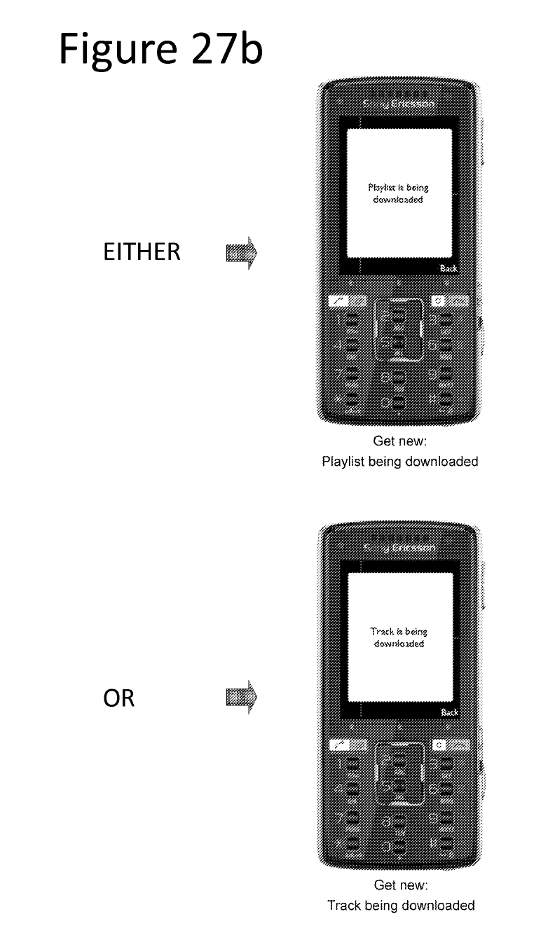

FIGS. 27a and 27b show New playlists. In FIG. 27a, the user starts with the Get new: Main Menu, and goes to the Get new: New playlists Menu, then to Get New: top playlists menu, then to Get new: playlists detail screen. FIG. 27b continues from FIG. 27a. From the Get new: playlists detail screen in FIG. 27a, the user either goes to the Get new: playlist being downloaded screen, or to the Get new: track being downloaded screen.

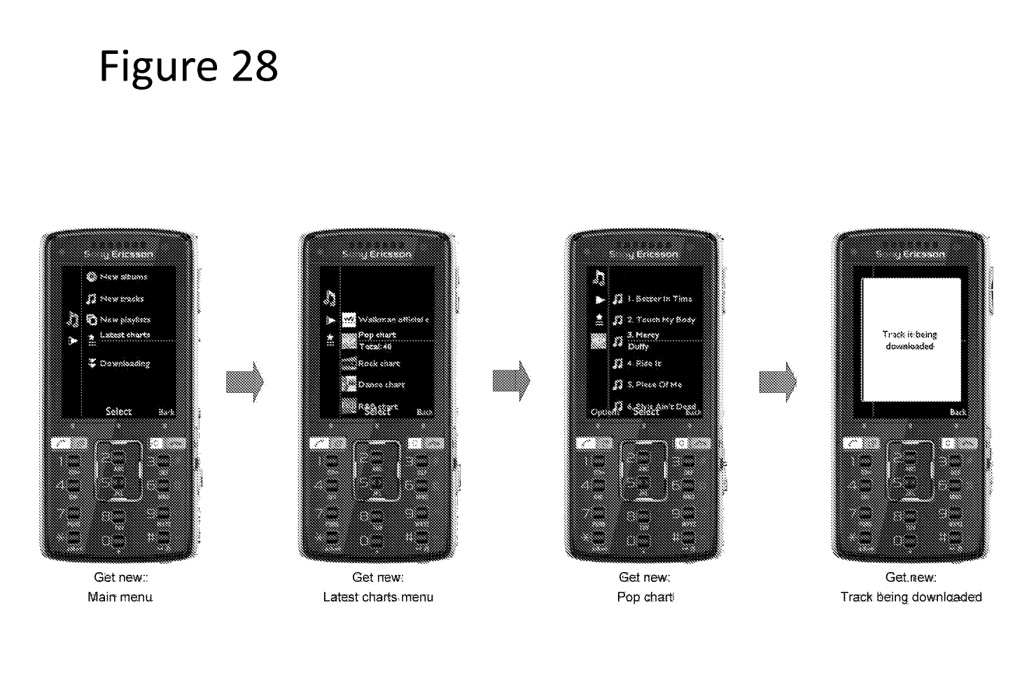

FIG. 28 shows Latest charts. The user can navigate from the Get New: Main Menu, to the Get new: latest charts Menu, to the Get New: Pop chart screen, and finally to the Get new: track being downloaded screen.

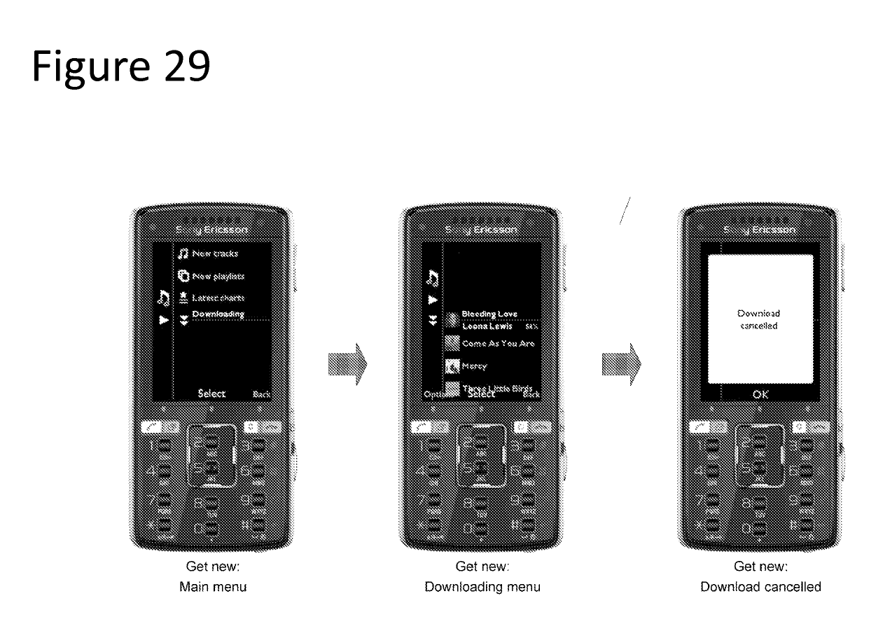

FIG. 29 shows Downloading. The user can navigate from the Get New: Main Menu, to the Get new: downloading Menu, to the Get New: download cancelled screen.

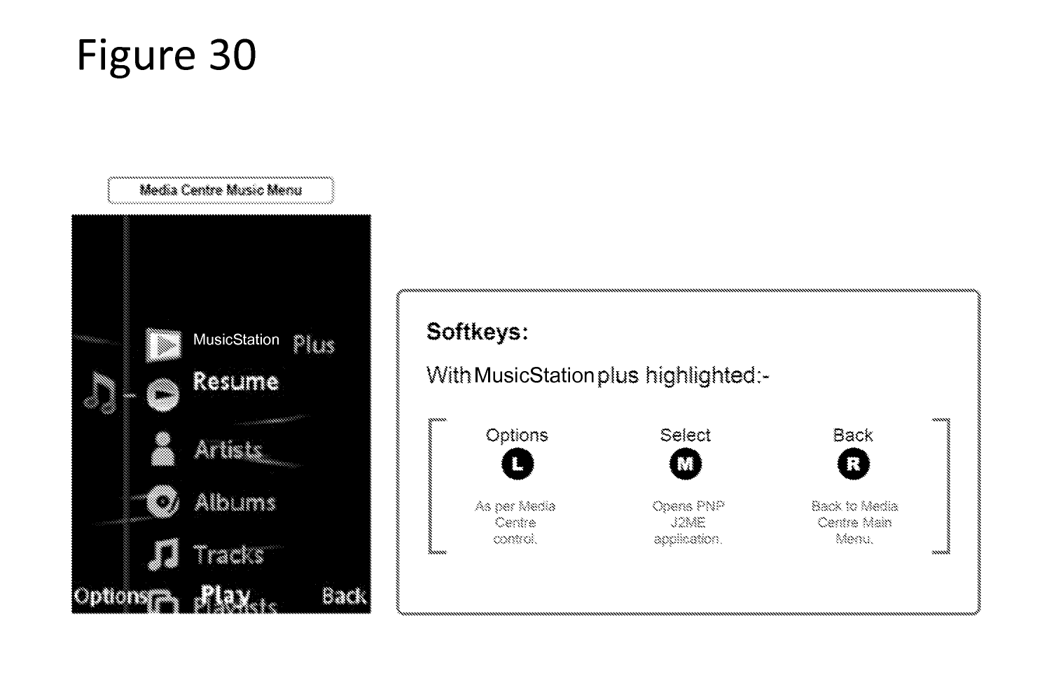

There follows a description of the Screen Flows and Lifecycle of another implementation. This includes the Figures from FIG. 30 to FIG. 79.

FIG. 30 shows the Screen Name: Media Centre Music Menu. The Media Centre Music Menu has a “Hook” to launch the J2ME MusicStation application.

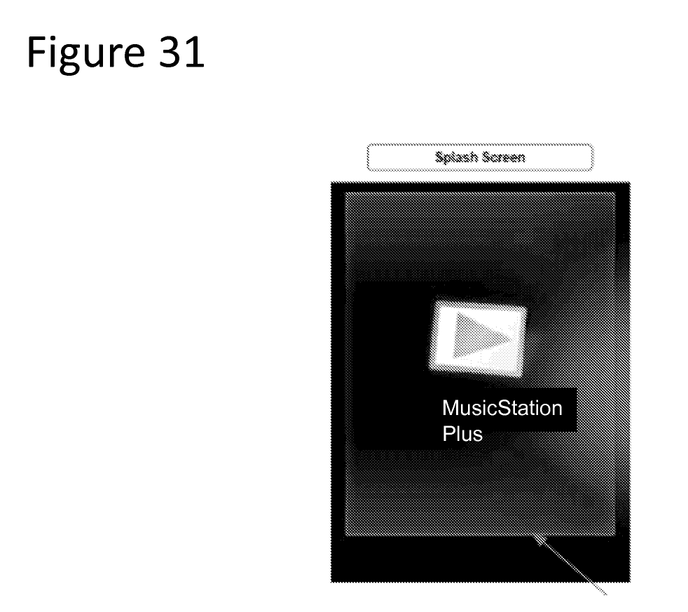

FIG. 31 shows the Screen Name: Splash Screen. The Splash Screen will distract the user from any delays in launching the MusicStation application. There need be no branding for the operator here as this can done in the MusicStation Launcher application. There can be the ability to load a semi-transparent image on top of this (indicated by arrow) to brand the application.

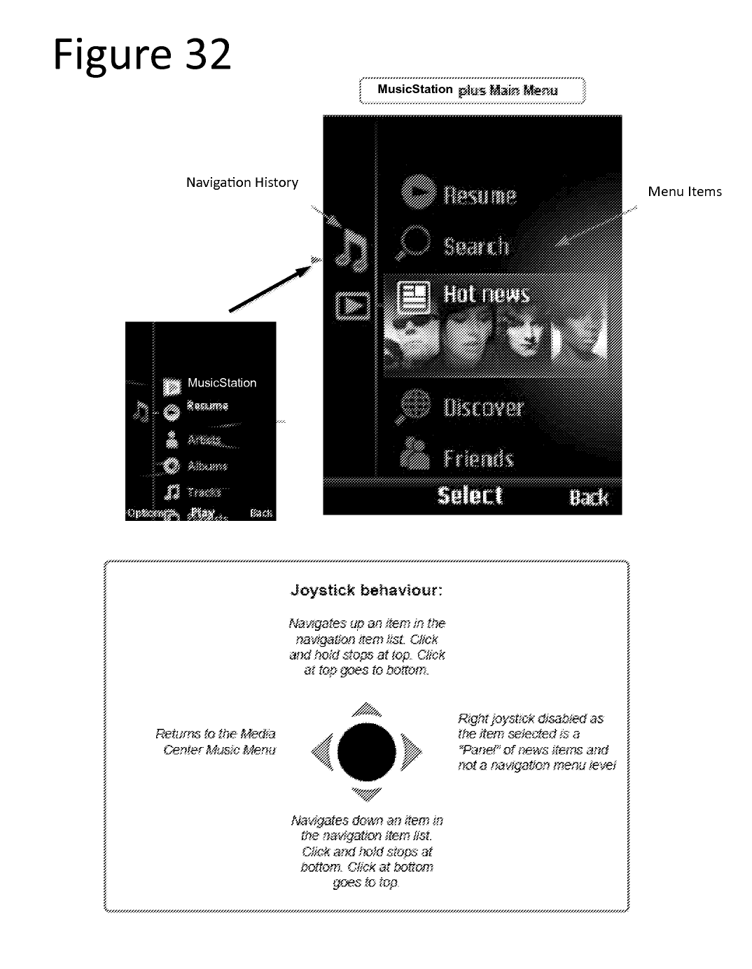

FIG. 32 shows the Screen Name: MusicStation Main Menu. The MusicStation Main Menu (MM) can be the first entry point to the discovery, downloading and social networking of unlimited music. From this screen the user can search for music, read about the latest music news, dive into the rich depths of music discovery, make new friends and manage their downloads. Regarding Navigation History, following from the Media Centre's behaviour the Navigation History tracks the user's progress through the menu structures. Regarding Language Selection, on application start-up if the language has not been explicitly chosen by the user in Options then the program checks the handset language and uses that MusicStation language pack if available. If not then it uses default DEF_LANG from JAD. If that language pack is not available then it defaults to English. The Menu Items may include: Resume, Search, Hot News, Discover, Friends, Downloads, Options.

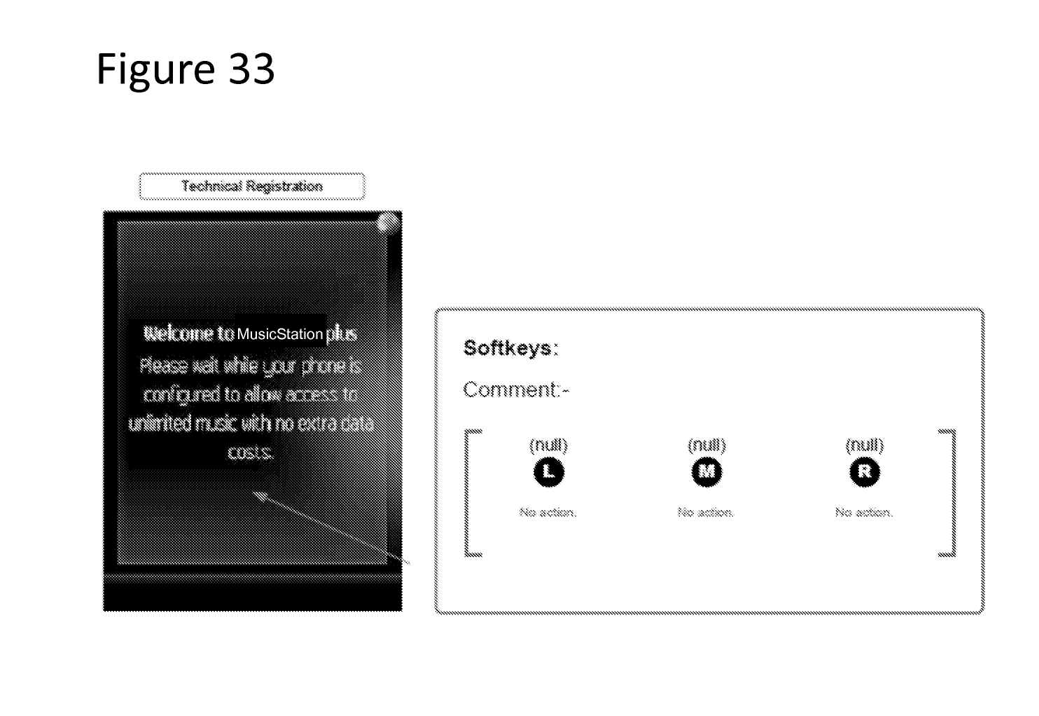

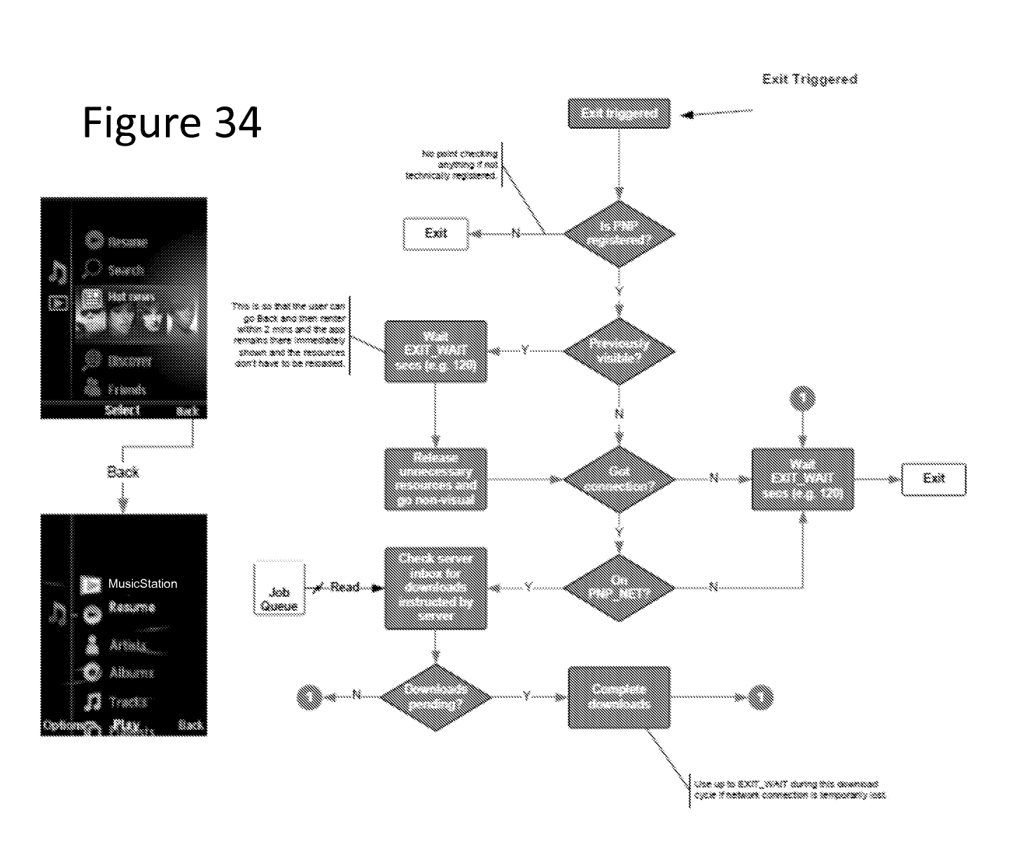

FIG. 33 shows Screen Name: Technical Registration. On the very first start of the MusicStation application it may immediately attempt to technically register the client with the server. The following screen is displayed (FIG. 34).

FIG. 34 shows Screen Name: Exit Logic. FIG. 34 describes the behaviour of the MusicStation application when exiting. Regarding Exit Triggered, This Exit Logic can be triggered by:
User pressing Back on the Main Menu
MusicStation Helper starting up and telling MusicStation to start and invisibly finish any pending downloads
Catching the red key

Notes On FIG. 34:
WAIT_EXIT updatable OTA.
If the application is started whilst it is in this logic, this is dealt with gracefully.
The highlighted menu item is remembered when moving into or out of the Main Menu. If the user exits (Back or joystick left) to the Media Centre Music Menu to manage their music then on re-entry to the MusicStation Main Menu the last highlighted menu item is restored bringing continuity to the user's navigation flow.

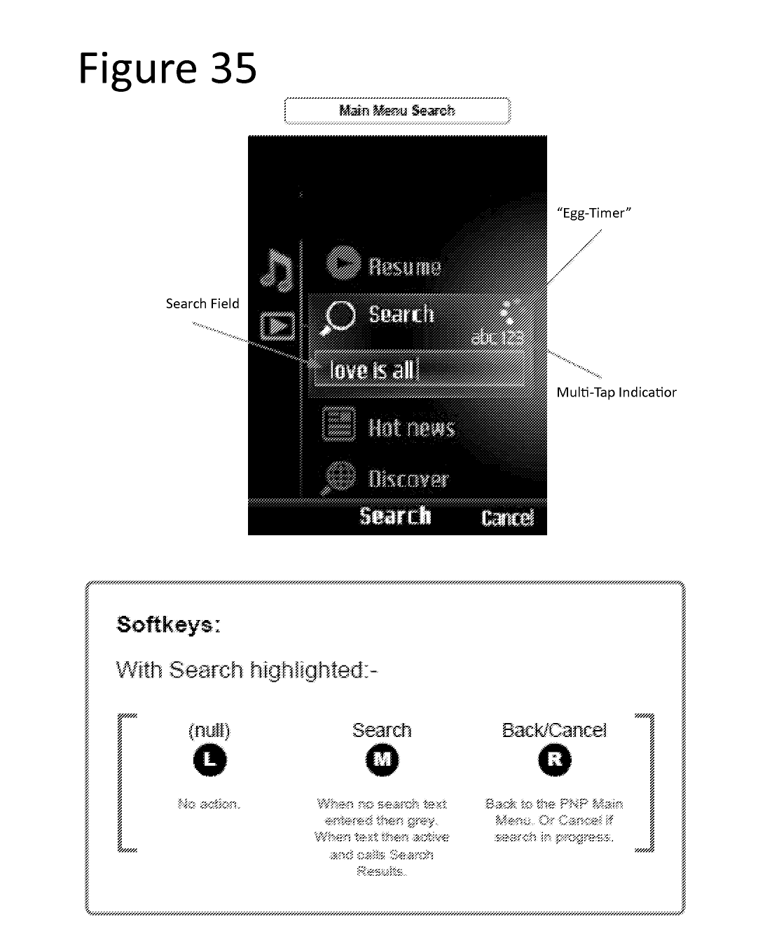

FIG. 35 shows Screen Name: Main Menu Search. This screen describes the behaviour of MusicStation Main Menu when the Search item is highlighted. Regarding Search Field: this text entry search field behaves very similarly to the phone WAP browser's web address box (WAB) to bring continuity to the entire device's UI. When search is highlighted the box is ready for text entry via the keypad. The field is clear (if no previous entry) and the cursor blinks similar to WAB blink rate. The input field does not auto clear if the user navigates away. The input field remembers its last text or search. Regarding “Egg-Timer”: while a search is taking place the “egg-timer” graphic is animated and the RSK changes to “Cancel”. No other user navigation or key input can take place while a search is in progress but the search can be cancelled. Regarding Multi-Tap Indicator: this is similar to the WAB on some device vendor's phones; when typing in the field this multi-tap indicator animates to show which key is pressed. The multi-tap shown may be inversed highlighting—e.g. only one character highlighted at any time. Notes on FIG. 35: Pressing and holding the ‘c’ key will clear the entire search term.

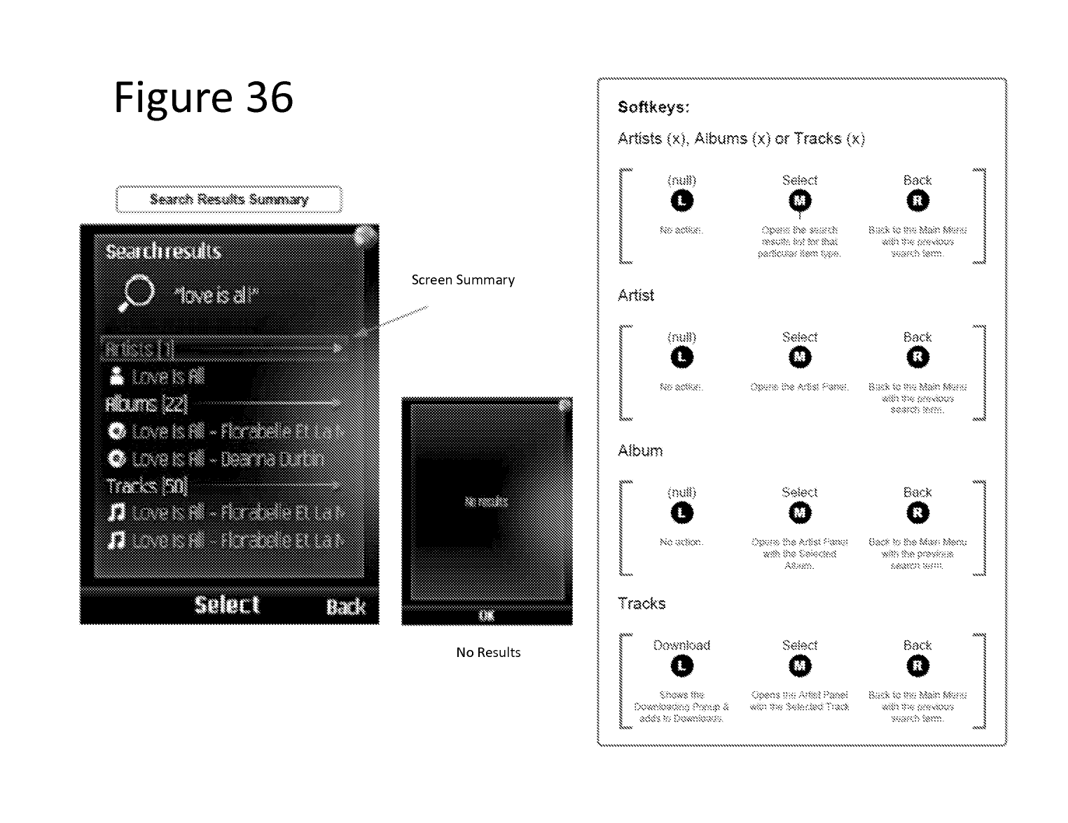

FIG. 36 shows Screen Name: Search Results Summary. This screen describes the behaviour of the initial search results summary after requesting a search from the Main Menu. Regarding No Results: if the search returns no results then a popup message is shown. Clicking OK goes back to the Main Menu with the Search item highlighted so it can be instantly edited. Regarding Screen Summary: Results from the search term are returned. The overall number of results is shown and then divided into the following areas.
Artists [total]
Albums [total]
Tracks [total]

The top two items in each section are listed below the relevant section. Selecting a category drills down to Artist Results, Album Results or Track Results, respectively.

Notes on FIG. 36: search results are presented in a panel with the search term displayed and the overall returns found for the search term. The search summary panel divides the results in to three categories, Artists, Albums and Tracks. The total number of returns in each section is shown in brackets. The top two returns in each section are also displayed below the three headings. If no results are returned in any of the three sections then that item is not displayed. e.g. If only Track results are returned then Artists (0) or Albums (0) are omitted from the screen leaving only Tracks (x) and the top two track results. In the unlikely event that no results are returned from the search results then a popup will explain that the search term returned no results and the user is returned to the Search highlight item and is able to edit their text input. Pressing Back returns the user to the MusicStation Main Menu with the search term highlighted and editable for the user to adjust the search term. A scroll bar is displayed if the number of items exceeds the screen display. The maximum returns allowed for any given section is e.g. 50 giving a maximum possible 150 results overall.

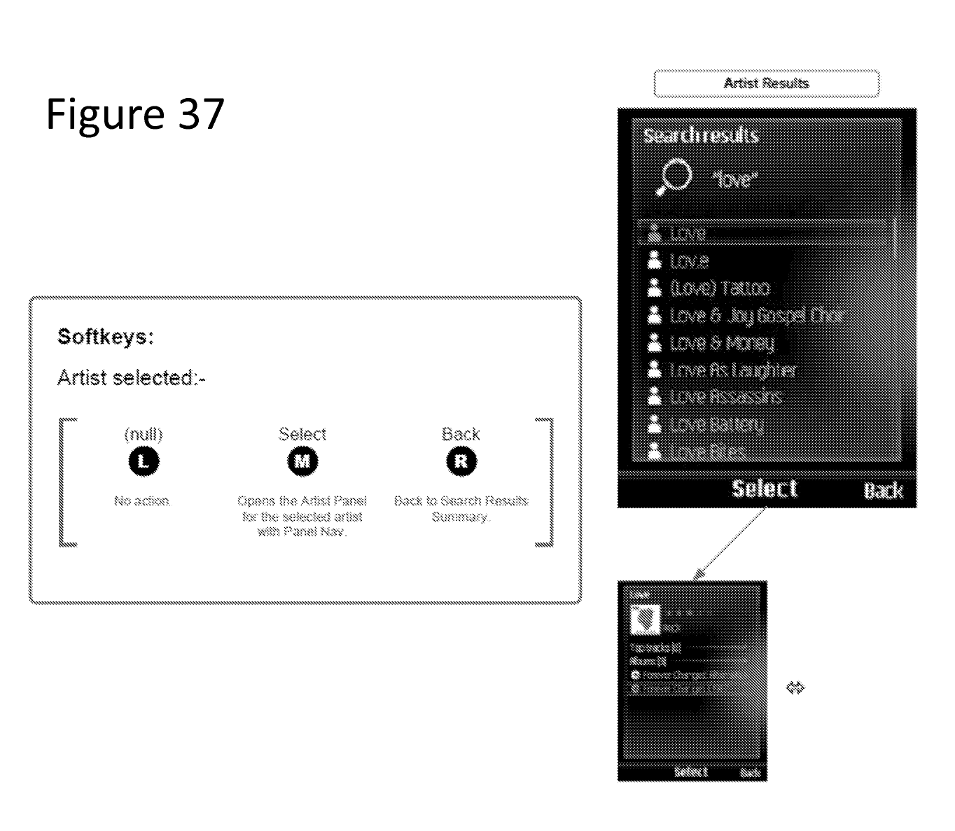

FIG. 37 shows Screen Name: Artist Results. This screen describes the behaviour of the Artist Results screen which is the screen which shows the list of artists returned from a search. Notes on FIG. 37: A scroll bar is displayed if the number of items exceeds the screen display. The maximum returns allowed for any given section is e.g. 50 giving a maximum possible 150 results overall.

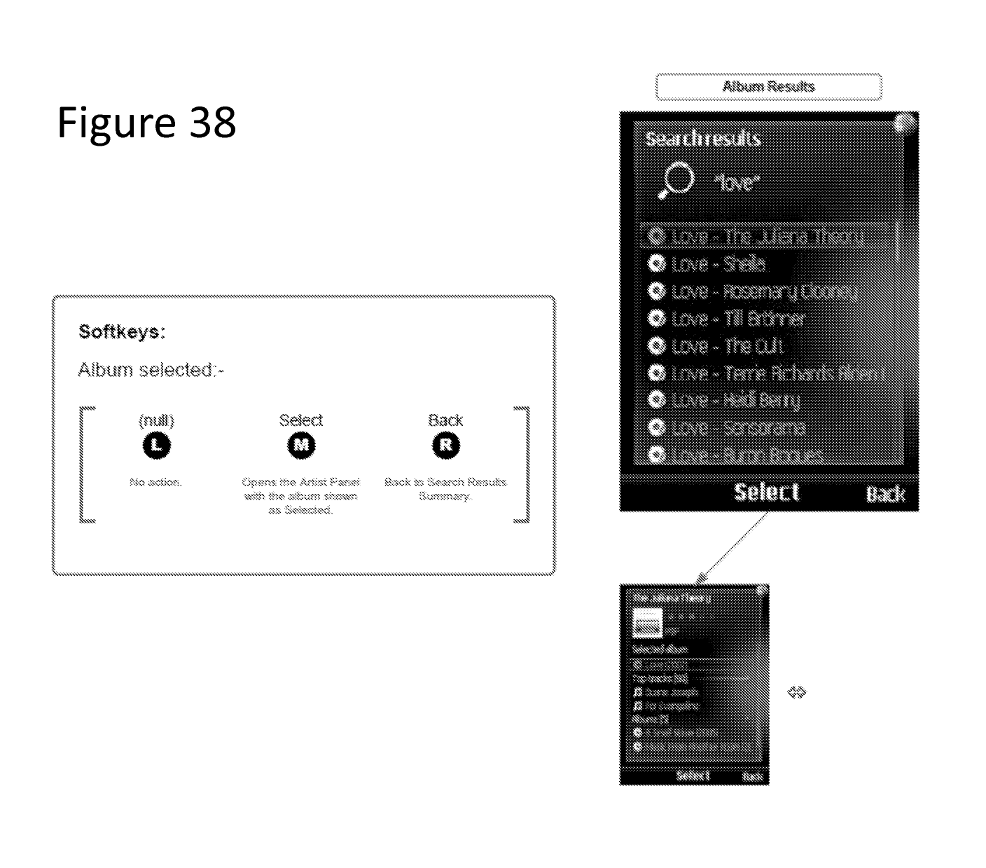

FIG. 38 shows Screen Name: Album Results. This screen describes the behaviour of the Album Results screen which is the screen which shows the list of albums returned from a search. Notes on FIG. 38: A scroll bar is displayed if the number of items exceeds the screen display. The maximum returns allowed for any given section is e.g. 50 giving a maximum possible 150 results overall.

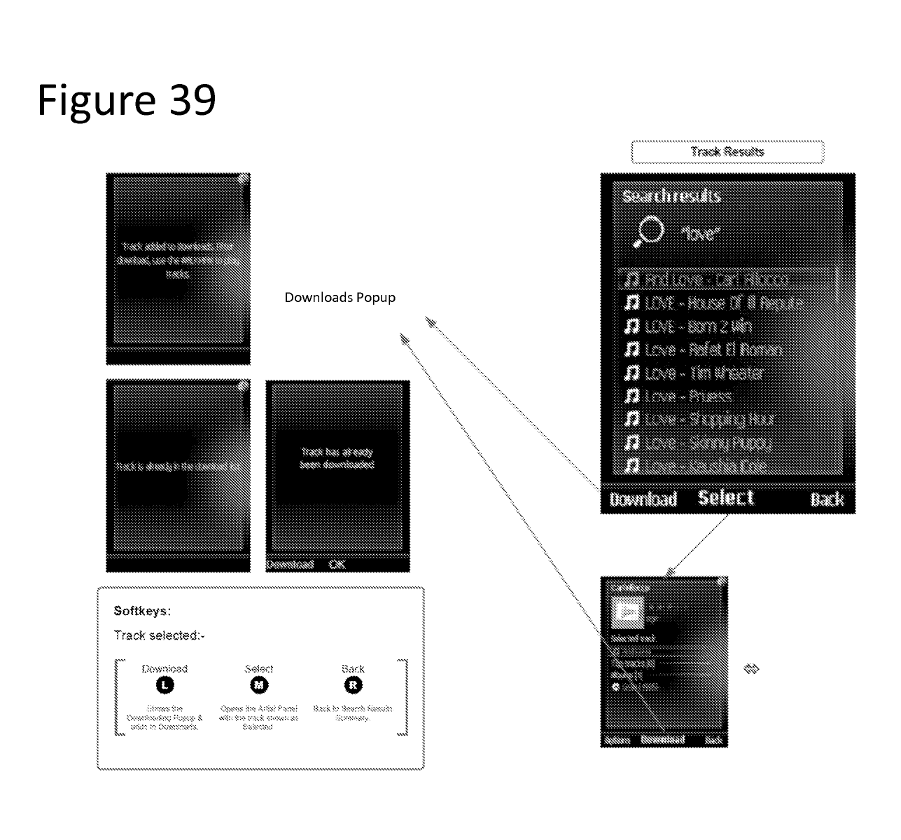

FIG. 39 shows Screen Name: Track Results. This screen describes the behaviour of the Track Results screen which is the screen which shows the list of tracks returned from a search. Regarding Downloads Popup, when the user clicks on “Download” this popup is shown and the track is added to Downloads. This popup is a transient popup meaning that after some time it disappears. Notes on FIG. 39: a scroll bar is displayed if the number of items exceeds the screen display. The maximum returns allowed for any given section is e.g. 50 giving a maximum possible 150 results overall.

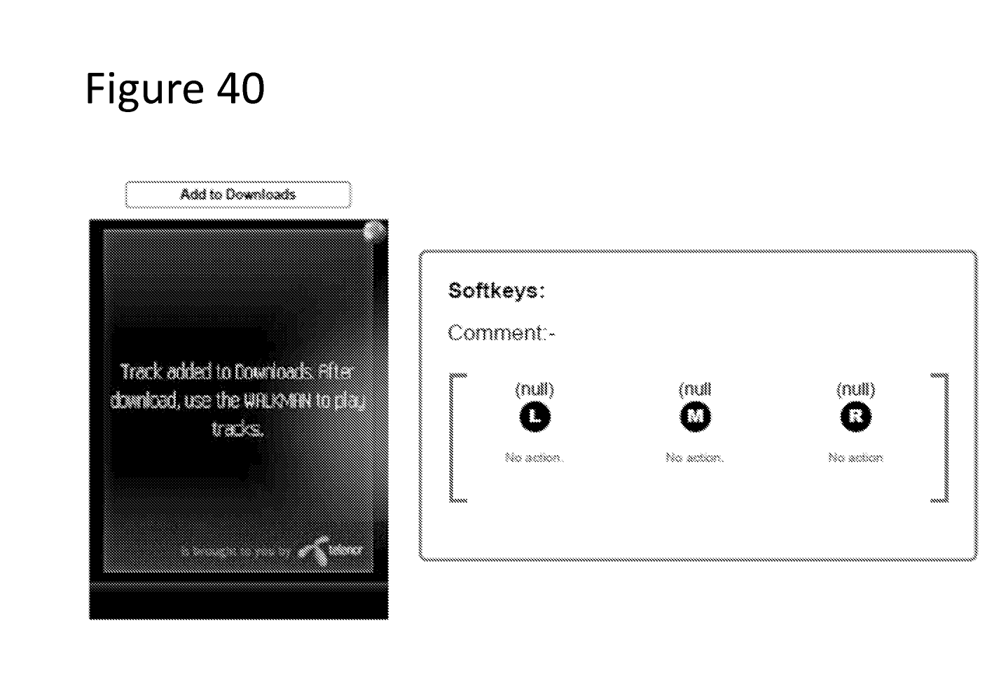

FIG. 40 shows Screen Name: Add to Downloads. This is the transient pop up for showing the user after they click on Download on a track. It disappears after a configurable number of milliseconds.

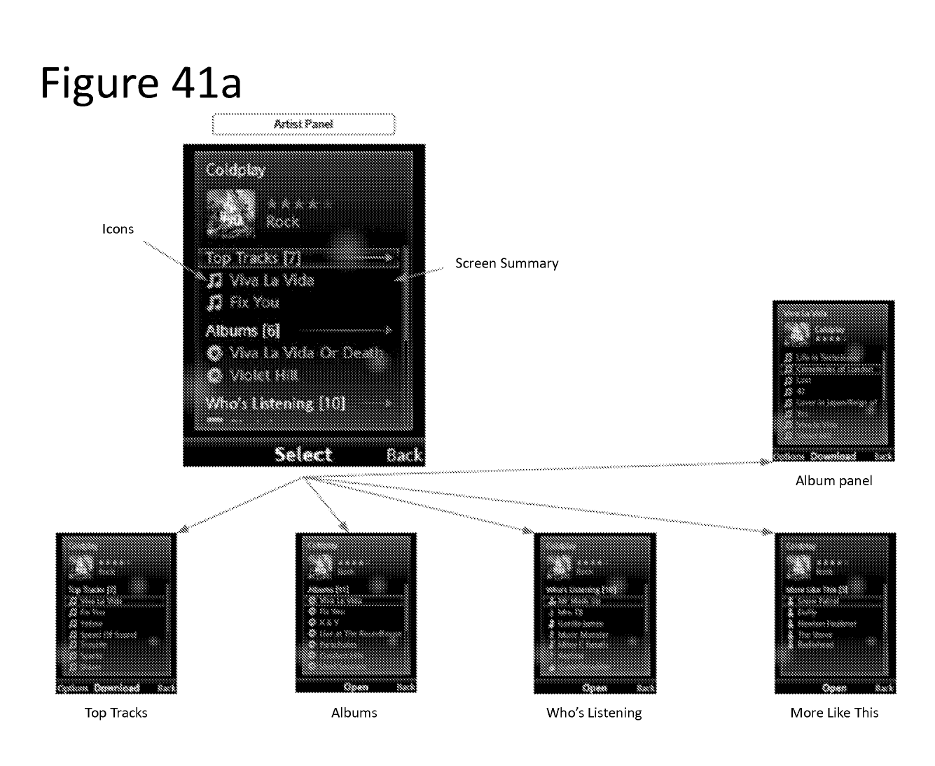

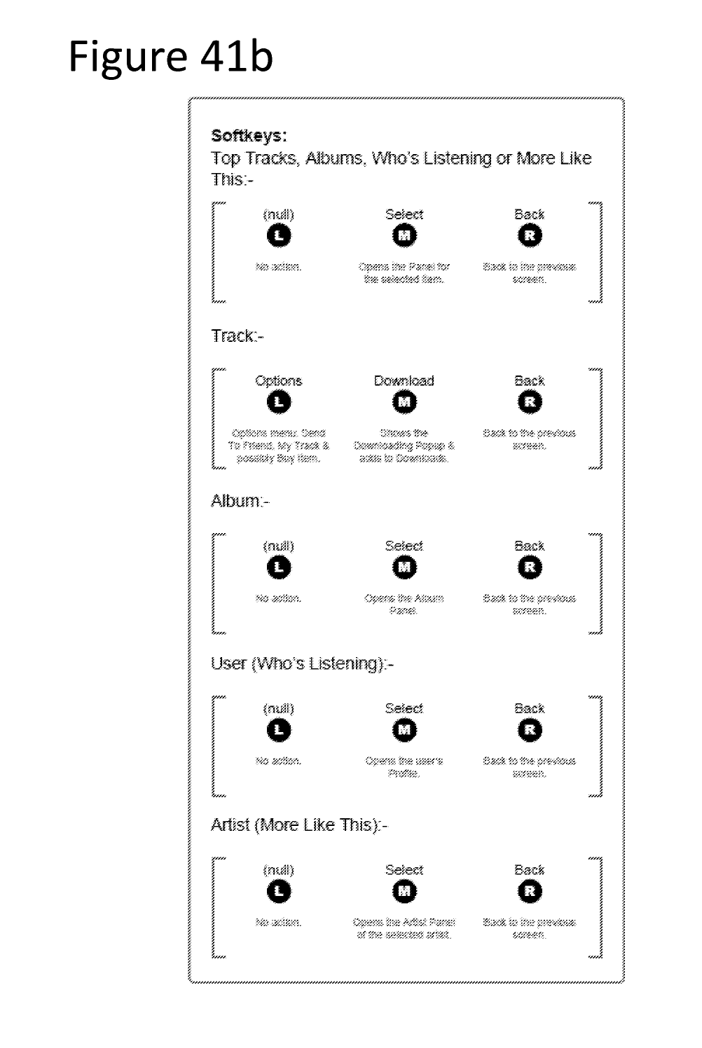

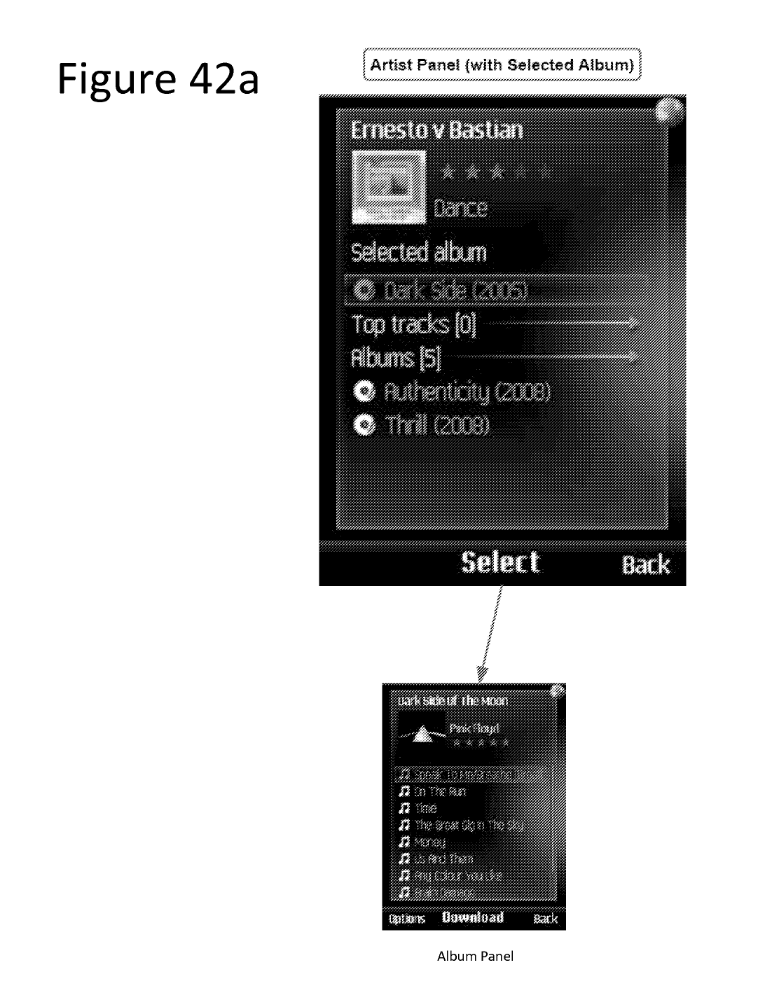

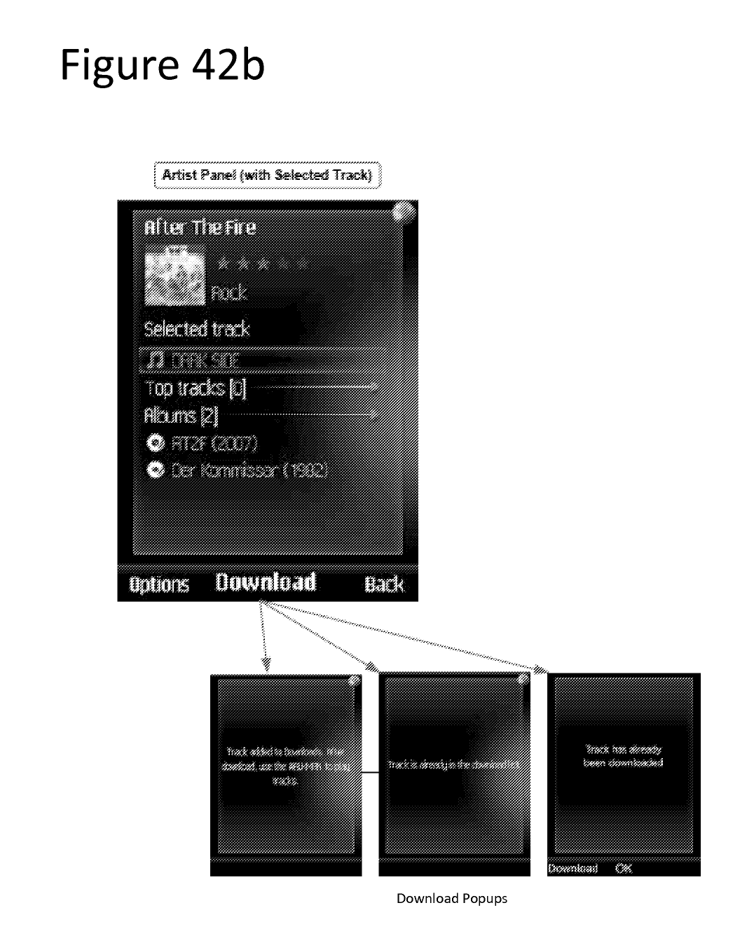

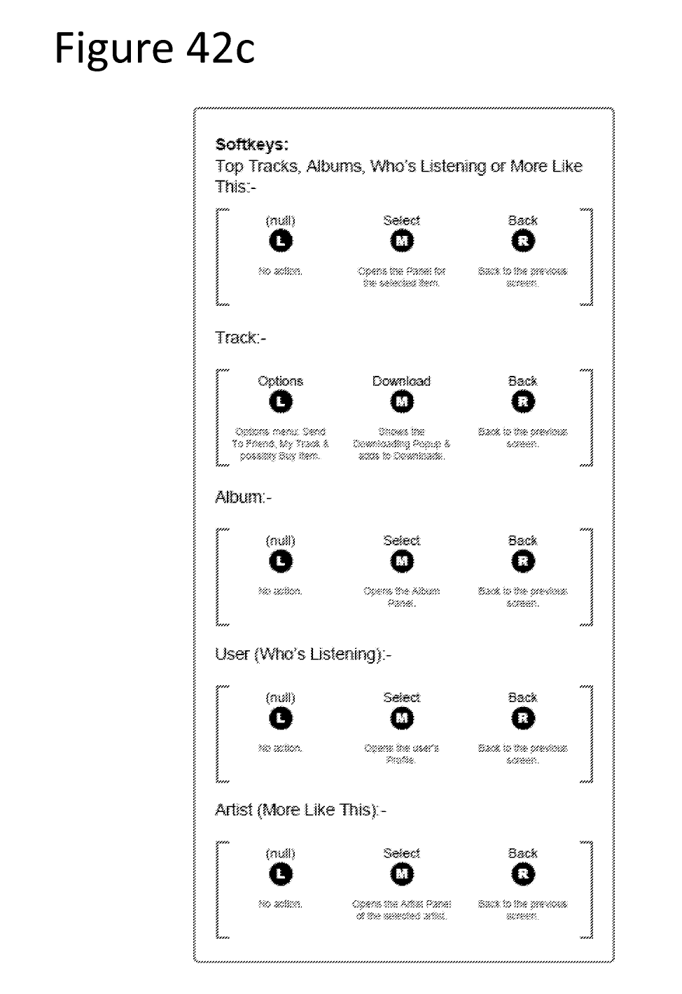

FIGS. 41a and 41b show Screen Name: Artist Panel (no Selected item). These FIGS. 41a and 41b relate to a screen which describes the behaviour of the Artist Panel when it is opened without the context of a Selected Album or a Selected Track (see FIG. 42). In FIG. 41a, regarding the Screen Summary: the collective works of an artist, the top list of users listening to the artist, and similar artists, are contained within the following items.
Top Tracks (X)—lists top tracks for the artist as listened to by MusicStation users.
Albums (X)—lists all albums and releases by the artist.
Who's Listening—lists the top MusicStation users listening to the artist (if any are currently listening)
More Like This—lists similar artists to the current artist.

The top two items in each section are listed below the relevant section heading to facilitate the quick browsing of MusicStation content. Regarding Icons, these icons are the default icon for that object. Regarding Top Tracks, this screen shows the top tracks for this artist; Download adds to Downloads. Regarding Albums, this screen shows the list of albums/releases for this artist. It opens the Album Panel for the selected album. Regarding Who's Listening: this screen shows the list of up to e.g. 10 users who have most recently listened to this artist. It opens the Friend Panel. Regarding More Like This: this screen shows the list of up to e.g. 10 similar artists to the current artist. It opens the Artist Panel for the selected artist. Regarding Album Panel: this screen shows the Tracks on a selected album. Softkeys as per a track.

FIG. 41b shows Softkeys: Top tracks, Albums, Who's listening or More like this.

Notes on FIGS. 41a and 41b: the artist name scrolls after a brief pause if the text exceeds the limits of the screen. The artist image chosen is preferably the latest release by the artist or an editorially selected image. The artist star rating is generated by the popularity of the artist across the MusicStation service. The artist genre is the primary genre for the artist. The LSK Options menu allows for extended functionality. It gives the user the opportunity to Send the track to a friend or add the track to their profile as ‘My Song’. OTA data setting controls the display of “Buy Item” in the LSK Options menu so as to allow the retrospective addition of a MusicStation Arena or operator portal track sensitive link (WAP launch).

FIGS. 42a, 42b and 42c show Screen Name: Artist Panel (with Selected Album/Track). These FIGS. 42a, 42b and 42c describe the behaviour of the Artist Panel when it is opened with the context of a Selected Album or a Selected Track (i.e. user clicks Open on an Album or Track). The Selected Album/Track is shown at the top of the panel.

In FIG. 42a, regarding Album Panel: this screen shows the Tracks in a selected album. Softkeys as per a track. In FIG. 42b, regarding Download Popups: these popups represent the different messages displayed dependant on the progress or history of the selected track.

Notes on FIGS. 42a, 42b and 42c: Softkeys are as per Album and Track softkeys on an Artist Panel (see Artist Panel). The LSK Options menu allows for extended functionality. It gives the user the opportunity to Send the track to a friend or add the track to their profile as ‘My Track’. OTA data setting controls the display of “Buy Item” in the LSK menu so as to allow the retrospective addition of a MusicStation Arena or operator portal track sensitive link (WAP launch).

FIG. 43 shows Screen Name: Album Panel. This Figure describes the behaviour of the Album Panel. The album panel displays the tracks that appear in a release. Notes on FIG. 43: an extra option is inserted into the Options menu that allows the user to download the entire album. Other options are as per individual track options.

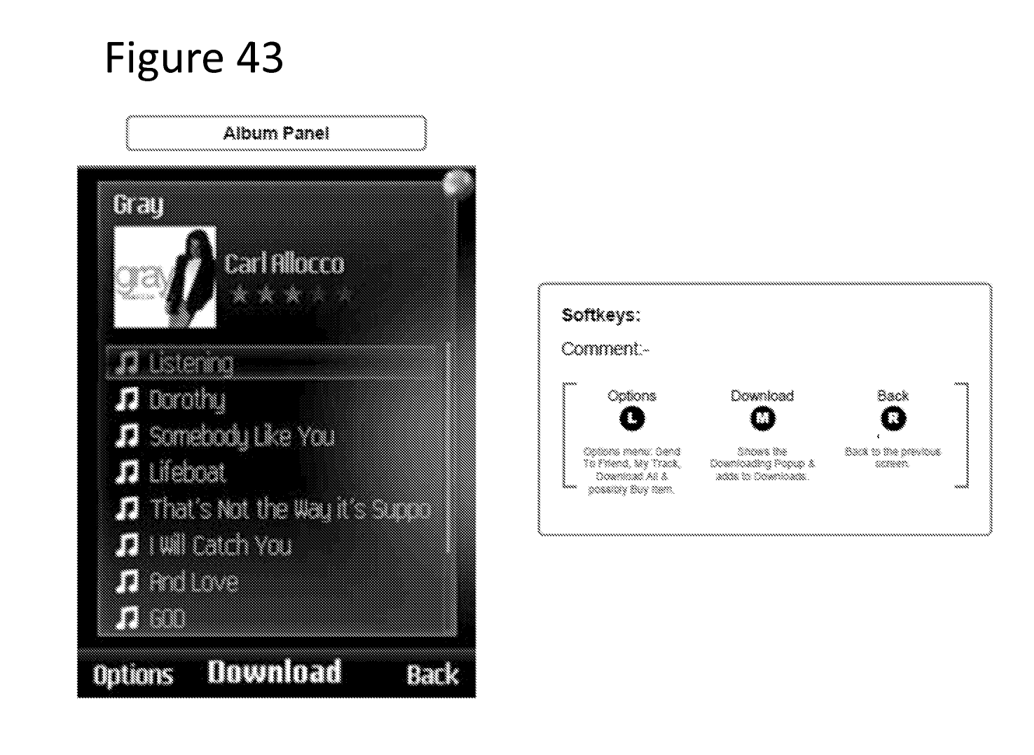

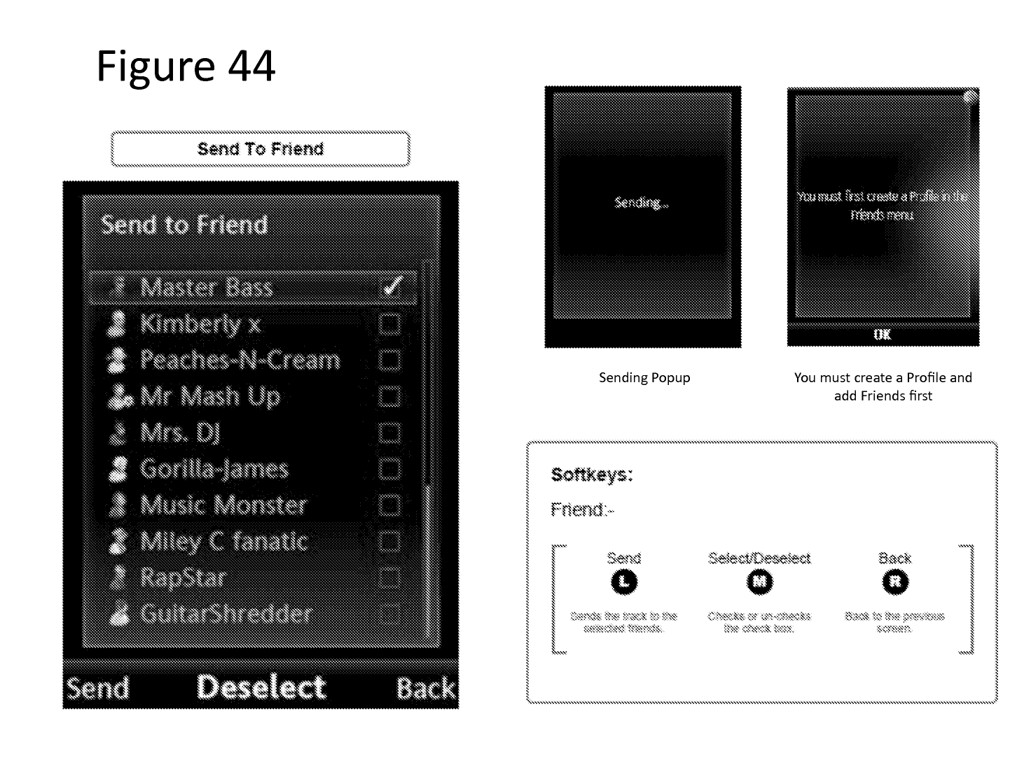

FIG. 44 shows Screen Name: Send To Friend. This Figure describes the behaviour of Send To Friend. The screen lists all a user's current friends and allows them to choose which friend they wish to send the track to. Regarding Sending Popup: when the user clicks “Send” this popup is shown and the track is Sent to the selected friends. This popup is a transient popup, meaning that after a number of milliseconds (configurable) it disappears. In FIG. 44, the error screen is possible: this says “You must create a Profile in the Friends menu”. This is because you must create a Profile and add Friends first: you must add friends before you can send Dismiss to previous screen. Notes on FIG. 44: multiple friends can be selected or de-selected. Pressing Send displays a transient popup to confirm the sending. If no friends are selected then the LSK Send is greyed out and is inactive.

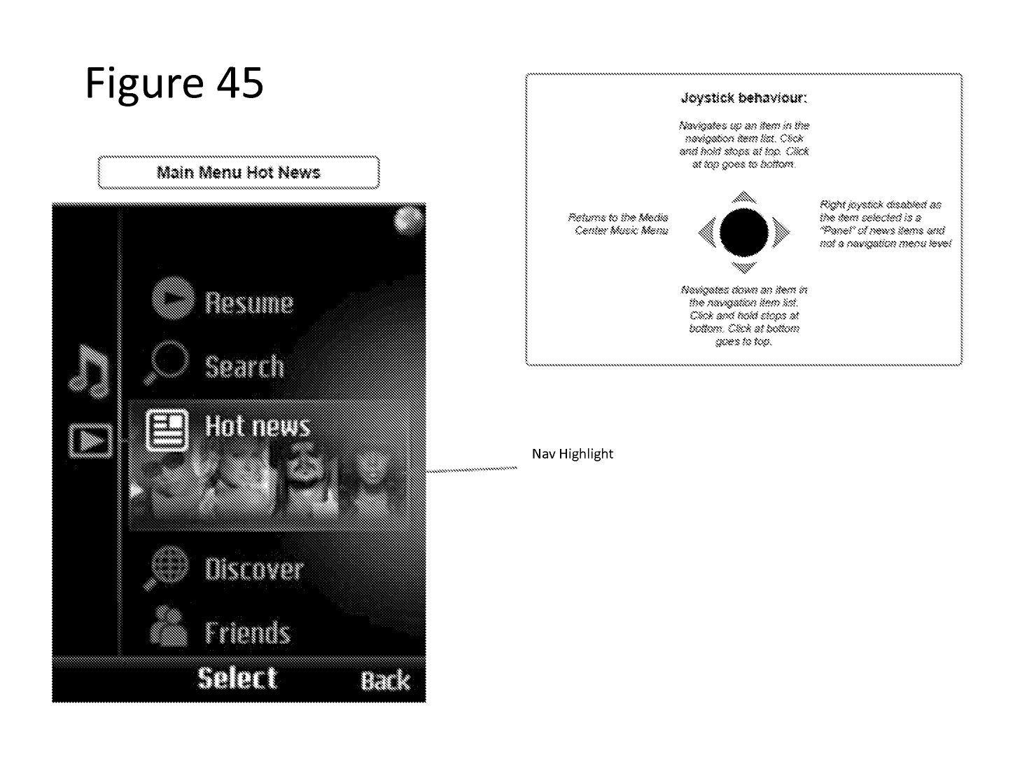

FIG. 45 shows Screen Name: Main Menu Hot News. This screen describes the behaviour of the Hot News item in the MusicStation Main Menu. Regarding Nav Highlight: the image which is the background to the Nav Highlight is dynamic. If the application has more than one image it will cycle through the available images e.g. every 5 seconds (whilst watching). New images can be downloaded OTA and old images retired. Static background may be in the image.

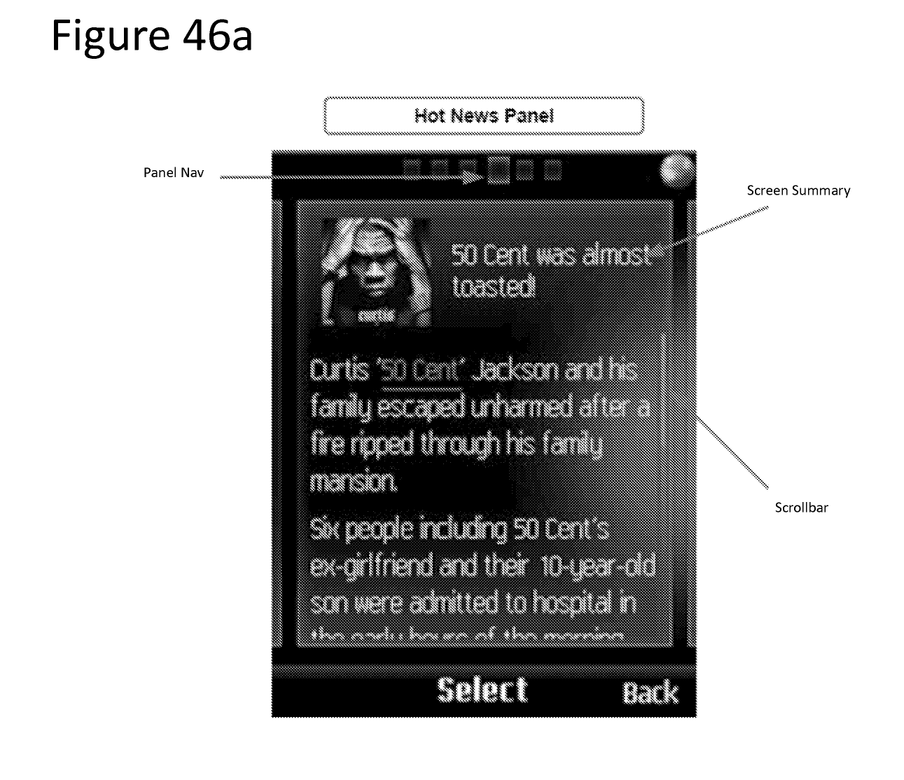

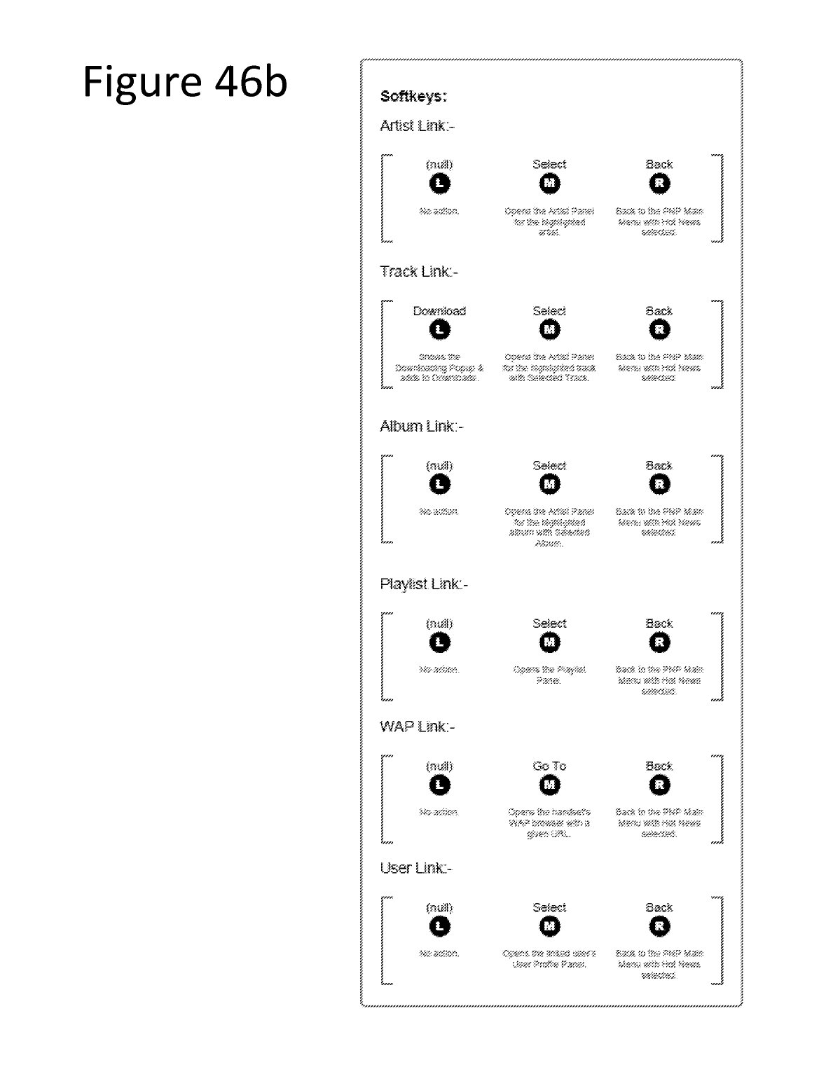

FIGS. 46a and 46b relate to Screen Name: Hot News Panel. This screen describes the editorially created music news delivered and displayed OTA to MusicStation users. The news stories contain links for Artists, Albums, Tracks, Playlists, WAP links and MusicStation Users that are embedded and relevant to each individual story.

In FIG. 46a, regarding Panel Nav: the Panel Nav boxes indicate the number of stories available and the highlighted box indicates which story is currently being viewed. Left and Right joystick input scrolls through each story item. Click and hold stops at the end. Click at extreme left or right of list moves the selection around to the next item at the opposite end. When viewing a story using left and right panel nav the top of the story is always shown. Regarding Screen Summary: these news stories contain a selection of highlighted links.
Artist—opens the linked Artist Panel.
Album—opens the linked album in the relevant Artist Panel with the Selected Album.
Track—opens the linked track in the relevant Artist Panel with the Selected Track.
Playlists—opens the linked Playlist Panel.
WAP links—opens the linked URL in the handsets browser.
User—opens the linked user in the relevant User Profile Panel.

Regarding Scrollbar: the scroll bar indicates the viewable portion of the current story. Moving the joystick up and down scrolls through the text of the story highlighting the links one at a time with an underline as they are encountered in the text. Click and hold scrolls up/down to the extremes of top or bottom of the story and stops. Scrolling does not wrap around and input will be ignored at the extremes of top and bottom. On entry highlight first link in page if a link is visible.

Notes on FIGS. 46a and 46b: opening a WAP Link in the browser uses the manufacturer signing to remove the user permission prompt. The Hot News stories are generated editorially by an experienced content team fully populated with numerous links to all the relevant artists, albums, tracks, playlists, URL's or user profiles discussed in the editorial. The content is downloaded OTA and updated weekly. There is a maximum number of 12 items stored at any given time. The stories can contain up to e.g. 1000 characters. The Middle Soft key (“MSK”) is (null) when no link is selected/highlighted. The viewed story is remembered on exiting Hot News (back to Main Menu) and recalled on subsequent entry into Hot News.

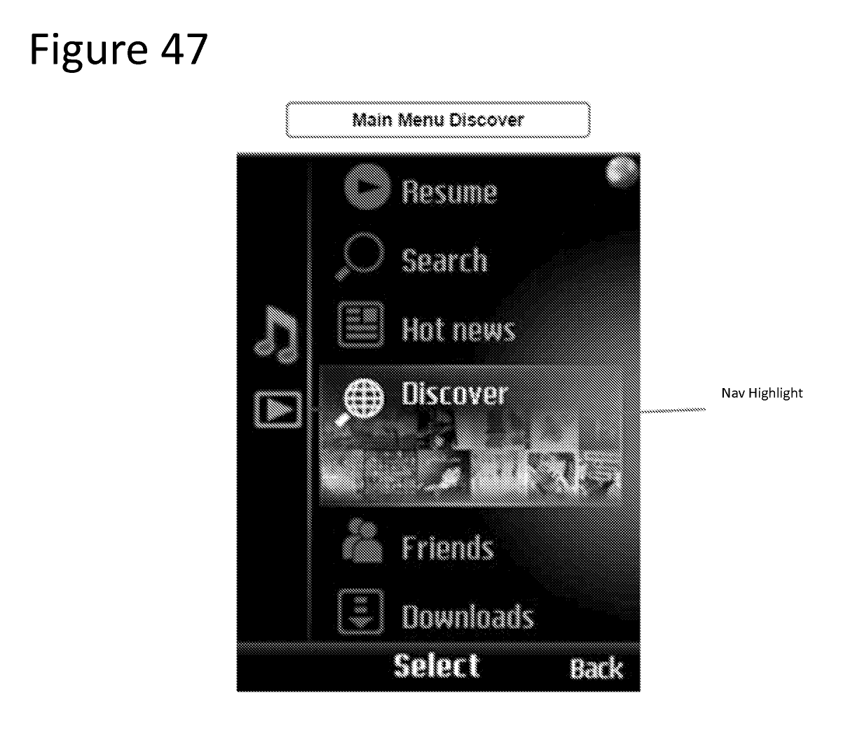

FIG. 47 shows Screen Name: Main Menu Discover. This screen describes the behaviour of the Discover item in the MusicStation Main Menu. Regarding Nay Highlight: the image which is the background to the Nav Highlight is static but can be replaced OTA. Notes on FIG. 47: clicking Select MSK or right joystick opens the Discover Menu.

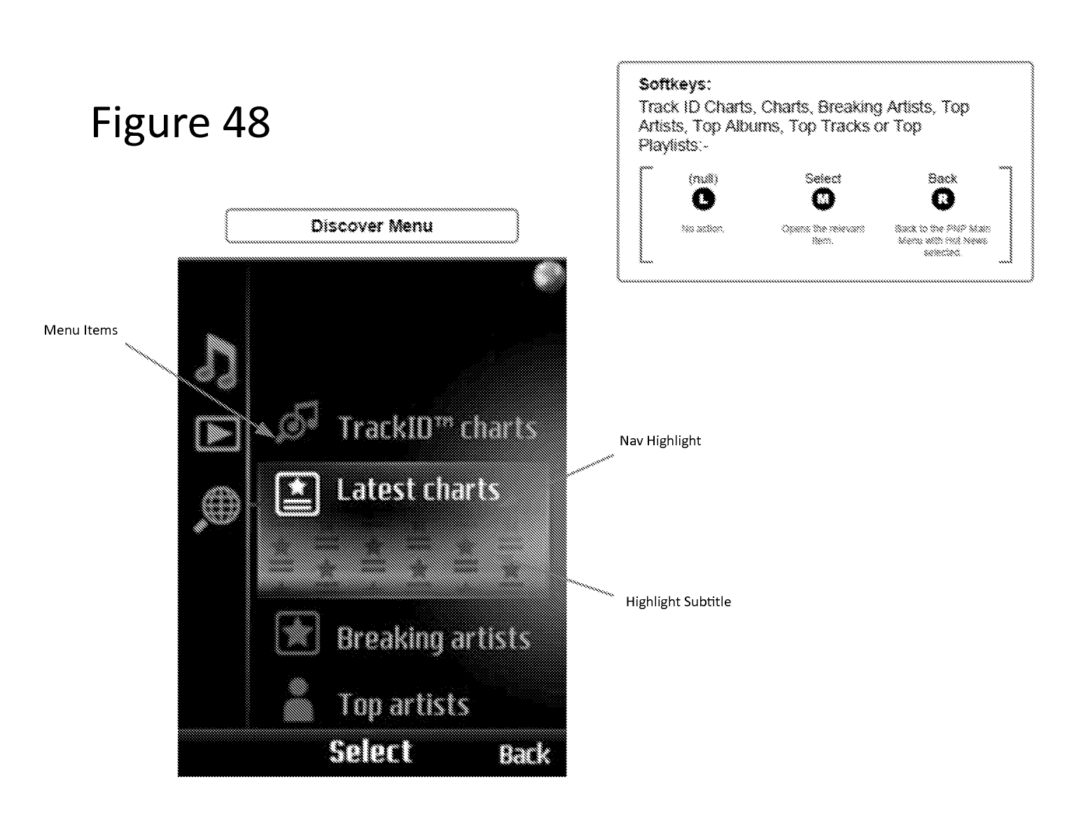

FIG. 48 shows Screen Name: Discover Menu. This screen describes the behaviour of the Discover Menu and the features it provides access to. Menu Items are: TrackID™ Charts, Latest Charts, Breaking Artists, Top Artists, Top Albums, Top Tracks, Top Playlists. Regarding Nav Highlight: the image which is the background to the Nav Highlight is static but can be replaced OTA. This is the same for all similar Nav Highlight images (except Hot News on the Main Menu). Regarding Highlight Subtitle: when highlighted the subtitle is always blank. Notes on FIG. 48: all these items except for TrackID™ Charts & Breaking Artists are auto generated sets defined by the listening behaviour of the MusicStation users on the service and updated weekly.

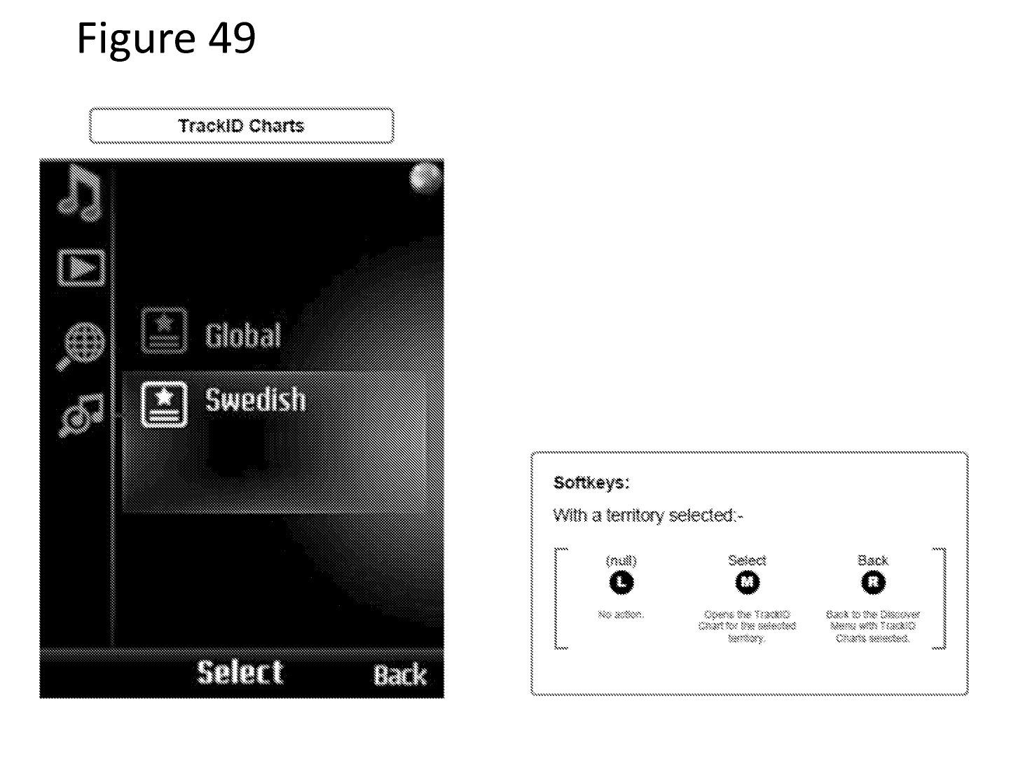

FIG. 49 shows Screen Name: TrackID Charts. This screen describes the behaviour of TrackID Charts menu. It provides the user with a view of the top tracks being identified using TrackID in different territories.

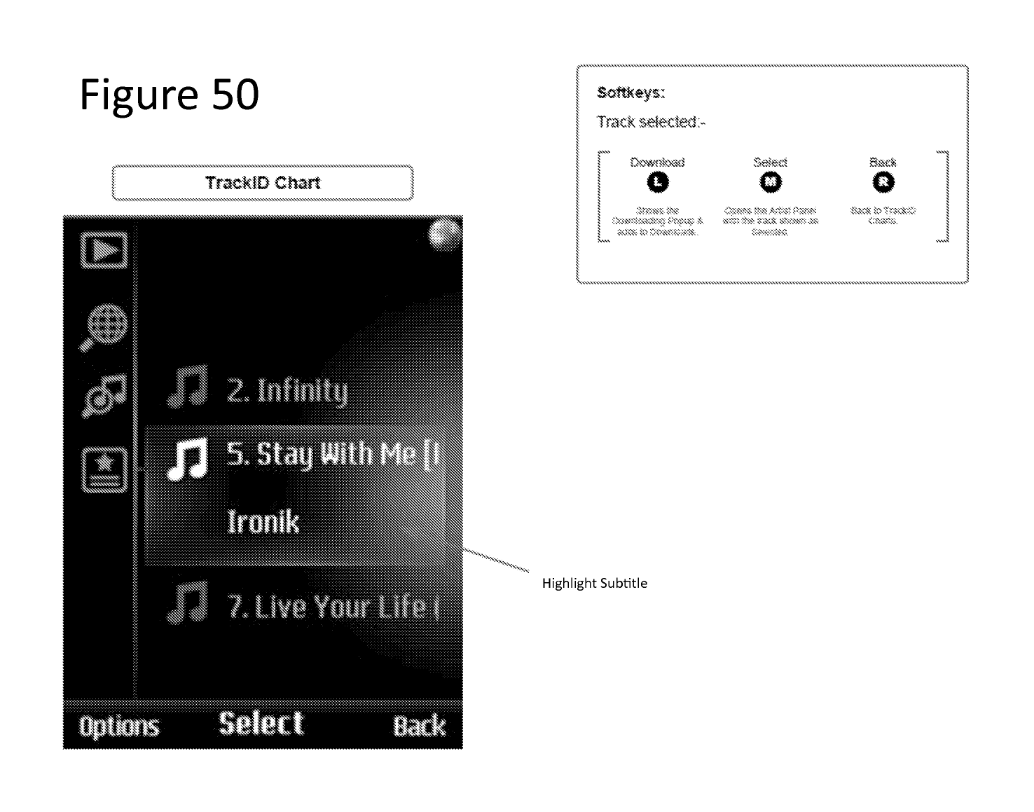

FIG. 50 shows Screen Name: TrackID Chart. This screen describes the behaviour of the TrackID Chart menu. It shows the TrackID Chart list for a selected territory. Regarding Highlight Subtitle: this shows the artist for the highlighted track. If either the track title or the artist name is too long for display then it scrolls automatically when highlighted. Notes on FIG. 50: the tracks are shown with a numerical value ahead of the track title to indicate their position and popularity on the TrackID service. The displayed tracks are matched against the catalogue to ensure that all items are available in the relevant user's country catalogue of tracks. Anything not matched is omitted from the chart rather than having an inactive item. Hence the numbers may not be continuous. A TrackID Chart has a maximum of e.g. 40 items.

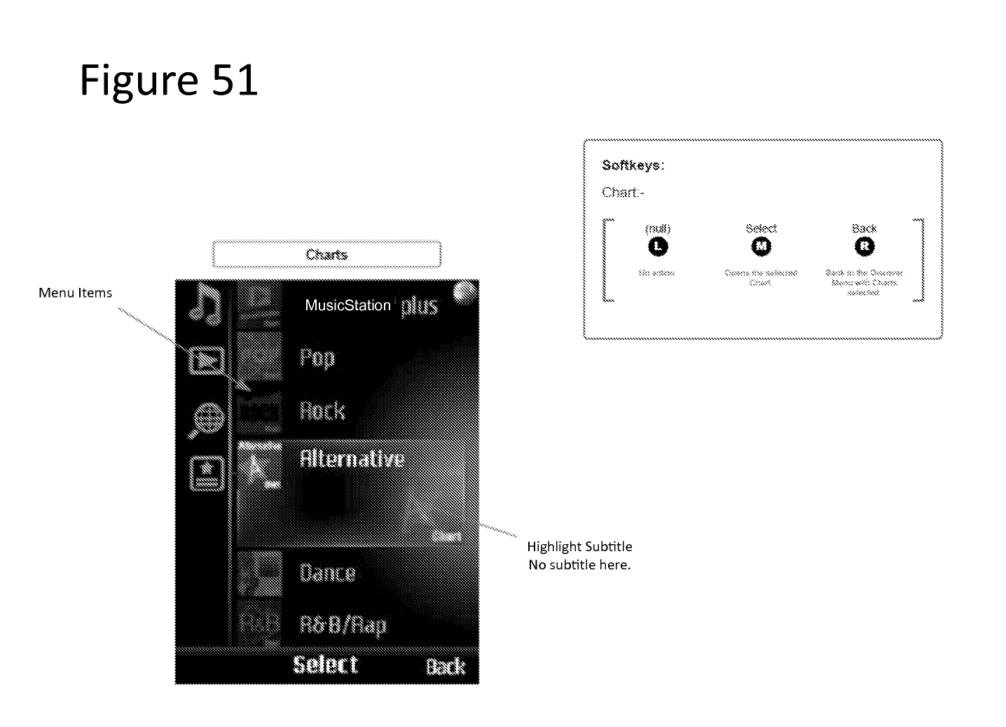

FIG. 51 shows Screen Name: Charts. This screen describes the behaviour of the Charts menu item in Discover. The Menu Items are: MusicStation, Pop, Rock, Alternative, Dance, R&B/Rap. Regarding Highlight Subtitle, no subtitles are shown here. Notes on FIG. 51: these are auto generated charts based on track plays across the MusicStation territory and organised by primary genre. The definition of the available charts, titles, images and which charts are linked to are all updatable OTA. Chart lists contain a maximum of e.g. 40 tracks. MusicStation chart is the main service chart and contains e.g. the top 40 most popular tracks per week.

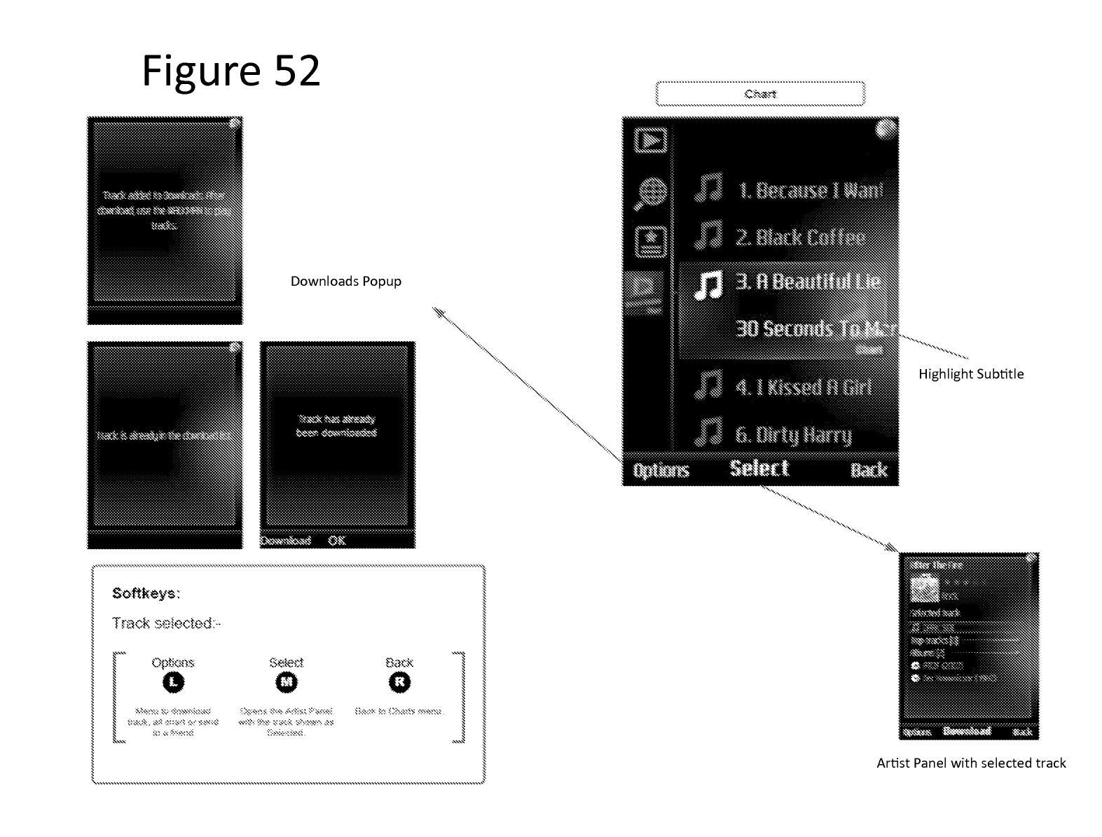

FIG. 52 shows Screen Name: Chart. This screen describes the behaviour of a Chart. Regarding Downloads Popup, when the user clicks on “Download” this popup is shown and the track is added to Downloads. This popup is a transient popup meaning that after some time it disappears. Regarding Highlight Subtitle, this shows the artist for the highlighted track. Notes on FIG. 52: the tracks are shown with a numerical value ahead of the track title to indicate their position and popularity on the service. Charts have a maximum of e.g. 40 track items. Charts are generated on a regular basis (e.g. weekly) and represent the most popular tracks organised by sets and genres on the MusicStation service. They present the most up-to-date representation of current music trends today.

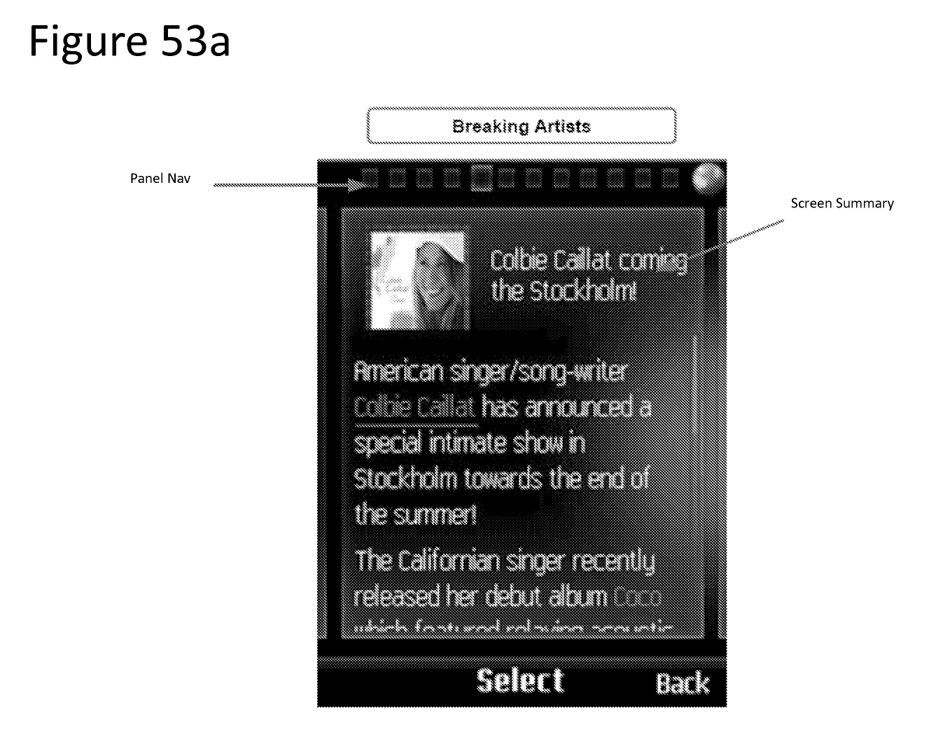

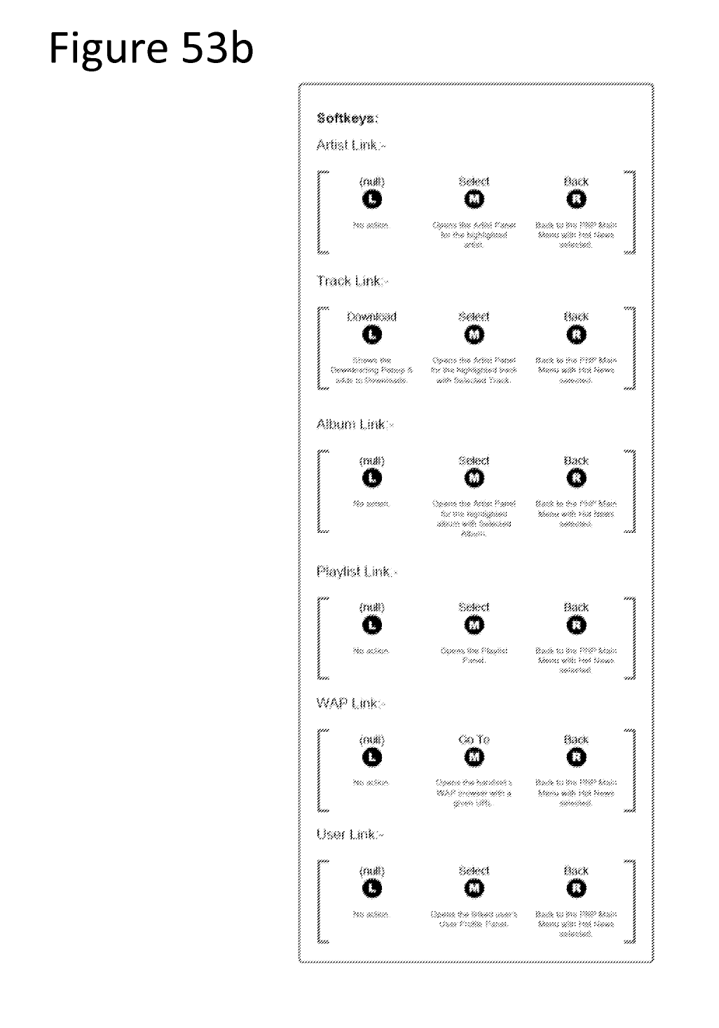

FIGS. 53a and 53b show Screen Name: Breaking Artists. This screen describes the editorially created Breaking Artists news for new, upcoming and breaking artists delivered and displayed OTA to MusicStation users. The Breaking Artist stories can contain links for Artists, Albums, Tracks, Playlists, WAP links and MusicStation Users that are embedded and relevant to each individual story. Regarding Panel Nav: the Panel Nav boxes indicate the number of Breaking Artist stories available and the highlighted box indicates which story is currently being viewed. Left and Right joystick input scrolls through each Breaking Artist item. Click and hold stops at the end. Click at extreme left or right of list moves the selection around to the next item at the opposite end. When viewing a Breaking Artist using left and right panel navigation, the top of the Breaking Artist is always shown. Regarding Screen Summary, these Breaking Artist reviews/profiles can contain a selection of highlighted links, summarized as follows:
Artist—opens the linked Artist Panel.
Album—opens the linked album in the relevant Artist Panel with the Selected Album.
Track—opens the linked track in the relevant Artist Panel with the Selected Track.
Playlists—opens the linked Playlist Panel.
WAP links—opens the linked URL in the handsets browser.
User—opens the linked user in the relevant User Profile Panel.

Notes on FIGS. 53a and 53b: Breaking Artist is similar to Hot News. It's editorially generated but focuses very specifically on new or breaking artists currently popular globally or in the relevant territories. While the links traditionally revolve around the Breaking Artist they can also link to other or similar artists associated with the Breaking Artist or other link types. There is a maximum number of e.g. 12 Breaking Artists stored at any given time.

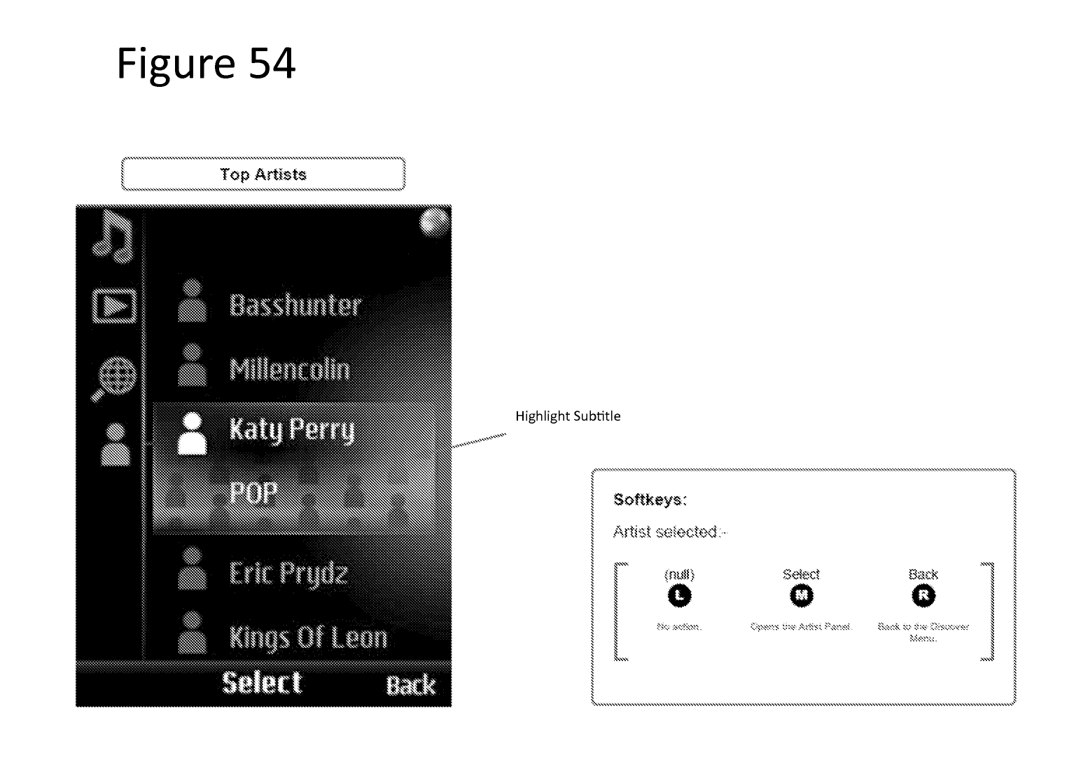

FIG. 54 shows Screen Name: Top Artists. This screen describes the behaviour of the Top Artists menu item. It is a controlled set of artists shown as Artist Panels under a panel navigation control. Regarding Highlight Subtitle, this shows the artist genre for the highlighted artist. Notes on FIG. 54: as per other Top content they represent the most popular items on the MusicStation service of all time. Shows the artist artwork image if available, otherwise default album image.

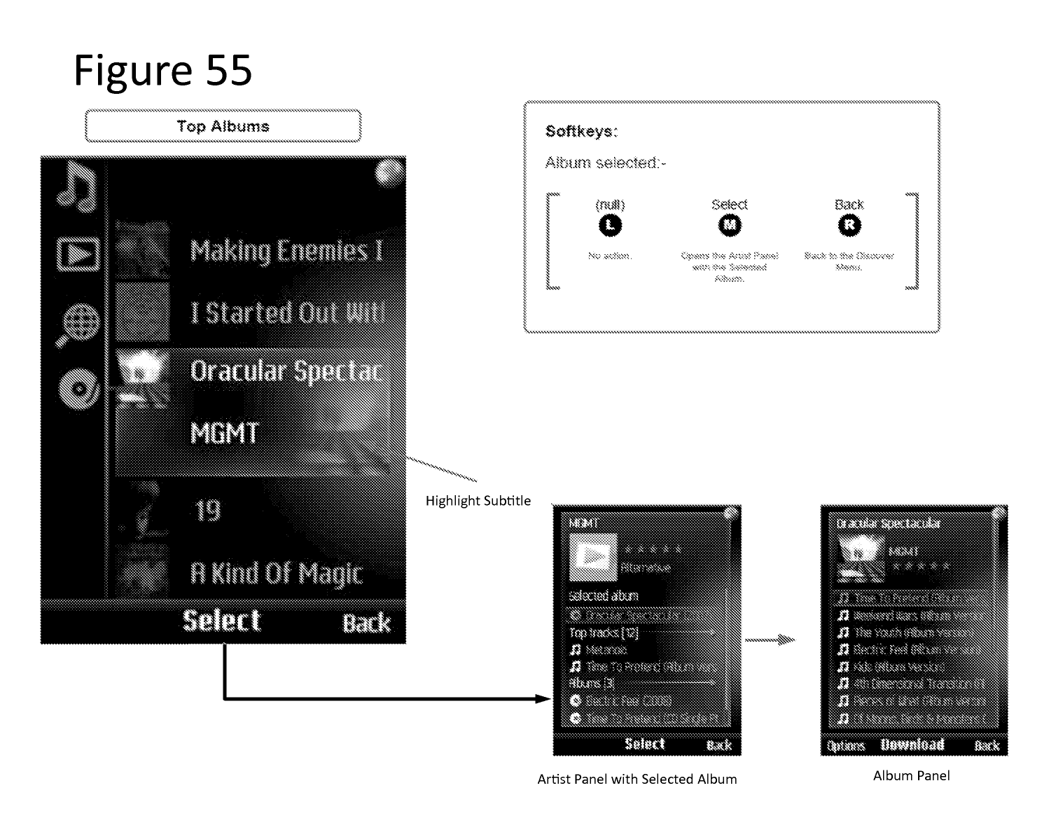

FIG. 55 shows Screen Name: Top Albums. This screen describes the Top Albums which represent the most popular albums of all time on the MusicStation service. Regarding Highlight Subtitle, this shows the artist for the highlighted album. Also shown are the Artist Panel with selected album screen and the Album panel screen. Notes on FIG. 55: as per other Top content they represent the most popular items on the MusicStation service of all time. Shows the album artwork image if available, otherwise default album image.

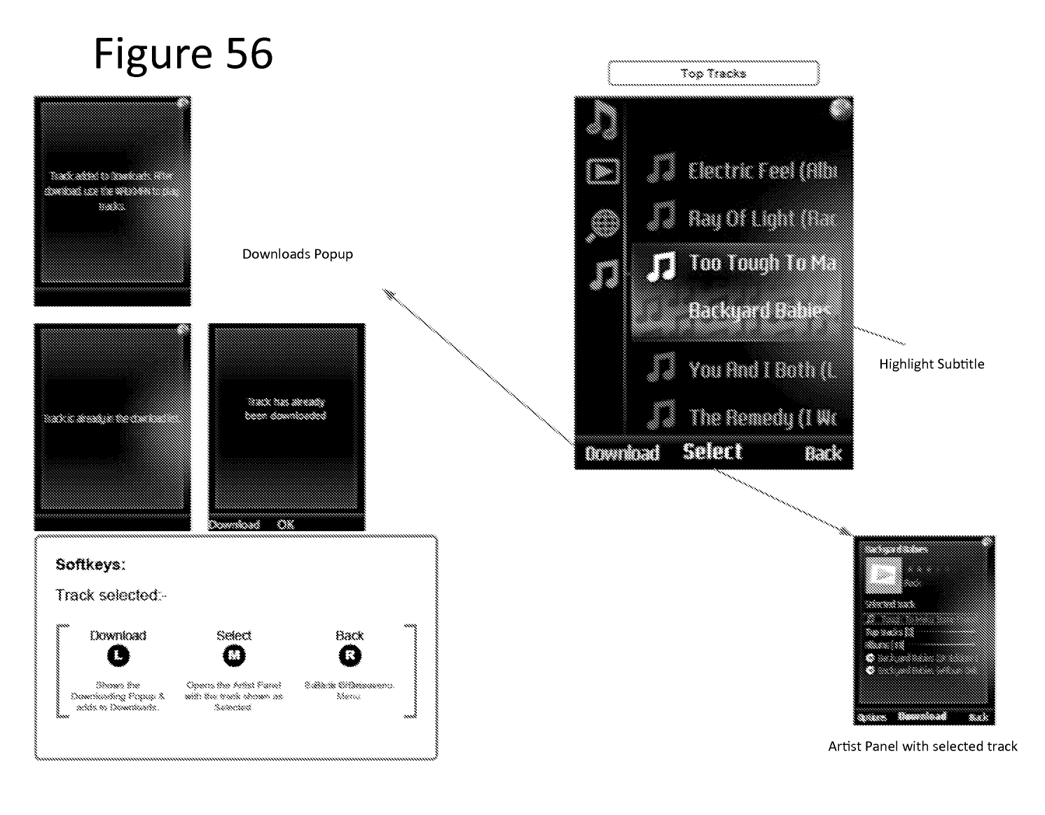

FIG. 56 shows Screen Name: Top Tracks. This screen describes the Top Tracks which represent the most popular tracks of all time on the MusicStation service. Regarding Downloads Popup, when the user clicks on “Download” this popup is shown and the track is added to Downloads. This popup is a transient popup meaning that after some time it disappears. Regarding Highlight Subtitle, this shows the artist for the highlighted track. Also shown is the Artist Panel with selected track screen. Notes on FIG. 56: as per other Top content they represent the most popular items on the MusicStation service of all time.

FIG. 57 shows Screen Name: Top Playlists. This screen describes the Top Playlists which represent the top editorially-generated playlists on the MusicStation service. Regarding Highlight Subtitle, this shows the total number of tracks for the highlighted playlist. Notes on FIG. 57: the selected playlist can be downloaded and saved into the user's Media Centre Music Menu Playlists by opening the playlist (see Playlist screen). Where available, the custom playlist icon or otherwise the default playlist icon is shown.

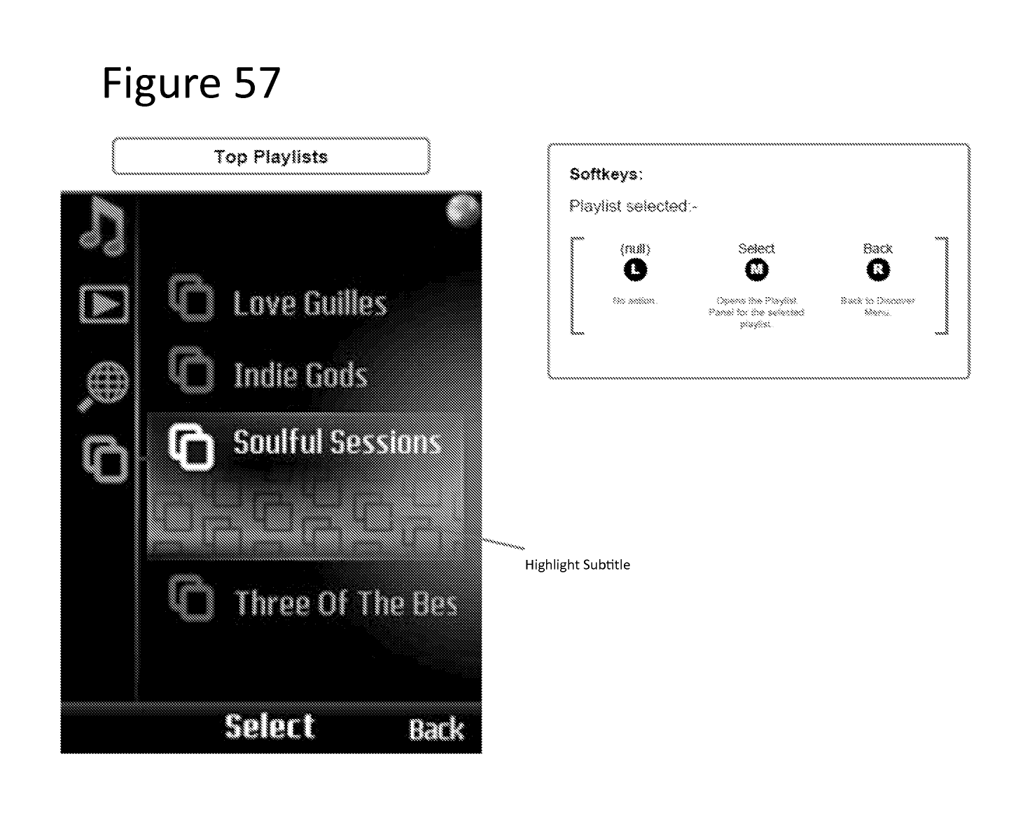

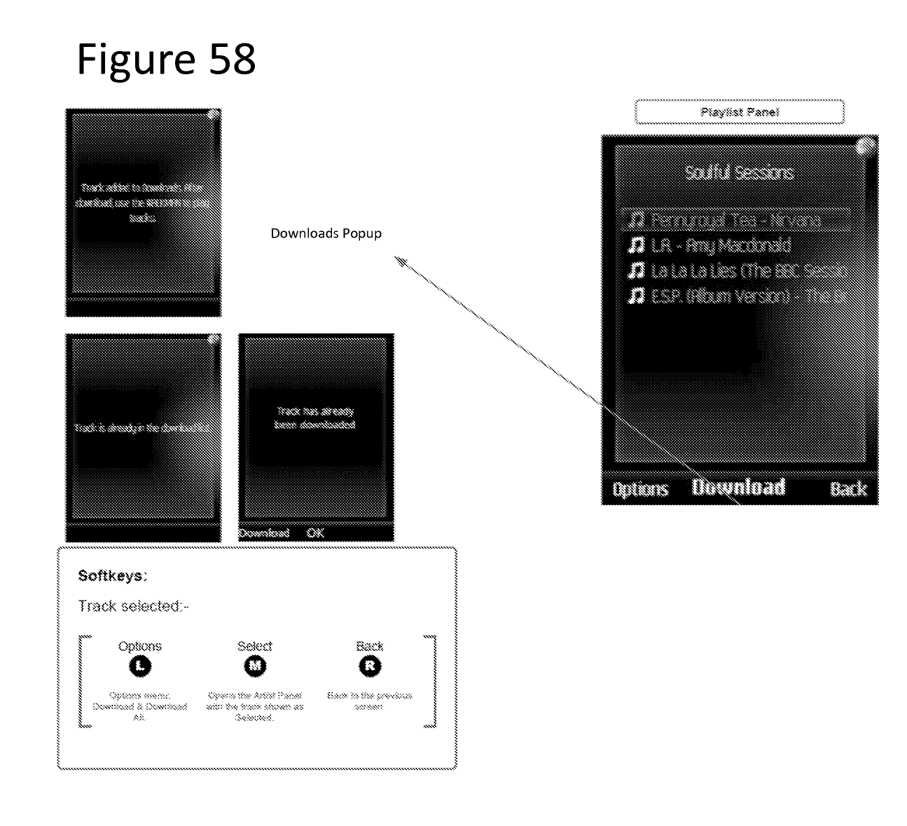

FIG. 58 shows Screen Name: Playlist Panel. This screen describes the contents of a Playlist which represents the top editorially generated playlists on the MusicStation service. Regarding Downloads Popup, when the user clicks on “Download” this popup is shown and the track is added to Downloads. This popup is a transient popup. Notes on FIG. 58: a playlist can be saved in its entirety as an M3U file directly into the user's Playlists section of the Media Centre's Music Menu by choosing Download Playlist from the Options menu.

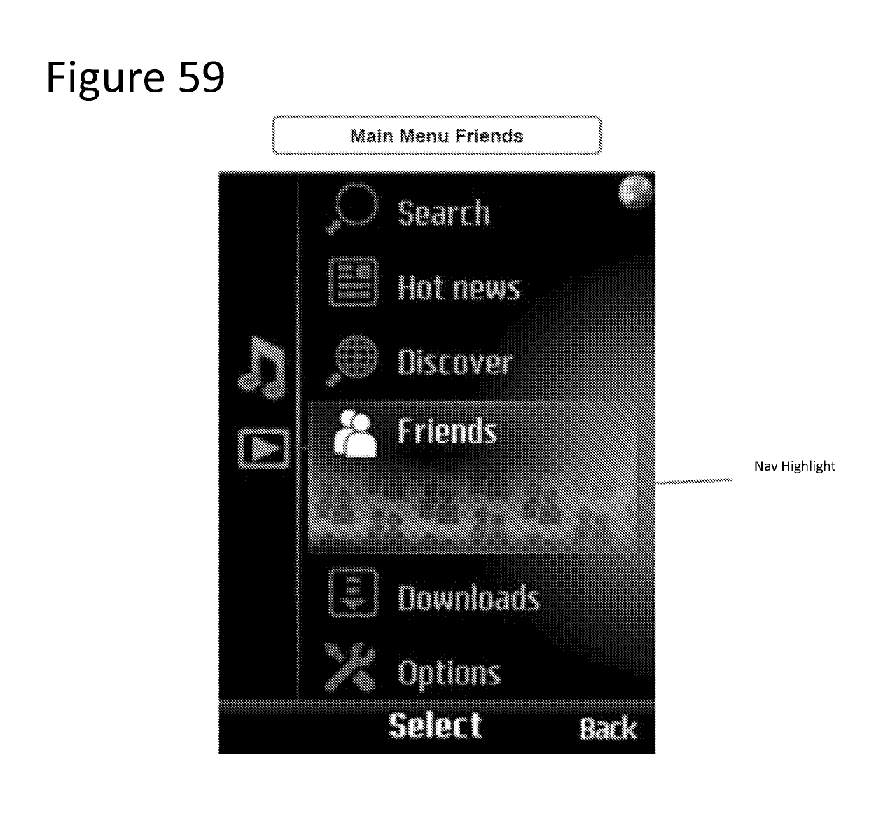

FIG. 59 shows Screen Name: Main Menu Friends. This screen describes the behaviour of the Friends item in the MusicStation Main Menu. Regarding Nay Highlight: the image which is the background to the Nav Highlight is static but can be replaced OTA. Notes on FIG. 59: Clicking Select MSK or right joystick opens the Friends Menu.

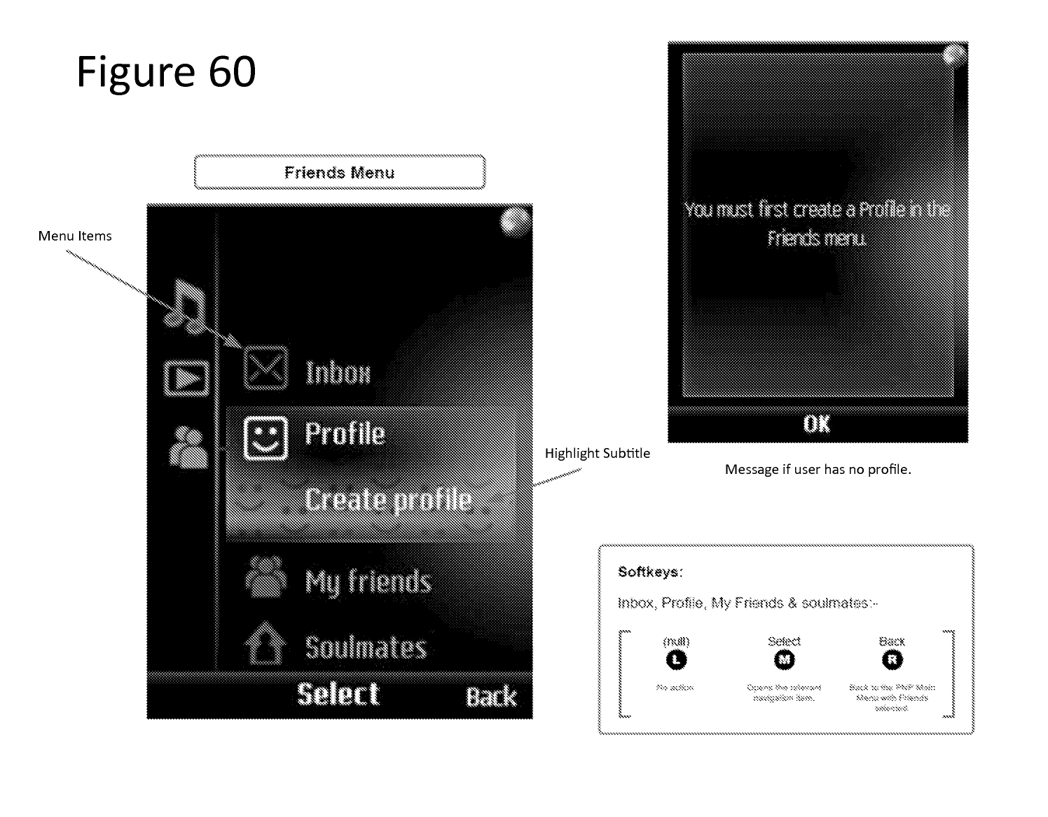

FIG. 60 shows Screen Name: Friends Menu. This screen describes the behaviour of the Friends Menu and the features it provides access to. Regarding “Message if user has no profile”: this screen is shown if the user attempts to do something which requires a profile before he has created a profile. Menu Items are: Inbox, Profile, My Friends, Soulmates. Regarding Highlight Subtitle, the highlight subtitles are:
Inbox=“Total: X”
Profile=“Create/Edit Profile”
My Friends=“Total: X”
soulmates=“Total: X”

Notes on FIG. 60: the subtitle for the Profile item is context-sensitive based on the user having created a profile. When no profile has been created then the subtitle is “Create Profile. When a profile has been created the subtitle changes to “Edit Profile”.

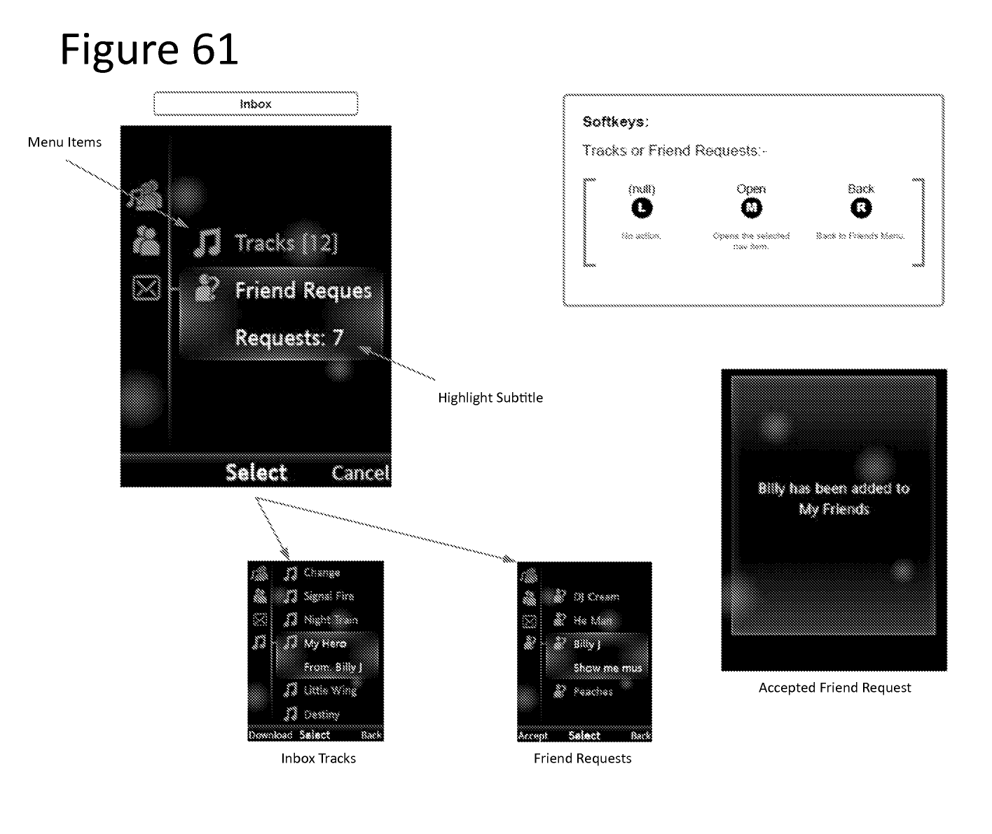

FIG. 61 shows Screen Name: Inbox. This screen describes the behaviour of the Inbox and the features it provides access to. Regarding Accept Friend Request, a transient popup is displayed on pressing Accept. Menu Items are: Tracks, Friend Requests. Regarding Highlight Subtitle, the highlight subtitle for both items is “Total: X”. Regarding Inbox Tracks, this screen shows the tracks sent by friends; Download adds to Downloads; Select opens the artist panel with the track selected. Regarding Friend Requests, this screen shows the Friend requests. The ‘c’ key will delete a friend request, Select opens the friend panel, Accept accepts the user and adds them to My Friends.

Notes on FIG. 61: this is the user's Inbox, which contains tracks and friend requests from other MusicStation users. Both navigation options are displayed even if there are no items in either option. A Track or Friend Request can be removed by pressing the ‘c’ key. A popup will confirm the removal.

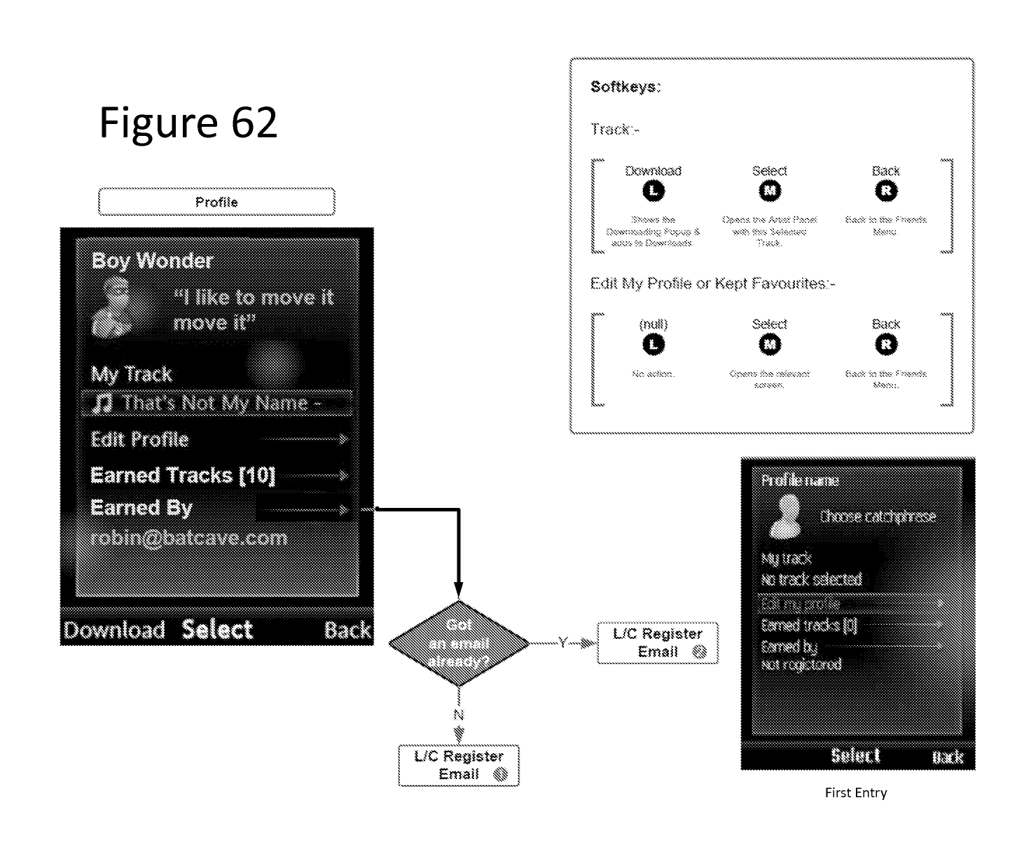

FIG. 62 shows Screen Name: Profile. This screen describes the behaviour and function of the Profile screen. This is where a MusicStation user has the ability to create and customise their profile enabling them to explore the social networking aspects of MusicStation by making friends and sending tracks. In here they can also see the total of their Earned tracks. Regarding First Entry, on first entry to this screen (with a SIM which isn't associated with an existing profile), the screen elements are as shown to the left. Earned tracks are tracks that a user has earned permanent access to. Further details are provided in GB 0817460.9 and related applications, the contents of which are incorporated by reference.

Notes on FIG. 62: a MusicStation user can create and customise their own profile with a profile name, image, catchphrase and even choose a track to represent who they are to the rest of the MusicStation community. When a user first enters into the profile page they are presented with different wording that directs them to create a profile. The profile name displayed is ‘Profile’, catchphrase is “Use Create Profile to set up a Profile”, My Track has the words ‘No track selected” below it and the edit profile option is presented as ‘Create Profile’. The user can add a track (My Track) to their profile by selecting My Track from the soft key options menu of a track at the artist panel level. Also accessible from this panel is Earned tracks. Here the user can also register for Earned tracks by using the “Earned By” link to register their Email address, which may be up to 128 characters in length.

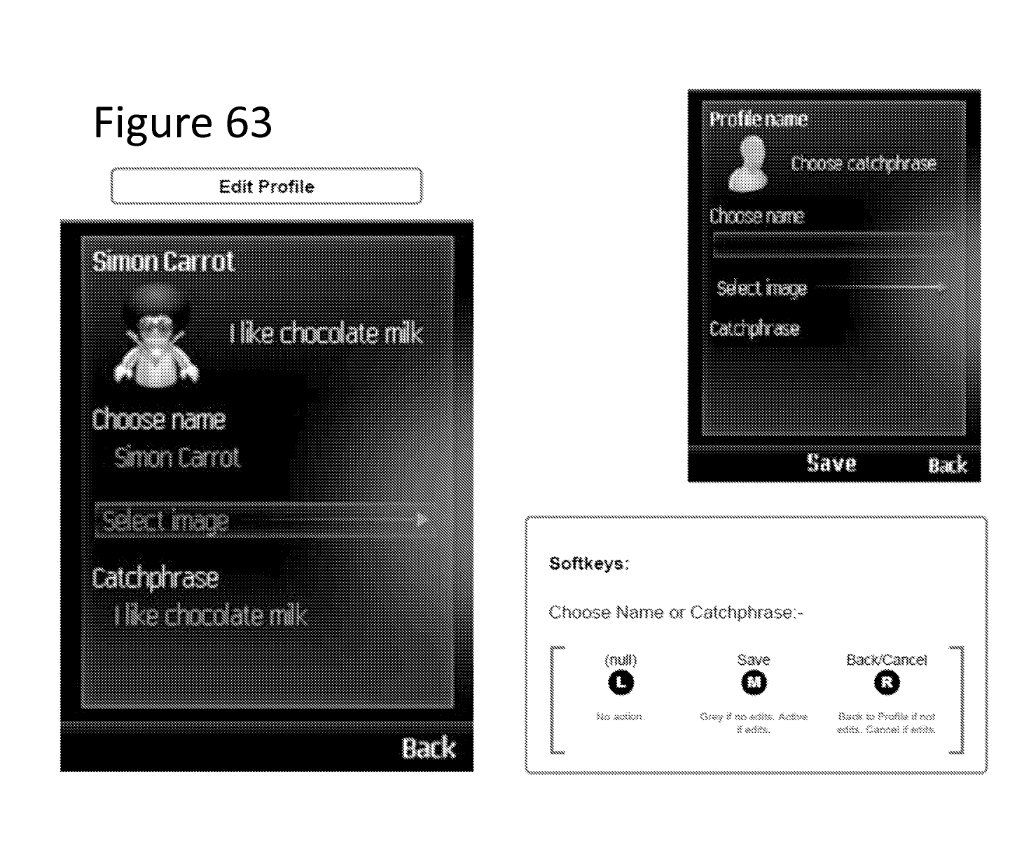

FIG. 63 shows Screen Name: Edit Profile. This screen allows a user to create and edit their community/friends Profile. Regarding First Entry, on first entry to this screen (with a SIM which isn't associated with an existing profile), the screen elements are as shown to the left. Notes on FIG. 63: Below Name and Catchphrase is an editable box for the user to create a profile name or edit their Catchphrase or image. The user's Catchphrase and image can be changed as often as she likes. The Name can be up to e.g. 96 characters in length and the user's catchphrase may be up to e.g. 256 characters long.

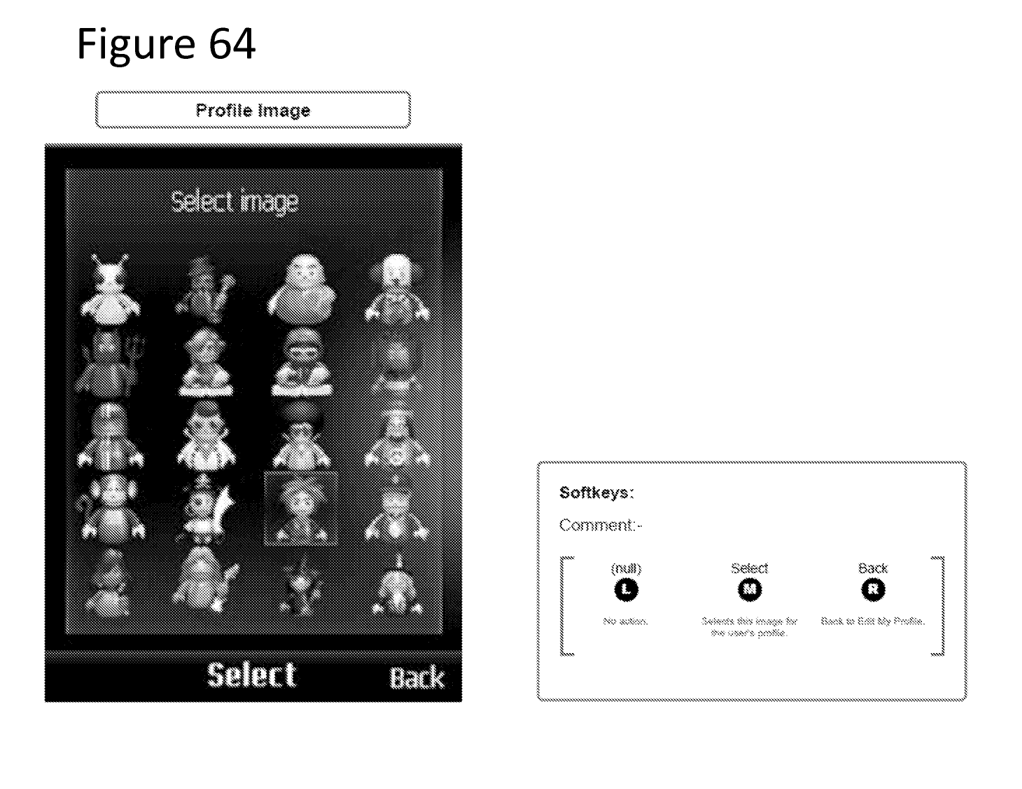

FIG. 64 shows Screen Name: Profile Image. This screen describes the behaviour of the Profile Image screen where a user can select from an assortment of images. Notes on FIG. 64: the cursor selection logic works as per standard device logic for images. e.g. pressing right joystick on row 1, column 4, moves the highlight to row 2, column 1. At the end of the items it does NOT cycle around (right cursor on last item does nothing as per image selection in other areas of the device UI). Cursor down to last item in column does NOT cycle around to top. Initial selected image regardless of unset or set image will always be the first item (col 1, row 1). The contents of this screen will scroll (with scroll bar) if the items number e.g. 20 or more.

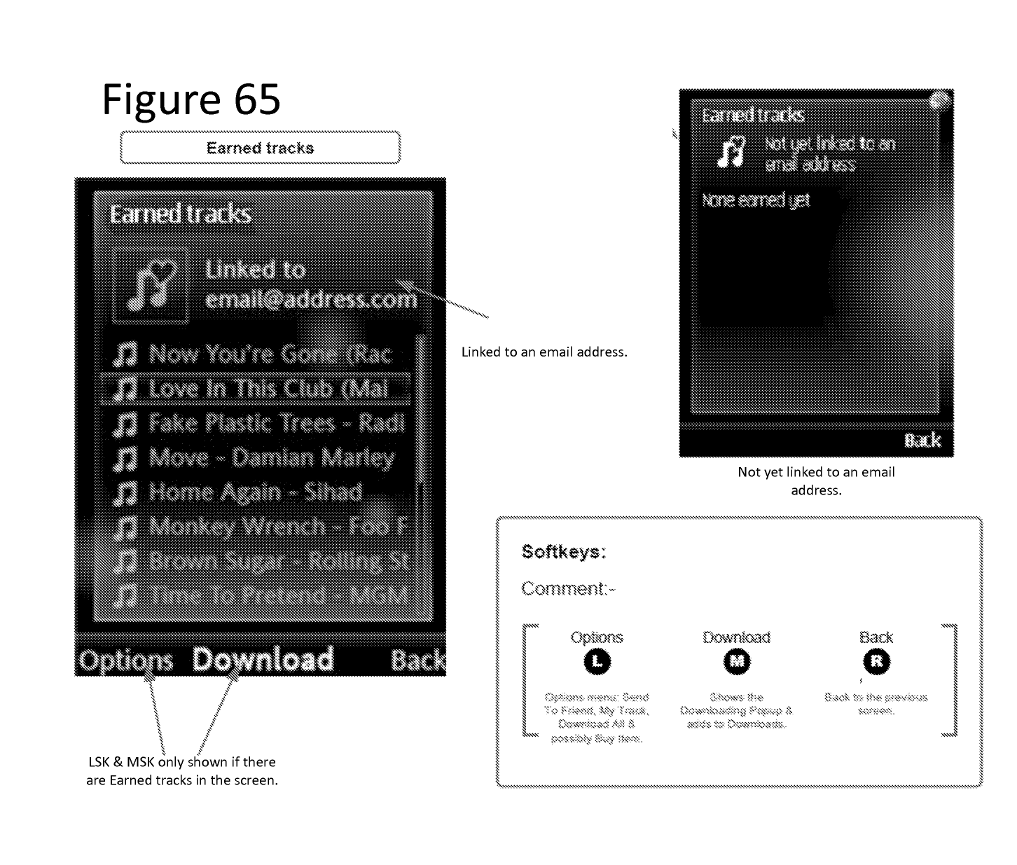

FIG. 65 shows Screen Name: Earned tracks. This screen describes the behaviour of the Earned tracks screen. Regarding Description, if this Profile is not yet linked to a confirmed Email address then the description should be: “Not yet linked to an email address”. Otherwise if linked to email address it should say: “Linked to email@address.com”. If there are Earned tracks then they are shown like the track list of an album. Notes on FIG. 65: when in here with an associated Profile you can see all your Earned tracks from any source. You can download these at anytime and are not subject to being inside an active subscription.

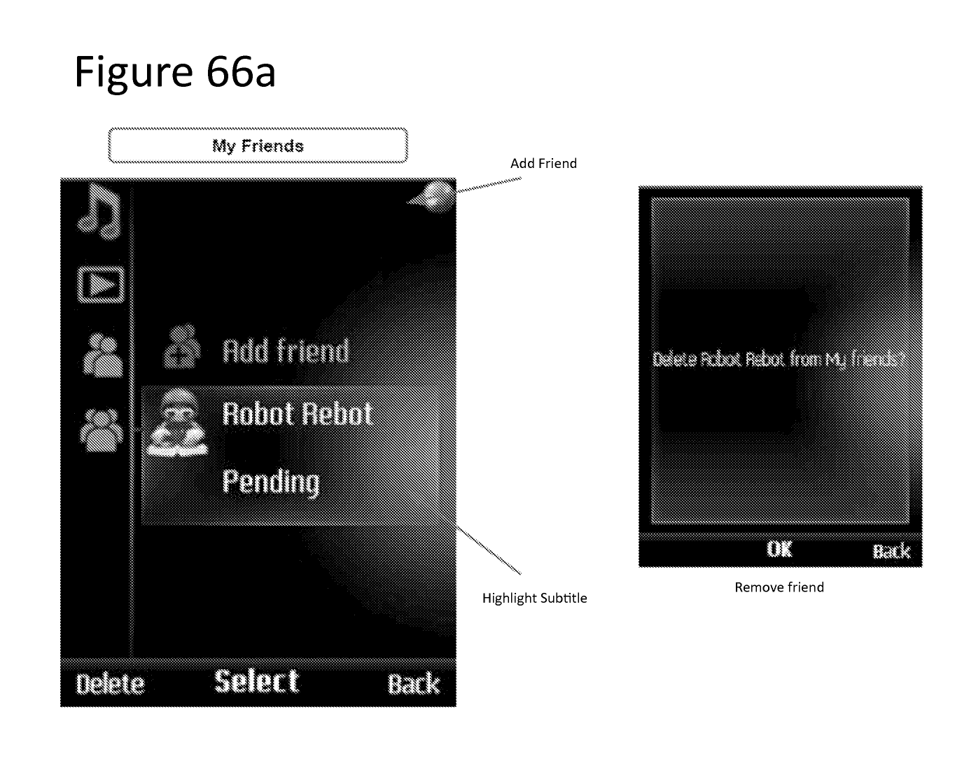

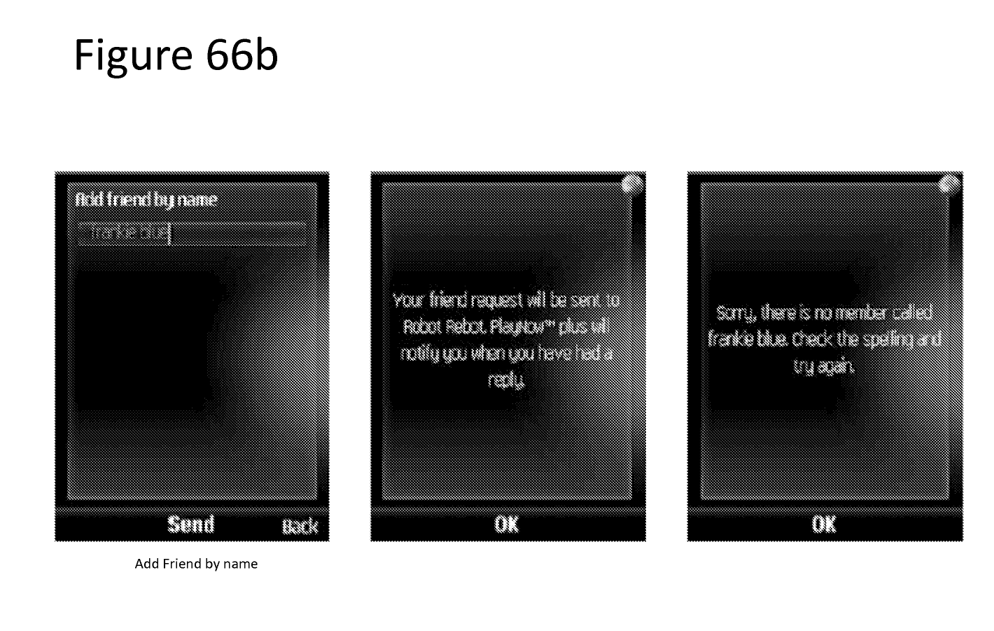

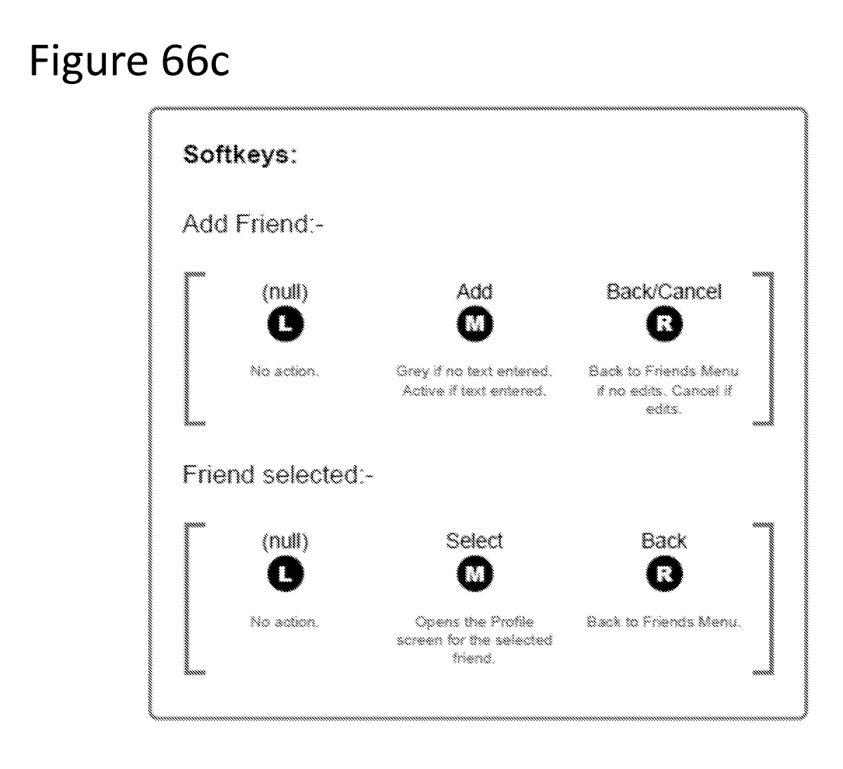

FIGS. 66a, 66b and 66c show Screen Name: My Friends. This screen describes the behaviour and function of the My Friends menu. In FIG. 66a, regarding Add Friend, this Acts like Search field on Main Menu (see notes). Regarding Highlight Subtitle, the highlight subtitle is the catchphrase if a friend is highlighted or the word ‘Pending’ if there is an outstanding friend request. Regarding Remove Friend, a popup will confirm removal of a friend after pressing the ‘c’ key. In FIG. 66b, regarding Add Friend by name, a popup will confirm if the friend request has been sent.

Notes on FIGS. 66a, 66b and 66c: this screen contains a list of all the fellow MusicStation users that the current user has added. The user has the ability to send a track to these listed users and also browse their own respective user profiles in order to discover more music. When Add Friend is highlighted it acts in just the same way as the Search highlight item in the MusicStation Main Menu. A user is presented with the opportunity to add a friend by the user's profile name. If the entered user exists then a Friend Request will be sent. A popup informs the user if the request has been sent and if the user name does not exist. Once a Friend Request has been sent then that friend receives a friend request in their Inbox and the friend will also be shown in the user's My Friends list with the subtitle “Pending”. You can view the friend's profile but you cannot send a track until they have accepted the request (by choosing accept when from their inbox/friend requests item). Once the friend request has been accepted then the subtitle changes from pending to their Catchphrase. Friends can also be added by viewing their profile as and when they discover new users in other areas such as Soulmates. Friends can be removed by pressing the ‘c’ key. A popup will confirm the removal of the friend.

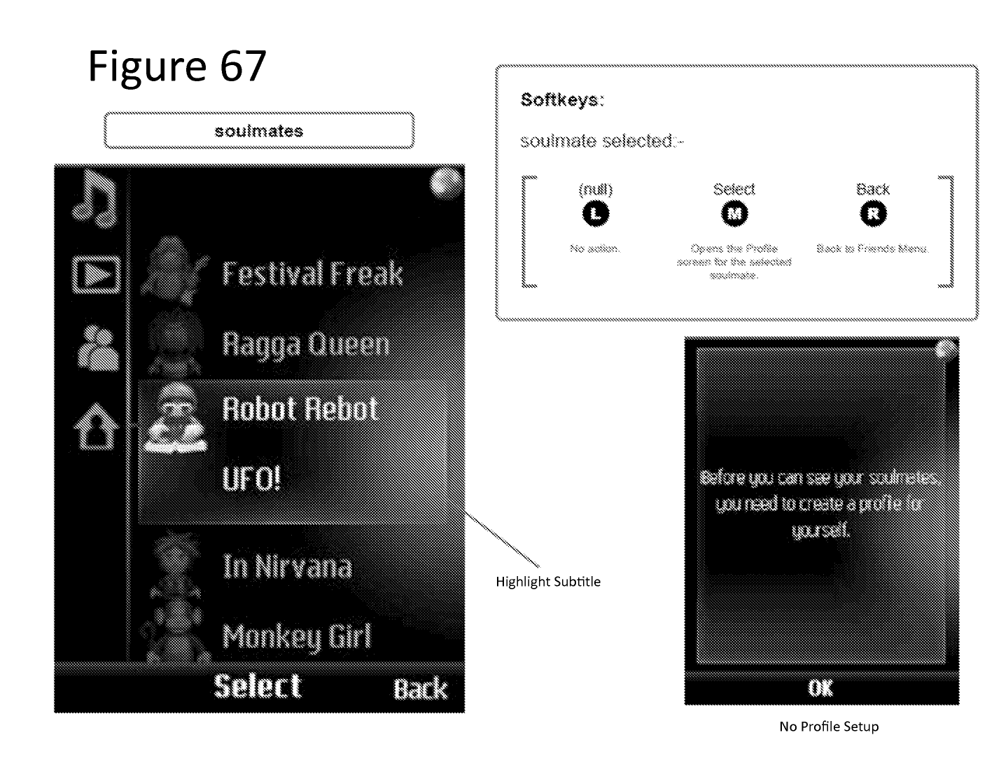

FIG. 67 shows Screen Name: soulmates. This screen describes the behaviour and function of the soulmates menu. Regarding No Profile Setup, this modal popup is shown if you enter Friends→soulmates before you set up a profile. Regarding Highlight Subtitle, the highlight subtitle is the catchphrase. Notes on FIG. 67: ‘soulmates’ is a term used to describe other MusicStation users who share similar listening tastes. They are all selected by server side logic that matches users with other similar listening users. Navigating into a soulmates profile allows the user to discover more music and add the soulmate by sending a friend request.

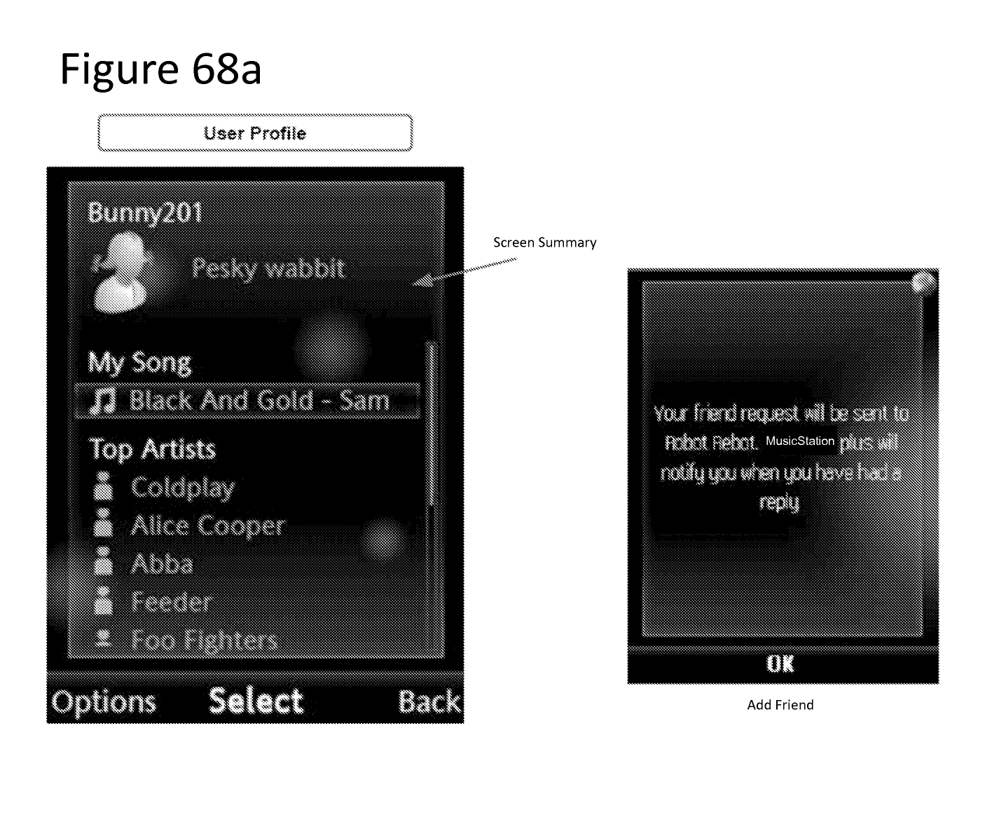

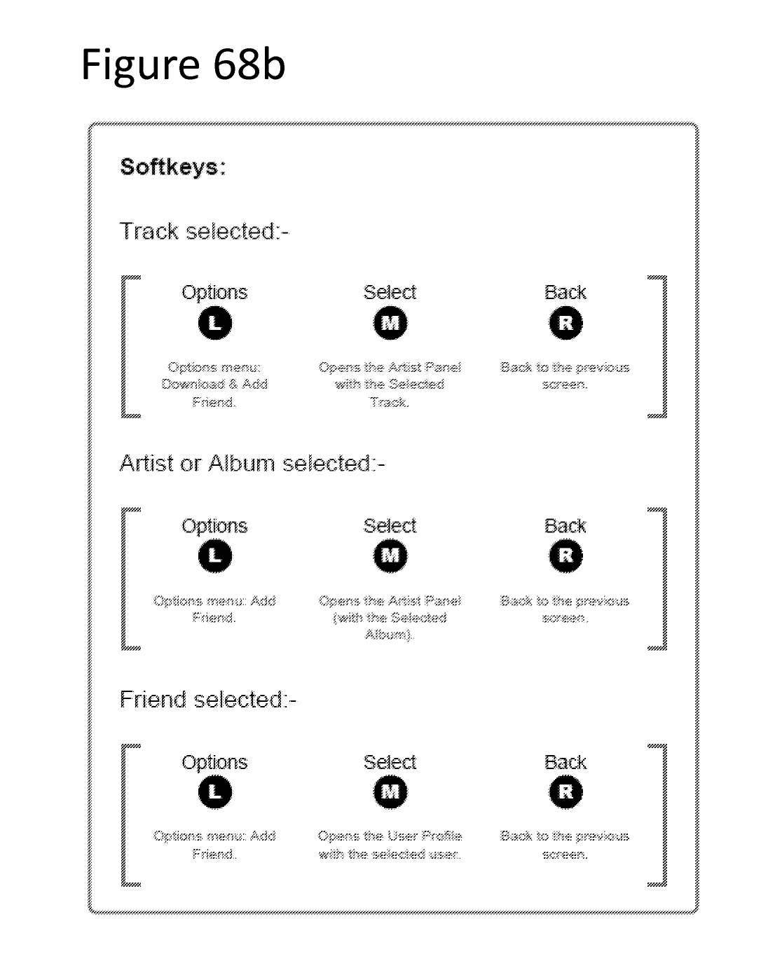

FIGS. 68a and 68b show Screen Name: User Profile. This screen describes the behaviour and functions of another MusicStation user's profile. In FIG. 68a, regarding Screen Summary, the currently viewed MusicStation user's profile contains the following items that are personal to their listening tastes.
Top Artists—lists top 5 artists as listened to by this MusicStation user.
Top Albums—lists top 5 albums and releases as listened to by this MusicStation user.
Top Tracks—lists top 5 tracks as listened to by this MusicStation user.
Top Friends—lists top 5 friends associated with this MusicStation user.

The top 5 items in each section are listed below the relevant section heading. Regarding Add Friend, a popup will confirm if the friend request has been sent.

Notes on FIGS. 68a and 68b: if the currently viewed MusicStation user has not chosen a track as their My Song then no My Song or track below it is displayed. On adding a Friend from the Options LSK a popup will confirm that the user wishes to add the named friend. A friend request is then sent to that user and the user will appear in the My Friends list with the subtitle displaying pending.

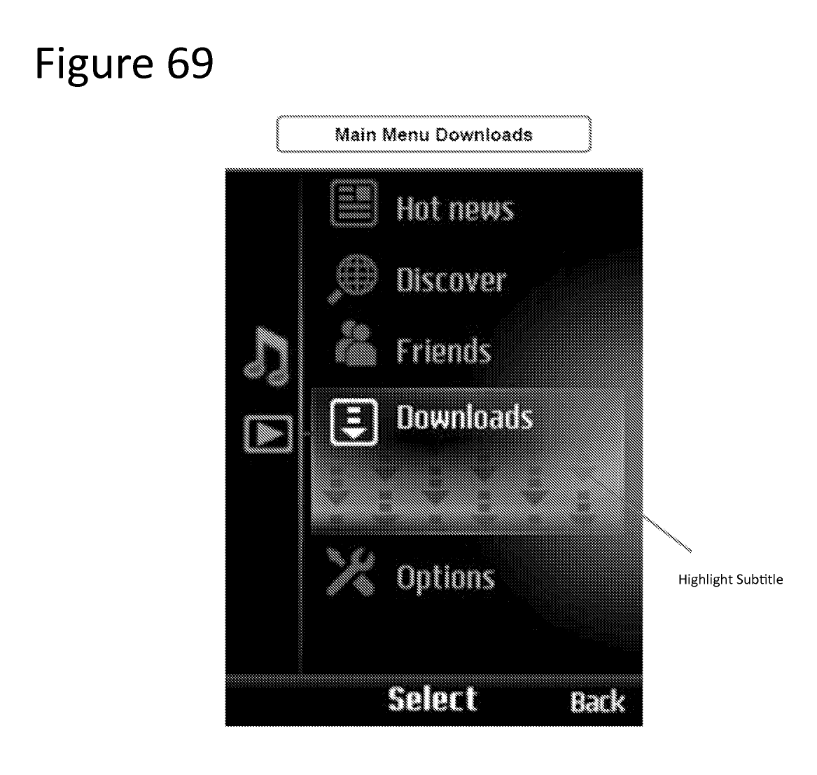

FIG. 69 shows Screen Name: Main Menu Downloads. This screen describes the behaviour of the Downloads item on the MusicStation Main Menu. Regarding Highlight Subtitle, this shows either the total downloads in the queue or the % complete of the currently downloading track.

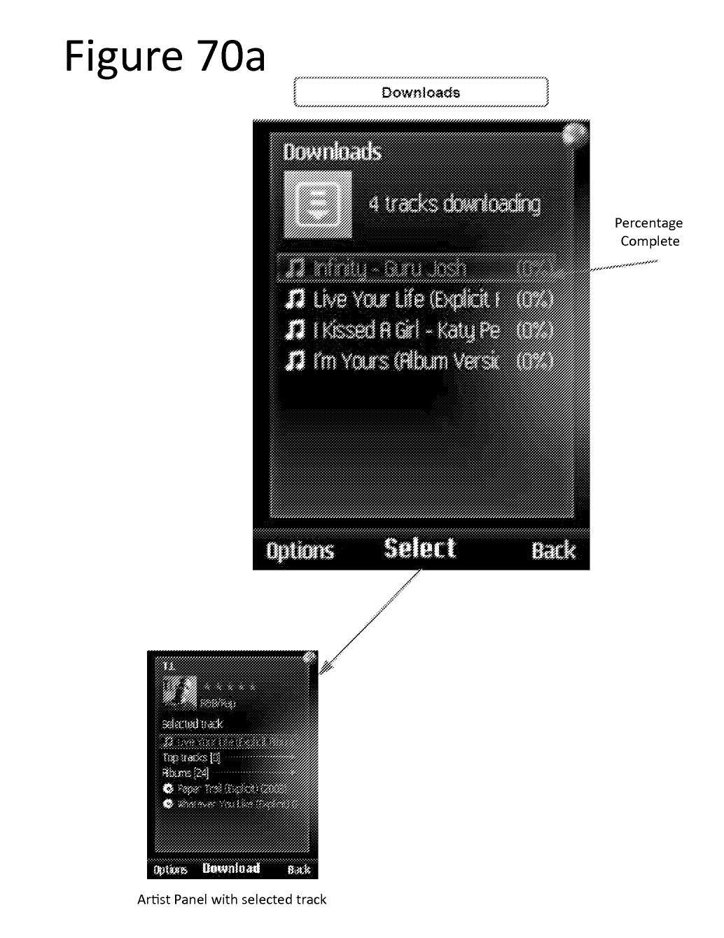

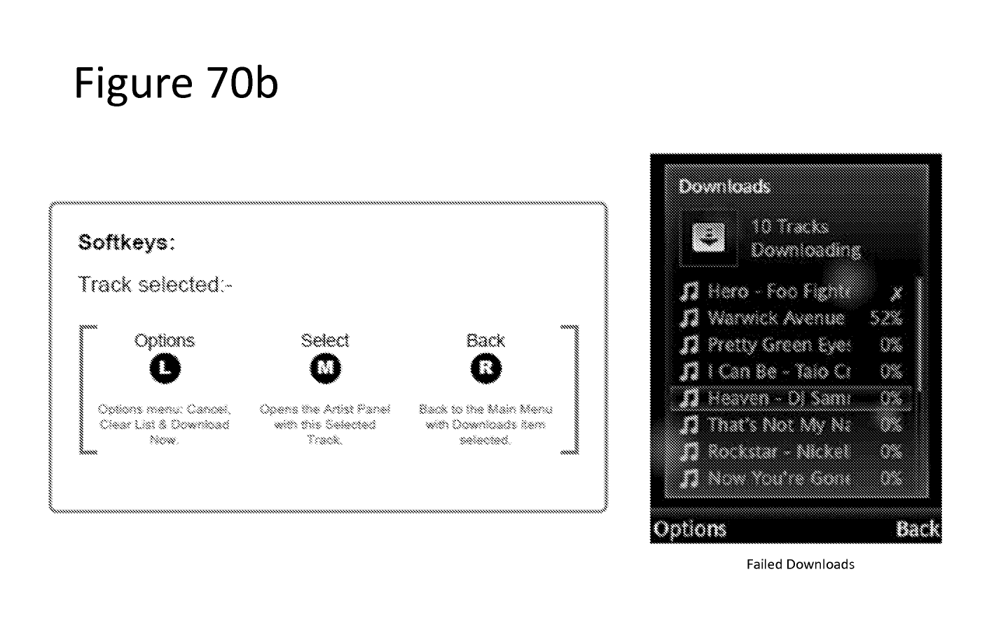

FIGS. 70a and 70b show Screen Name: Downloads. This screen describes the behaviour of the Downloads screen in MusicStation. In FIG. 70a, regarding Percentage Complete, this shows the percentage complete of the track download. The Artist Panel with selected track screen is also shown. In FIG. 70b, regarding Failed Downloads, if a track fails in the download then it will be marked with an X as shown. When the application exits it will delete these files after a retry during the Exit Logic.

Notes on FIGS. 70a and 70b: downloads are listed and download one at a time. The progress of a download is displayed alongside the track and artist name as a percentage of the completed download. A track that is downloading can be cancelled or a track lower in the list can be promoted to be downloaded (at the top of the list). Downloads will continue to download if the J2ME application is allowed to stay minimised. Completed downloads are removed from the list and are saved to the user's SE Media Centre Music area where they can be managed and played. Partial downloads of remainder of a track is supported. i.e. it doesn't download the whole track again if the handset loses connection. Selecting Download Now from the Options list will move the selected track to the top of the list and begin downloading it. The previously downloading track will move down the list (to the 2nd position) and can be resumed again later in order to complete the rest of the download. The ‘c’ key or Cancel in the LSK Options menu stops the current downloading track and deletes it from the list.

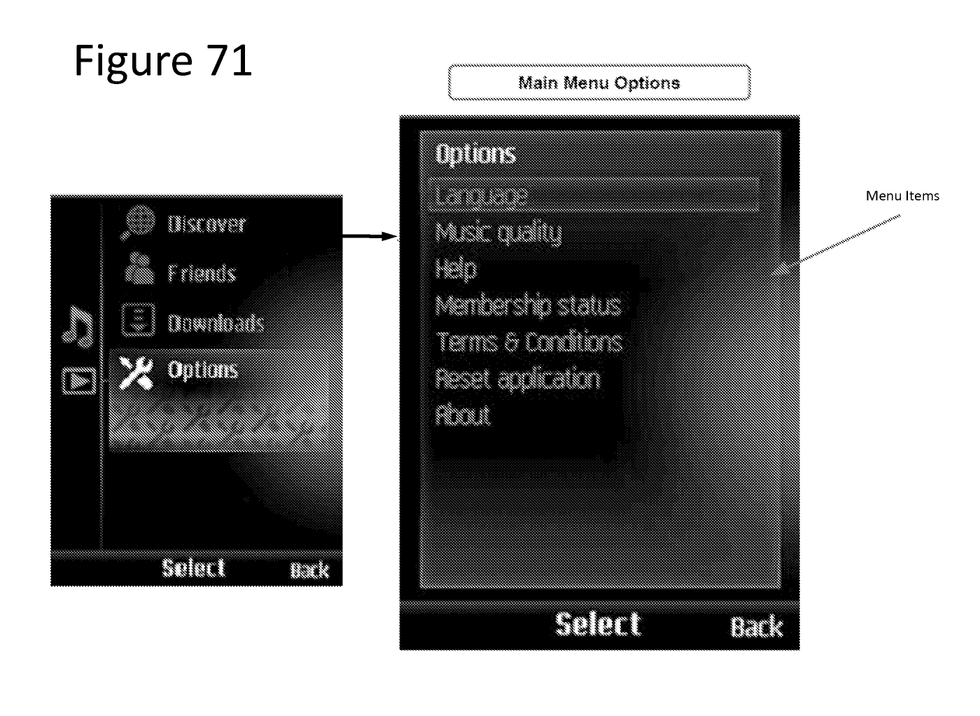

FIG. 71 shows Screen Name: Main Menu Options. This screen describes the behaviour of the Options item on the MusicStation Main Menu. Regarding Menu Items, the Options menu contains the following features:
Language
Music Quality
Help
Membership Status
Cancel Subscription
Terms & Conditions
Reset Application
About

Cancel Subscription is only shown if inside a rolling subscription.

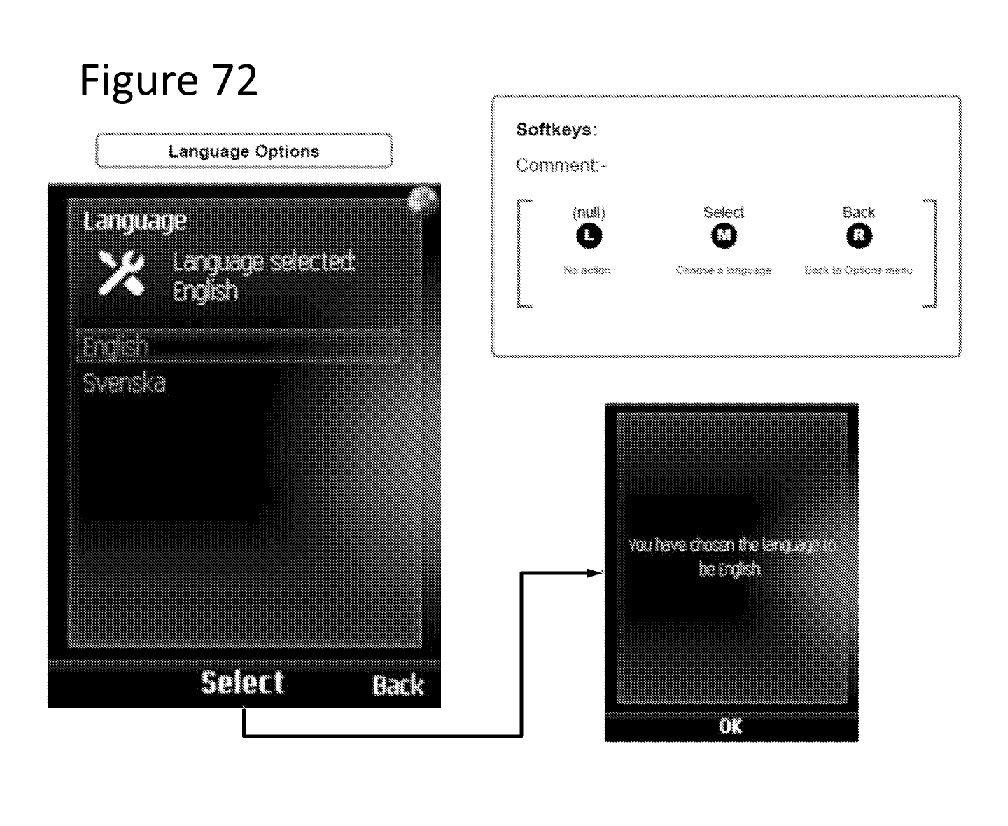

FIG. 72 shows Screen Name: Language Options. This screen describes the behaviour of the Options→Language menu. It provides the ability for the user to change language that MusicStation is in. Notes on FIG. 72: if the user sets their language manually here then this overrides any automatic choice made at application start-up. It may be possible to inform the client OTA download further language packs.

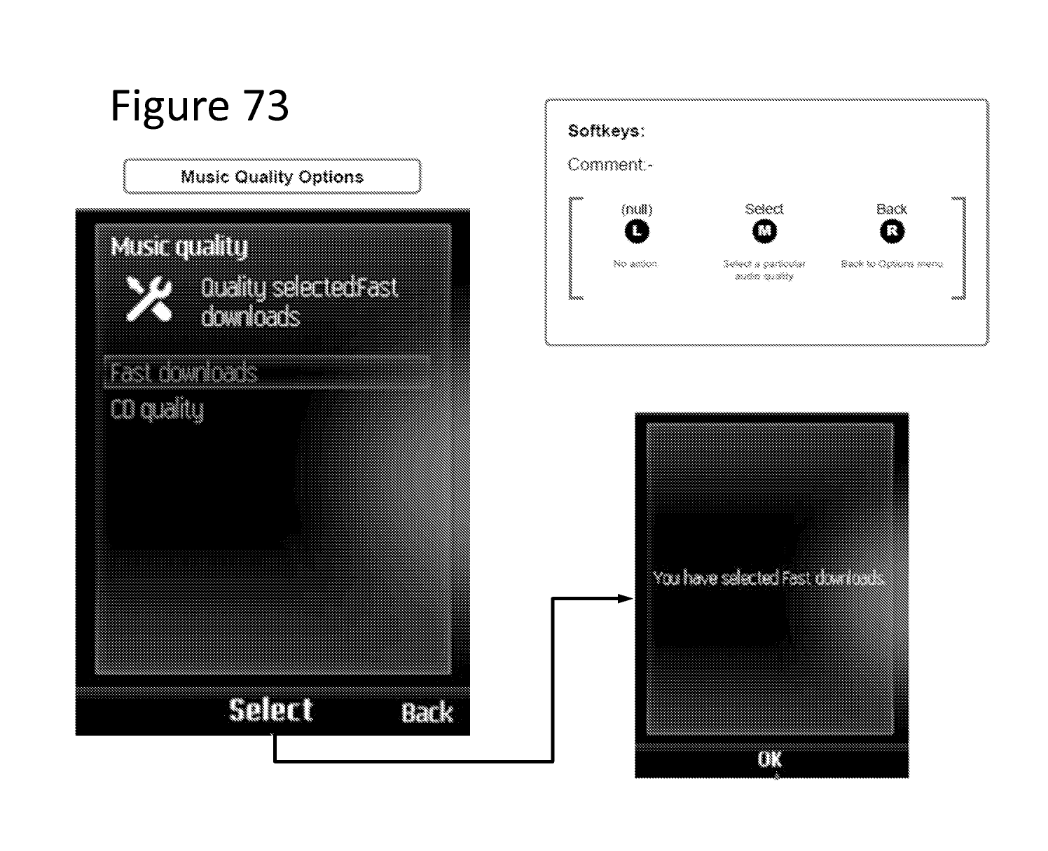

FIG. 73 shows Screen Name: Music Quality Options. This screen describes the behaviour of the Music Quality setting in the Options menu. Notes on FIG. 73: the default format for MusicStation is 24 k eAAC+. “Fast Downloads” is 24 kb/s eAAC+. “CD Quality” is 48 k AAC+. Selecting a format will set that format as the download format. This will continue until this screen is used to select the other format.

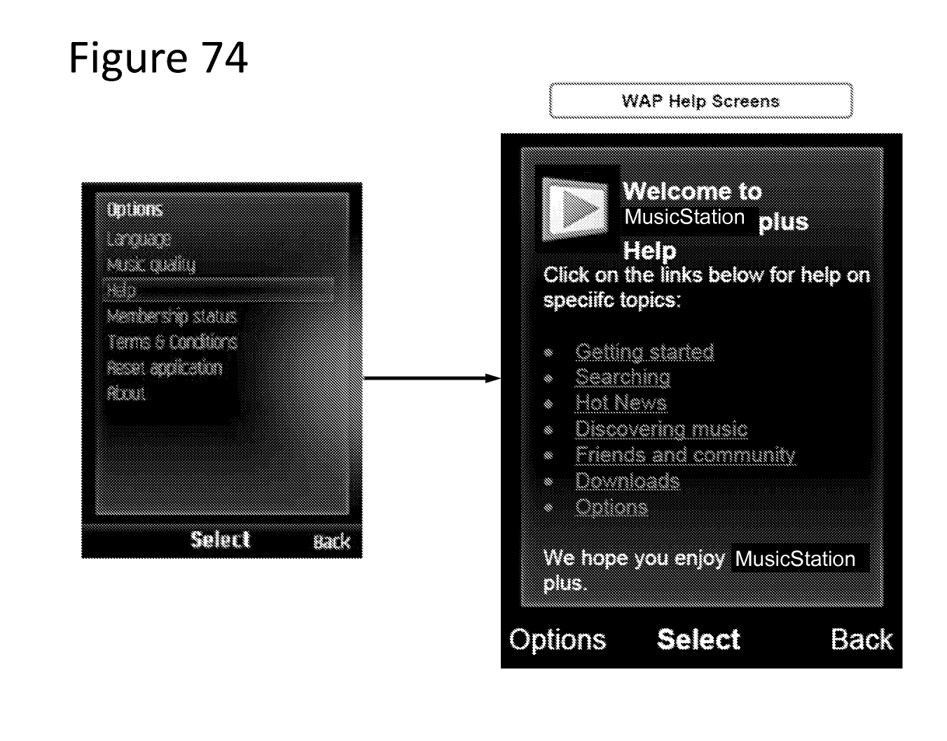

FIG. 74 shows Screen Name: Help. This screen describes the behaviour of the MusicStation WAP help screens accessed from Options→Help. Notes on FIG. 74: WAP delivered MusicStation help. Need to whitelist the WAP domain in the operator gateways.

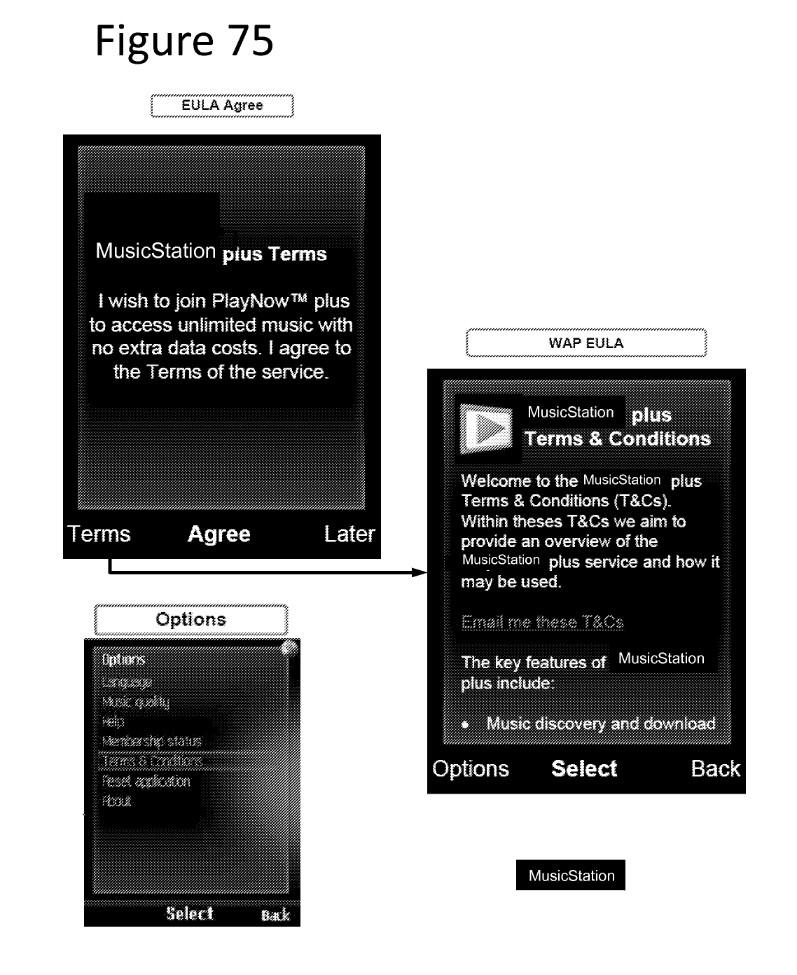

FIG. 75 shows the Screen Name: Terms & Conditions. This screen describes the behaviour of the WAP delivered End User License Agreement (EULA). Notes on FIG. 75: the EULA is to deal with the PC too. “Send me the EULA” option by entering email. If email entered already then suggest this email. If an email is first entered here then use this email to suggest for the Profile or “User Handle” email. There is no need for a “Exit the browser” message at the top of the WAP because clicking “Back” achieves this.

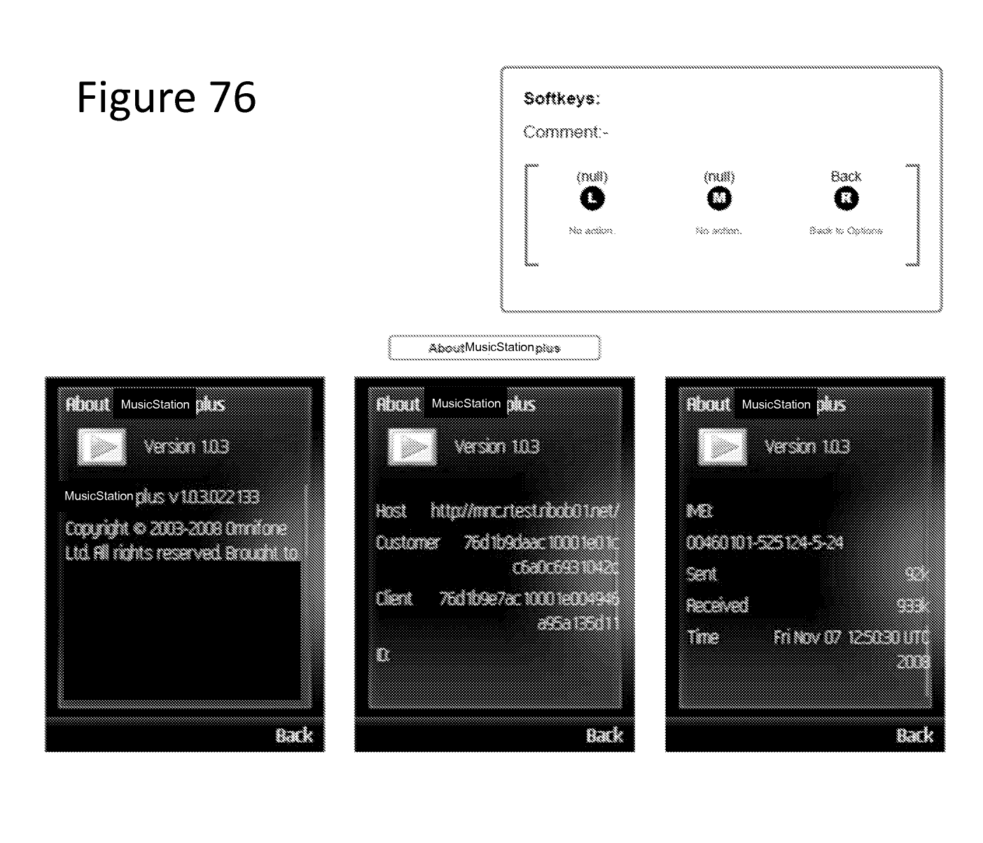

FIG. 76 shows Screen Name: About. This screen describes the behaviour of the About screen.

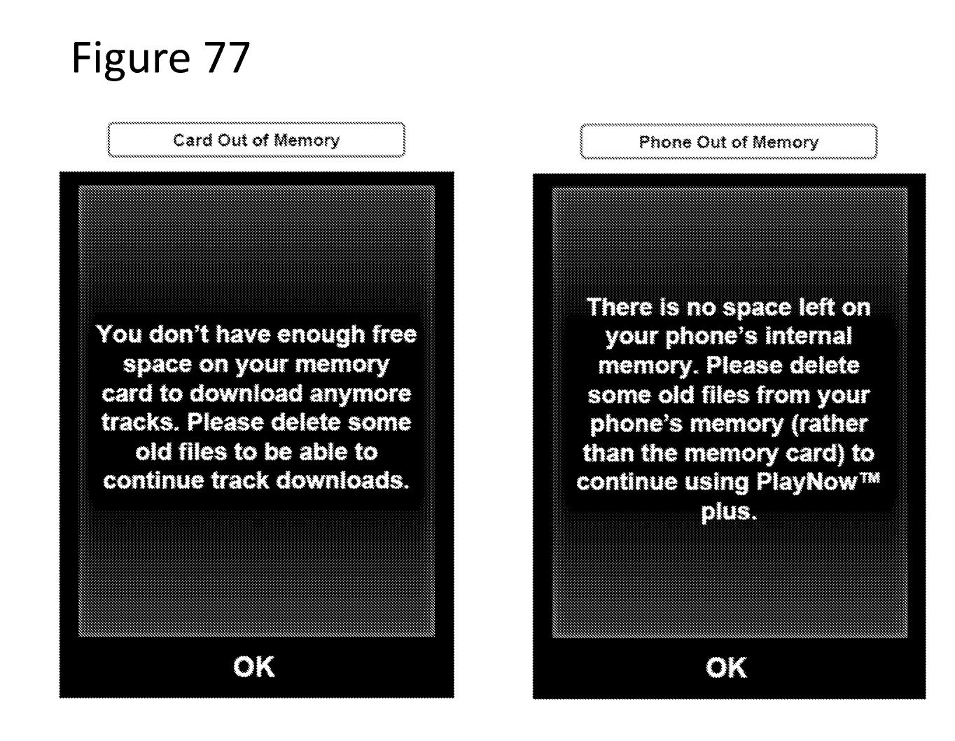

FIG. 77 shows Screen Name: Out of Memory Screens. These screens describe how the MusicStation application behaves when the phone or the memory card has run out of available space. Notes on FIG. 77: An error screen is shown when there is no space to save tracks. The phone memory error screen is also shown when there's no memory card. The service lets the user effectively fill the entire available space. Though for both phone and memory card checks an amount e.g. 1 MB is subtracted from the “available size” to provide a margin for error in case “available size” reports more space than is actually available as can happen with some handsets

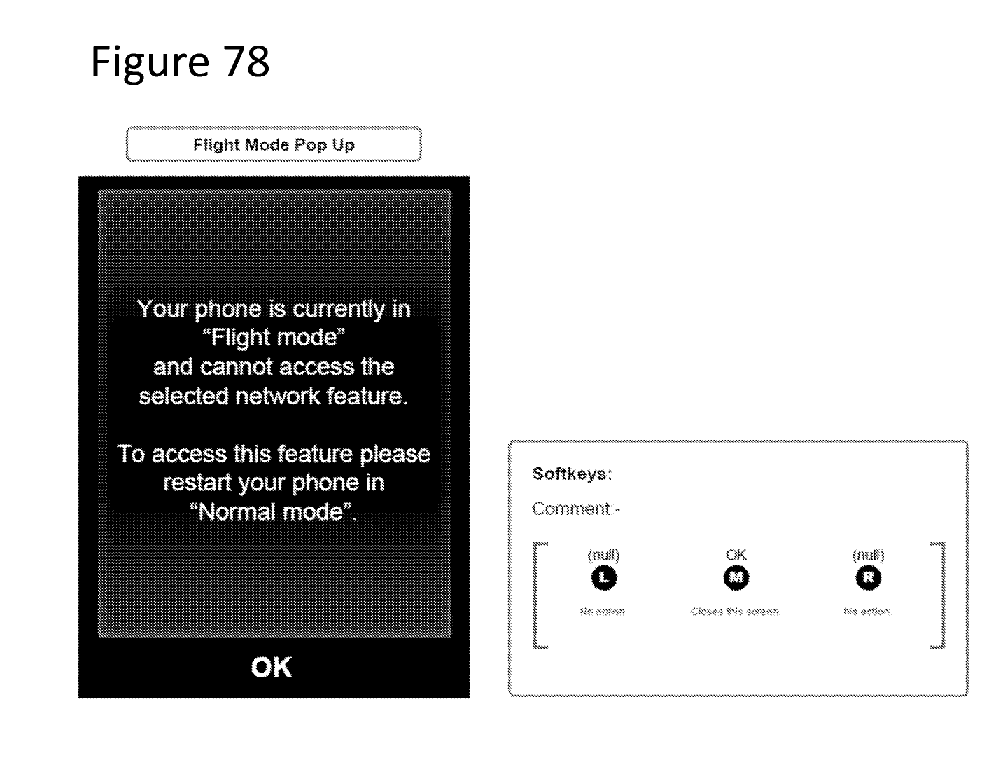

FIG. 78 shows Screen Name: Flight Mode. This screen describes the behaviour when a network connection is manually requested by the user and the handset is determined to be in flight mode by a predefined variable value.

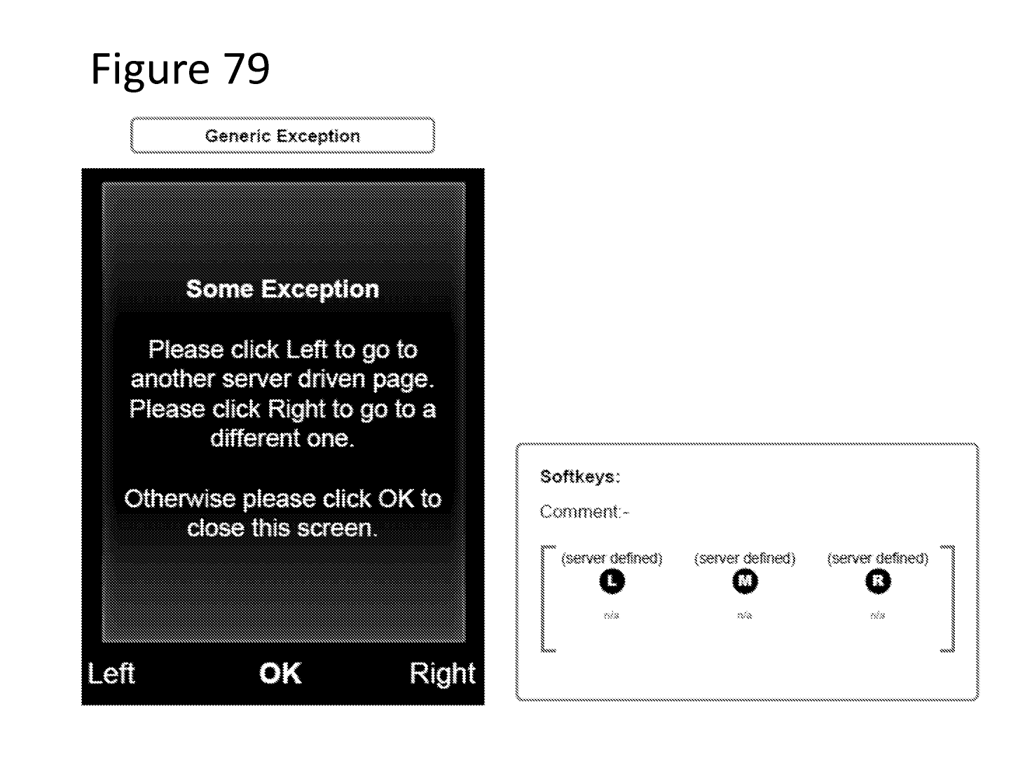

FIG. 79 shows Screen Name: Generic Exception Handling Screen. This screen is a defensive screen which is server-side controlled. In response to any normal network request the server can decide to abort the expected behaviour and return a server-side generated page as shown below. Notes on FIG. 79: not only can the screen message be dynamically generated but so can the softkeys. Softkeys can only either: Close the window, or Call back another server generated screen.

1. A mobile wireless device with an embedded media player, in which the functionality of the media player has been extended by integrating a third party application with the media player, the third party application extending the capabilities of the embedded media player by providing support for an unlimited music subscription service.

2. The device of claim 1 in which the third party application and the embedded media player are seamlessly integrated with each other so that they appear to the user to be a single application.

3. The device of claim 1 in which the third party application mimics the user interface of the embedded media player third party application.

4. The device of claim 1 in which the third party application presents no visible UI that is different from the UI of the embedded media player.

5. The device of claim 1 in which the third party application provides one or more of: unlimited media browsing; unlimited media downloading; sharing of playlists with other users; sharing of tracks with other users; registering a profile representing the user to enable the user to develop a network of friends.

6. The device of claim 1 in which the third party application is a J2ME plug-in and the embedded media player includes hooks that enable seamless integration with the third party application such that substantially no changes to the code for the embedded media player are required to integrate with the third party application.

7. The device of claim 1 in which the third party application is manufacturer signed and is therefore recognised more quickly than a non-signed third party application and has faster and more stable operation that a non-signed third party application.

8. The device of claim 1 in which the third party application has been customized substantially automatically for a specific mobile wireless device.

9. The device of claim 1 in which the music related main menu of the embedded media player includes an item that, if selected, opens the third party application.

10. The device of claim 9 in which selecting the item causes a menu list to be displayed, the menu list including items that substantially correspond to one or more of the following functions: Search; News; Discover/Browse; Friends/Community; Downloads.

11. The device of claim 1 in which the third party application provides a control mechanism such as DRM that supports metering and enables the use of unlimited subscription services.

12. The device of claim 1 in which the download of music tracks is not metered by or sent to a billing system.

13. The device of claim 1 in which the third party application communicates with the user's phone or address book data stored on the device to enable invitations to be sent to listen to and/or download music tracks.

14. The device of claim 1 in which the third party application provides a download queuing mechanism for downloading a queue of media assets and digital content for efficient network utilization.

15. The device of claim 1 in which the device sends one or more playlists to one or more remote servers for subsequent retrieval by one or more other users.

16. The device of claim 1 in which a playlist or playlists are generated automatically using one or more of: statistical information, playing metrics, a media recommendations engine, information describing media charts or using any other information.

17. The device of claim 1 in which a playlist is received at a mobile wireless device and is used to trigger the automatic downloading of media files specified in the playlist to that mobile wireless device.

18. The device of claim 17 in which the media files specified in the playlist are transferred from one or more remote servers to the mobile wireless device that has received the playlist.

19. The device of claim 1 in which the third party application supports one or more of: music, sound, images and video.

20. The device of claim 1 in which the third party application is manufacturer signed and is provided with more security access and can run and access functions and features which may otherwise not be possible or require user approval.

21. The device of claim 1 in which the third party application is a J2ME, or other programming language supported by the device, plug-in and the embedded media player includes hooks that enable seamless integration with the third party application such that substantially no changes to the code for the embedded media player are required to integrate with the third party application.

22. The device of claim 1 in which the third party application communicates with the user's phone or address book data stored on the device, or the friends and contacts stored on the server (a cache of which will be in the application), to enable invitations to be sent to listen to and/or download music tracks.
